(19) United States
(12) Patent Application Publication
(10) Pub. No.: US 2009/0218936 A1
(43) Pub. Date: Sep. 3, 2009

(54) Organic electroluminescence element

(75) Inventors: Kazuyuki Shibata, Tokyo (JP); Wataru Sotoyama, Kanagawa (JP); Manabu Tobise, Kanagawa (JP); Akira Takeda, Kanagawa (JP)

Correspondence Address: Moss & Burke, PLLC, 401 Holland Lane, Suite 407, Alexandria, VA, 22314, US

(73) Assignee: FUJIFILM CORPORATION, Minato-ku (JP)

(21) Appl. No.: 12/379,517

(22) Filed: Feb. 24, 2009

(30) Foreign Application Priority Data
Feb. 28, 2008 (JP) 2008-048629
Dec. 9, 2008 (JP) 2008-313240

(51) Int. Cl. H01J 1/62

(52) U.S. Cl. 313/504

(57) ABSTRACT

An organic electroluminescence element having at least one organic compound layer including a light-emitting layer, which is disposed between a pair of electrodes, wherein a charge transport layer which contains a charge transporting material and a compound represented by the following formula (1) is disposed adjacent to the light-emitting layer. An organic EL element that exhibits high light-emission efficiency and low driving voltage, and is excellent in drive durability is provided.

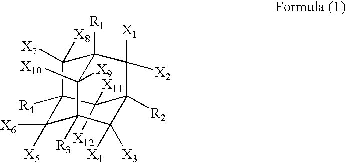

### CROSS-REFERENCE TO RELATED APPLICATION

This application claims priority under 35 USC 119 from Japanese Patent Application Nos. 2008-048,629 and 2008-313,240, the disclosures of which are incorporated by reference herein.

### BACKGROUND OF THE INVENTION

1. Field of the Invention

The present invention relates to an organic electroluminescence element (hereinafter, referred to as an “organic EL element” in some cases, and also referred to as an organic light emitting diode (OLED)) which can be effectively applied to a surface light source for full color displays, backlights, illumination light sources and the like; or a light source array for printers and the like.

2. Description of the Related Art

An organic EL element is composed of a light-emitting layer or a plurality of organic layers containing a light-emitting layer, and a pair of electrodes sandwiching the organic layers. The organic EL element is an element for obtaining luminescence by utilizing at least either one of luminescence from excitons each of which is obtained by recombining an electron injected from a cathode with a hole injected from an anode to produce an exciton in the organic layer, or luminescence from excitons of other molecules produced by energy transmission from the above-described excitons.

Heretofore, an organic EL element has been developed by using a laminate structure from integrated layers in which each layer is functionally differentiated, whereby the brightness and the element efficiency have been remarkably improved. For example, a two-layer laminated type element obtained by laminating a hole transport layer and a light-emitting layer also functioning as an electron transport layer; a three-layer laminated type element obtained by laminating a hole transport layer, a light-emitting layer, and an electron transport layer; and a four-layer laminated type element obtained by laminating a hole transport layer, a light-emitting layer, a hole-blocking layer, and an electron transport layer have been frequently used.

For the practical application of an organic EL element, however, there are still many problems such as improvements in light-emission efficiency and drive durability. Particularly, increase in light-emission efficiency results in a decrease in power consumption, and further, it is advantageous in view of drive durability. Accordingly, many means of improvement have been heretofore disclosed. However, a light emitting material having a high light-emission efficiency generally has a disadvantage of causing brightness deterioration during driving thereof, and further, a material excellent in drive durability generally has a disadvantage of low brightness. Accordingly, it is not easy to achieve both higher light-emission efficiency and higher drive durability, and thus further improvements are sought.

For instance, Japanese Patent Application Laid-Open (JP-A) Nos. 2005-294248 and 2005-294249 disclose an organic EL element, wherein an electrically inactive material is added to a layer adjacent to a light-emitting layer, and thereby, excitons generated in the light-emitting layer are inhibited from diffusing to the adjacent layer, and charges are blocked. However, an increase in electric resistance and an increase in driving voltage are inevitable.

On the other hand, a search for a light emitting material that is thermally and chemically stable and high in light-emission efficiency has been forwarded. For instance, JP-A No. 2003-321402 discloses an organic EL element including an adamantane derivative as a light emitting material of a light-emitting layer, or an organic EL element wherein an adamantane derivative is used as a light emitting material in a light-emitting layer and further an adjacent layer contains an adamantane derivative. However, there are problems with respect to the adamantane derivative in that the charge transportability is poor, the light-emission efficiency is low and the driving voltage becomes higher. Furthermore, JP-A No. 2006-120811 discloses that an organic EL element which includes an unsubstituted adamantane compound or a substituted adamantane compound having a straight chain or branched alkyl group as a substituent as a host compound together with a guest compound in a light-emitting layer is expected to improve the light-emission efficiency and drive durability. However, since the adamantane compound does not have charge transportability, charges flow only on the guest compound. Accordingly, the driving voltage is increased by incorporating the adamantane compound; as a result, a large improvement in the light-emission efficiency is not expected. Furthermore, JP-A No. 2005-220080 discloses that when an adamantane compound having an o-terphenyl group is used as a host material of a light-emitting layer, the heat resistance in particular is improved, and an organic EL element which is high in light-emission efficiency is provided. However, in order to put an organic EL element to practical use, in addition to high light-emission efficiency and high drive durability, comprehensively, many characteristics such as low driving voltage operability and capability of emitting in a broad light emitting wavelength region have to be provided. The structure of the light-emitting layer disclosed in JP-A No. 2005-220080 cannot be considered to respond sufficiently to these demands.

### SUMMARY OF THE INVENTION

The present invention has been made in view of the above circumstances and provides an organic electroluminescence element with the following aspect.

An aspect of the present invention is to provide an organic electroluminescence element comprising at least one organic compound layer including a light-emitting layer, which is disposed between a pair of electrodes, wherein a charge transport layer which contains a charge transporting material and a compound represented by the following formula (1) is disposed adjacent to the light-emitting layer:

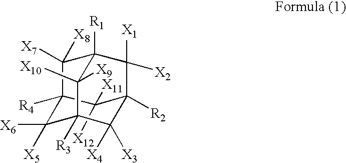

wherein in formula (1), R₁ through R₄ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group; at least one of R₁ through R₄ is a group having a double bond or a triple bond; and X₁ through X₁₂ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group.

### DETAILED DESCRIPTION OF THE INVENTION

An object of the present invention is to provide an organic EL element that exhibits high light-emission efficiency and low driving voltage, and is excellent in drive durability.

The present invention has been made in view of the above circumstances, and the problems described above have been solved by an organic electroluminescence element which is characterized in that it comprises at least one organic compound layer including a light-emitting layer, which is disposed between a pair of electrodes, wherein a charge transport layer which contains a charge transporting material and a compound represented by the following formula (1) is disposed adjacent to the light-emitting layer.

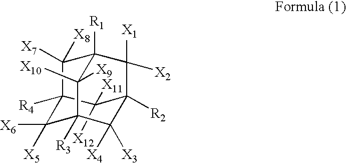

In formula (1), R₁ through R₄ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group, wherein at least one of R₁ through R₄ is a group having a double bond or a triple bond. X₁ through X₁₂ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group.

Preferably, the charge transport layer is disposed on an anode side of the light-emitting layer.

Preferably, the charge transport layer is disposed on a cathode side of the light-emitting layer.

Preferably, the charge transport layer is disposed on an anode side and on a cathode side of the light-emitting layer.

Preferably, a content of the compound represented by formula (1) in the charge transport layer is from 5% by weight to 50% by weight.

Preferably, an energy difference (Eg) between the highest occupied molecular orbital and the lowest unoccupied molecular orbital of the compound represented by formula (1) is 4.0 eV or more.

Preferably, the lowest excited triplet level (T1) of compound represented by formula (1) is 2.7 eV or more.

Preferably, an electron affinity (Ea) of the compound represented by formula (1) is 2.3 eV or less.

Preferably, an ionization potential (Ip) of the compound represented by formula (1) is 6.1 eV or more.

Preferably, at least one of R1 through R4 is a group having a double bond, and the group having the double bond is a phenyl group, a biphenylyl group or a terphenylyl group.

Preferably, the group having the double bond is a phenyl group.

Preferably, the charge transport layer contains plural compounds represented by formula (1) in a mixed state.

Preferably, the plural compounds represented by formula (1) are compounds having a different number of phenyl groups from each other.

Preferably, the light-emitting layer contains a metal complex.

Preferably, the metal complex is a metal complex having a tri- or higher-dentate ligand.

Preferably, the metal complex is a metal complex represented by the following formula (A).

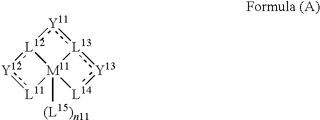

In formula (A), M¹¹ represents a metal ion, and L¹¹ through L¹⁵ each independently represent a ligand which coordinates to M¹¹. An atomic group may further exist between L¹¹ and L¹⁴ to form a cyclic ligand. L¹⁵ may bond to both of L¹¹ and L¹⁴ to form a cyclic ligand. Y¹¹, Y¹² and Y¹³ each independently represent a linking group, a single bond or a double bond. Furthermore, when Y¹¹, Y¹² or Y¹³ is a linking group, bonds between L¹¹ and Y¹², Y¹² and L¹², L¹² and Y¹¹, Y¹¹ and L¹³, L¹³ and Y¹³, and Y¹³ and L¹⁴ each independently represent a single bond or a double bond. n11 is from 0 to 4. Bonds between M¹¹ and L¹¹ to L¹⁵ are each independently a coordination bond, an ionic bond or a covalent bond.

Preferably, in formula (A), M¹¹ is a platinum ion.

According to the present invention, an organic EL element that exhibits high light-emission efficiency and low driving voltage, and is excellent in drive durability is provided.

In the following, the organic electroluminescence element of the present invention will be described in detail.

The organic electroluminescence element of the present invention includes an anode and a cathode on a substrate, and at least one organic compound layer including a light-emitting layer between the electrodes, wherein a charge transport layer which contains a charge transporting material and a compound represented by the following formula (1) is disposed adjacent to the light-emitting layer.

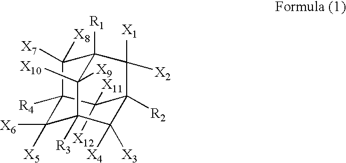

In formula (1), R₁ through R₄ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group, wherein at least one of R₁ through R₄ is a group having a double bond or a triple bond. X₁ through X₁₂ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group.

Due to the nature of a light-emitting element, it is preferred that at least one electrode of the anode or the cathode is transparent.

The organic compound layer in the present invention may be either of a monolayer or an integrated layer. In the case of an integrated layer, a preferable embodiment has a hole transport layer, a light-emitting layer, and an electron transport layer integrated in this order from the anode side. Moreover, a charge-blocking layer and the like may be provided between the hole transport layer and the light-emitting layer, or between the light-emitting layer and the electron transport layer. Further, a hole injection layer may be provided between the anode and the hole transport layer, and similarly an electron injection layer may be provided between the cathode and the electron transport layer. Each of the layers mentioned above may be composed of a plurality of secondary layers.

### 1. Compound Represented by Formula (1)

The compound represented by formula (1) used for the organic electroluminescence element in the present invention is to be described in detail hereinafter.

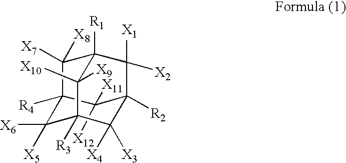

In formula (1), R₁ to R₄ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group, wherein at least one from among R₁ to R₄ is a group having a double bond or a triple bond. X₁ to X₁₂ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group.

### <Detailed Description of Substituents Etc.>

Examples of the alkyl group having 1 to 6 carbon atoms represented by R₁ to R₄ and X₁ to X₁₂ include methyl, ethyl, n-propyl, isopropyl, n-butyl, sec-butyl (i.e., 2-butyl), isobutyl, tert-butyl, n-pentyl, isopentyl, n-hexyl, cyclopropyl, cyclobutyl, cyclopentyl, cyclohexyl and the like.

Examples of the alkenyl group having 2 to 6 carbon atoms represented by R₁ to R₄ and X₁ to X₁₂ include vinyl, allyl (i.e., 1-(2-propenyl)), 1-(1-propenyl), 2-propenyl, 1-(1-butenyl), 1-(2-butenyl), 1-(3-butenyl), 1-(1,3-butadienyl), 2-(2-butenyl), 1-(1-pentenyl), 5-(cyclopentadienyl), 1-(1-cyclohexenyl) and the like.

Examples of the alkynyl group having 2 to 6 carbon atoms represented by R₁ to R₄ and X₁ to X₁₂ include ethynyl, propargyl (i.e., 1-(2-propynyl)), 1-(1-propynyl), 1-butadiynyl, 1-(1,3-pentadiynyl) and the like.

Examples of the aryl group represented by R₁ to R₄ and X₁ to X₁₂ include phenyl, o-tolyl (i.e., 1-(2-methylphenyl)), m-tolyl, p-tolyl, 1-(2,3-dimethylphenyl), 1-(3,4-dimethylphenyl), 2-(1,3-dimethylphenyl), 1-(3,5-dimethylphenyl), 1-(2,5-dimethylphenyl), p-cumenyl, mesityl, 1-naphtyl, 2-naphtyl, 1-anthranyl, 2-anthranyl, 9-anthranyl, biphenylyls such as 4-biphenylyl (i.e., 1-(4-phenyl)phenyl), 3-biphenylyl and 2-biphenylyl, terphenylyls such as 4-p-terphenylyl (i.e., 1-4-(4-biphenylyl)phenyl) and 4-m-terphenylyl (i.e., 1-4-(3-biphenylyl)phenyl), and the like.

The heteroaryl group represented by R₁ to R₄ and X₁ to X₁₂ includes a heteroatom such as a nitrogen atom, an oxygen atom, a sulfur atom or the like. Specific examples of the heteroaryl group represented by R₁ to R₄ and X₁ to X₁₂ include imidazolyl, pyrazolyl, pyridyl, pyrazyl, pyrimidyl, triazinyl, quinolyl, isoquinolinyl, pyrrolyl, indolyl, furyl, thienyl, benzoxazolyl, benzimidazolyl, benzthiazolyl, carbazolyl, azepinyl and the like.

Examples of the alkoxy group having 1 to 6 carbon atoms represented by R₁ to R₄ and X₁ to X₁₂ include methoxy, ethoxy, isopropoxy, cyclopropoxy, n-butoxy, tert-butoxy, cyclohexyloxy, phenoxy and the like.

Examples of the acyl group represented by R₁ to R₄ and X₁ to X₁₂ include acetyl, benzoyl, formyl, pivaloyl and the like.

Examples of the acyloxy group represented by R₁ to R₄ and X₁ to X₁₂ include acetoxy, benzoyloxy and the like.

Examples of the amino group represented by R₁ to R₄ and X₁ to X₁₂ include amino, methylamino, dimethylamino, diethylamino, dibenzylamino, diphenylamino, ditolylamino, pyrrolidino, piperidino, morpholino and the like.

Examples of the ester group represented by R₁ to R₄ and X₁ to X₁₂ include methylester (i.e., methoxycarbonyl), ethylester, isopropylester, phenylester, benzylester and the like.

Examples of the amido group represented by R₁ to R₄ and X₁ to X₁₂ include those to be linked through the carbon atom of amido group such as N,N-dimethylamido (i.e., dimethylaminocarbonyl), N-phenylamido and N,N-diphenylamido, and those to be linked through the nitrogen atom of amido group such as N-methylacetoamido (i.e., acetylmethylamino), N-phenylacetoamido, N-phenylbenzamido and the like.

Examples of the halogen atom represented by R₁ to R₄ and X₁ to X₁₂ include a fluorine atom, a chlorine atom, a bromine atom, an iodine atom and the like.

Examples of the perfluoroalkyl group having 1 to 6 carbon atoms represented by R₁ to R₄ and X₁ to X₁₂ include trifluoromethyl, pentafluoroethyl, 1-perfluoropropyl, 2-perfluoropropyl, perfluoropentyl and the like.

Examples of the silyl group having 1 to 18 carbon atoms represented by R₁ to R₄ and X₁ to X₁₂ include trimethylsilyl, triethylsilyl, triisopropylsilyl, triphenylsilyl, methyldiphenylsilyl, dimethylphenylsilyl, tert-butyldimethylsilyl, tert-butyldiphenylsilyl and the like.

R₁ to R₄ and X₁ to X₁₂ described above may be further substituted by other substituents. Examples of an aryl-substituted alkyl group include benzyl, 9-fluorenyl, 1-(2-phenylethyl), 1-(4-phenyl)cyclohexyl and the like. Examples of a heteroaryl-substituted aryl group include 1-(4-N-carbazolyl)phenyl, 1-(3,5-di(N-carbazolyl))phenyl, 1-(4-(2-pyridyl)phenyl) and the like.

R₁ to R₄ described above are each preferably a hydrogen atom, an alkyl group, an alkenyl group, an alkynyl group, an aryl group, a heteroaryl group, an alkoxy group, an amino group, an ester group or a silyl group, more preferably a hydrogen atom, an alkyl group, an aryl group, a heteroaryl group, an alkoxy group, an amino group or a silyl group, and particularly preferably a hydrogen atom, an alkyl group or an aryl group.

X₁ to X₁₂ described above are each preferably a hydrogen atom, an alkyl group, an alkenyl group, an alkynyl group, an aryl group, a heteroaryl group, an alkoxy group, an amino group, an ester group or a silyl group, more preferably a hydrogen atom, an alkyl group or an aryl group, and particularly preferably a hydrogen atom.

The alkyl group having 1 to 6 carbon atoms represented by R₁ to R₄ and X₁ to X₁₂ is preferably methyl, ethyl, n-propyl, isopropyl, n-butyl, isobutyl, tert-butyl, n-pentyl, n-hexyl, cyclopentyl or cyclohexyl, more preferably methyl, ethyl, tert-butyl, n-hexyl or cyclohexyl, and particularly preferably methyl or ethyl.

The aryl group represented by R₁ to R₄ and X₁ to X₁₂ is preferably phenyl, o-tolyl, 1-(3,4-dimethylphenyl), 1-(3,5-dimethylphenyl), 1-naphtyl, 2-naphtyl, 9-anthranyl, biphenyls or terphenyls, more preferably phenyl, biphenylyls or terphenylyls, and particularly preferably phenyl.

The hydrogen atom represented by R₁ to R₄ and X₁ to X₁₂ may be a deuterium atom, and is preferably a deuterium atom.

The hydrogen atoms included in the compounds represented by formula (1) may be replaced partly or entirely with deuterium atoms.

At least one from among R₁ to R₄ represents a group having a double bond or a triple bond. Specific examples of the double bond include C═C, C═O, C═S, C═N, N═N, S═O, P═O and the like. The double bond is preferably C═C, C═O, C═N, S═O or P═O, more preferably C═C, C═O or C═N, and particularly preferably C═C. Specific examples of the triple bond include C≡C and C≡N. The triple bond is preferably C≡C.

The group having a double bond or a triple bond represented by R₁ to R₄ is preferably an aryl group, more preferably a phenyl group, a biphenylyl group or a terphenylyl group shown below, and particularly preferably a phenyl group.

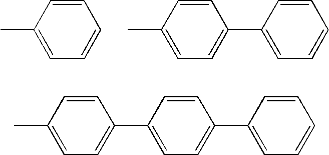

At least one from among R₁ to R₄ represents a group having a double bond or a triple bond, wherein a number of the groups having a double bond or a triple bond among R₁ to R₄ is preferably from 2 to 4, more preferably 3 or 4, and particularly preferably 4.

Among the groups represented by R₁ to R₄, when the number of the groups having a double bond or a triple bond is from 1 to 3, specific examples of the remaining group having only a single bond are preferably a hydrogen atom, an alkyl group, an alkoxy group or a silyl group, more preferably a hydrogen atom, an alkyl group or a silyl group, and particularly preferably a hydrogen atom or an alkyl group.

R₁ to R₄ and X₁ to X₁₂ may form a ring structure by combining with one other. For example, as shown below, X₂, X₃ and X₉ may link together to form a diamantane structure. Furthermore, X₄, X₅ and X₁₂ may link together to form a triamantane structure. These diamantane and triamantane structures may be further substituted by a substituent.

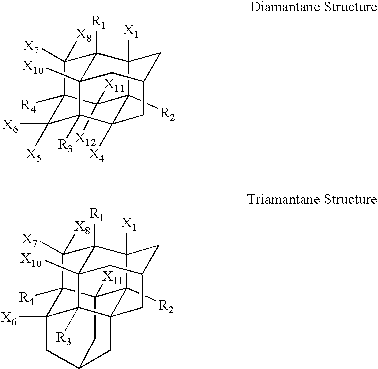

In the present invention, an energy difference (Eg) between the highest occupied molecular orbital and the lowest unoccupied molecular orbital of the compound represented by formula (1) is preferably 4.0 eV or more, and more preferably from 4.2 eV to 5.0 eV.

In the present invention, the lowest excited triplet level (T1) of the compound represented by formula (1) is preferably 2.7 eV or more, and more preferably from 2.8 eV to 3.5 eV.

Further, in the present invention, an electron affinity (Ea) of the compound represented by formula (1) is preferably 2.3 eV or less, and more preferably 2.0 eV or less.

Specific examples of the compound represented by formula (1) are shown below, but the present invention is not limited to these compounds.

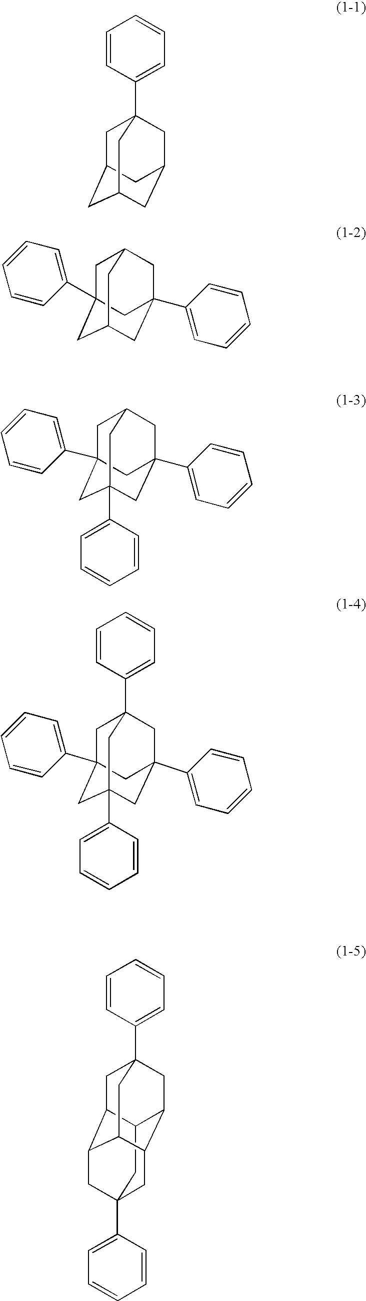

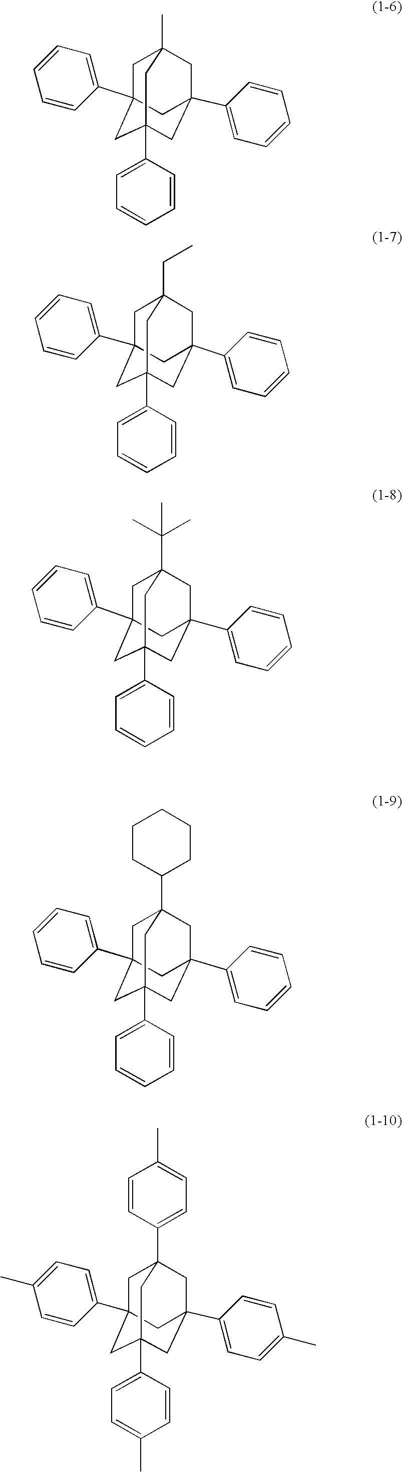

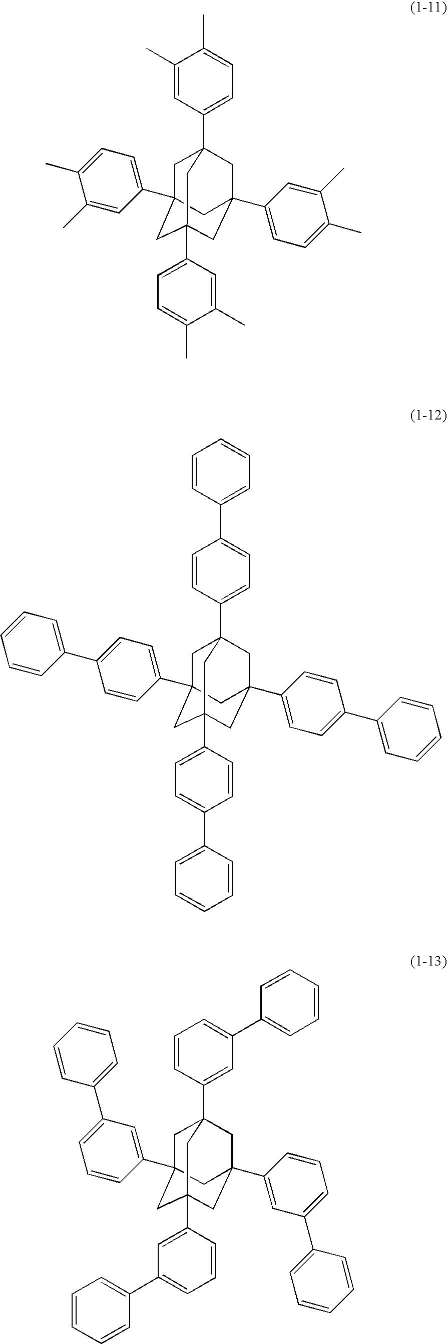

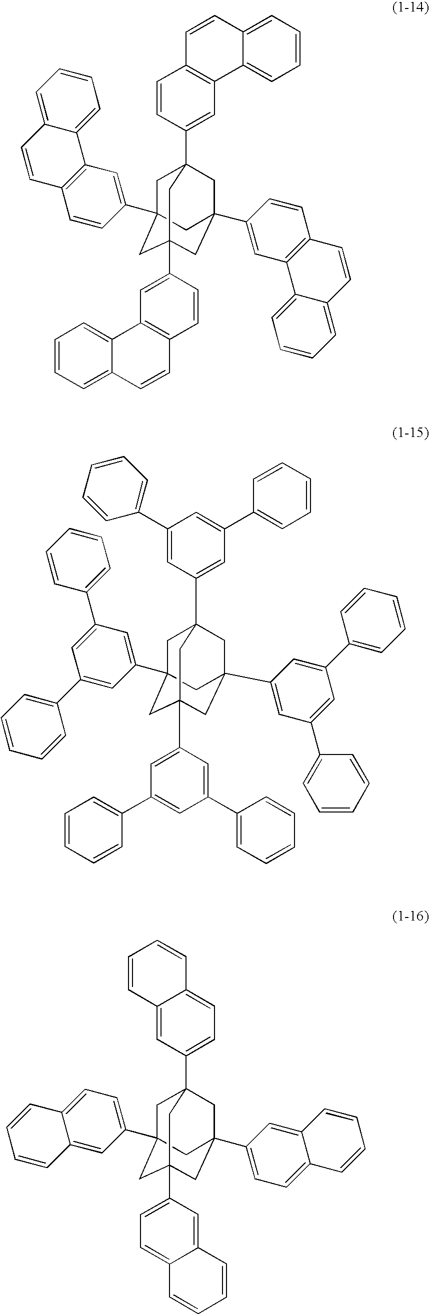

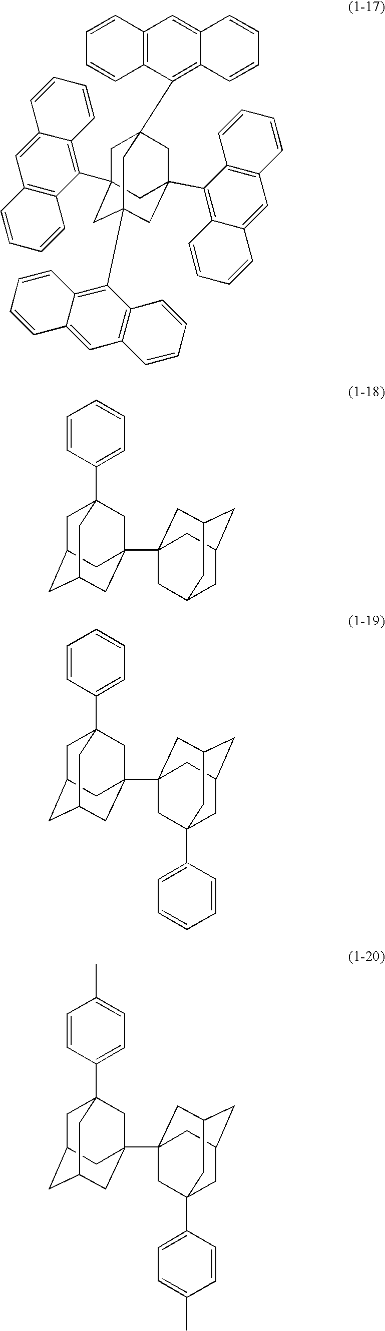

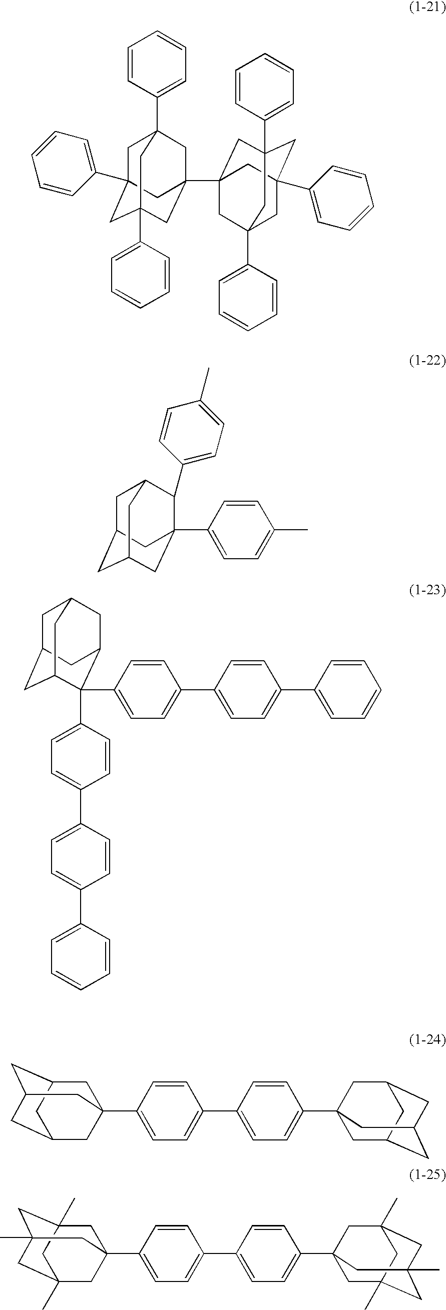

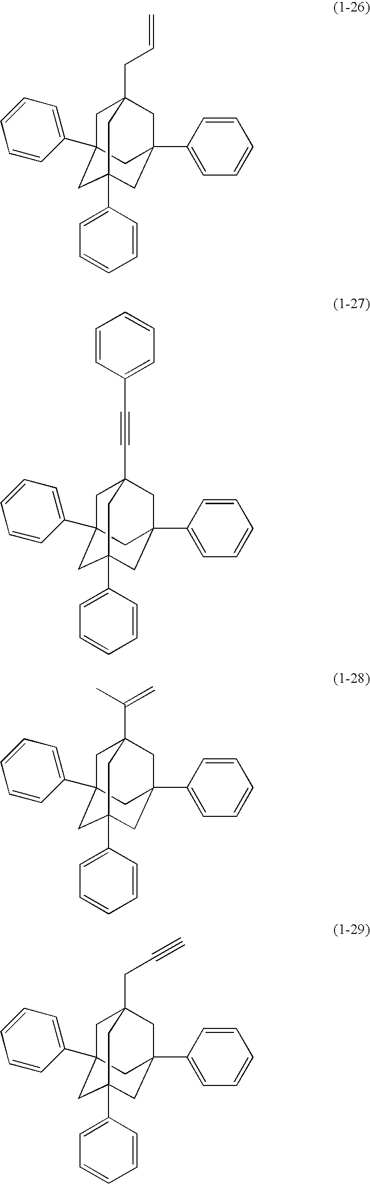

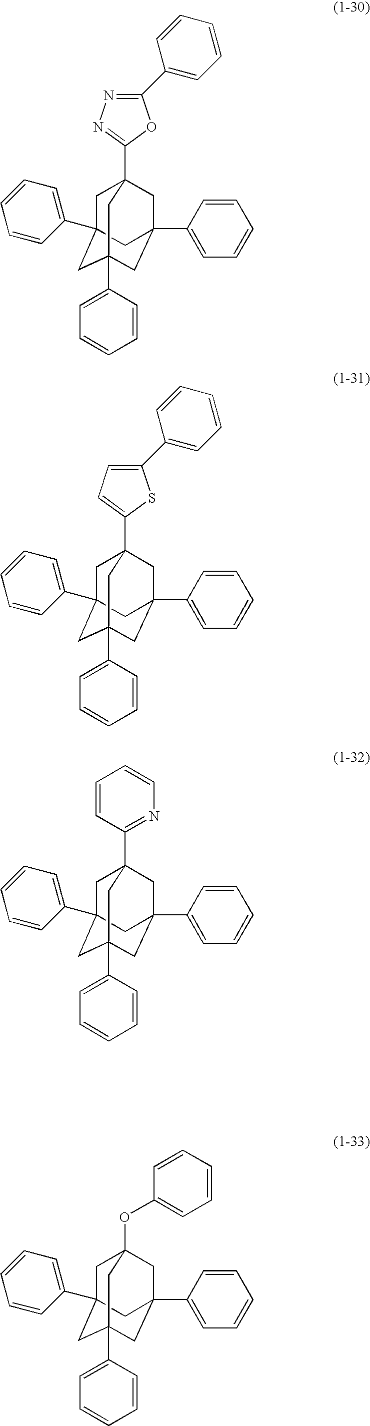

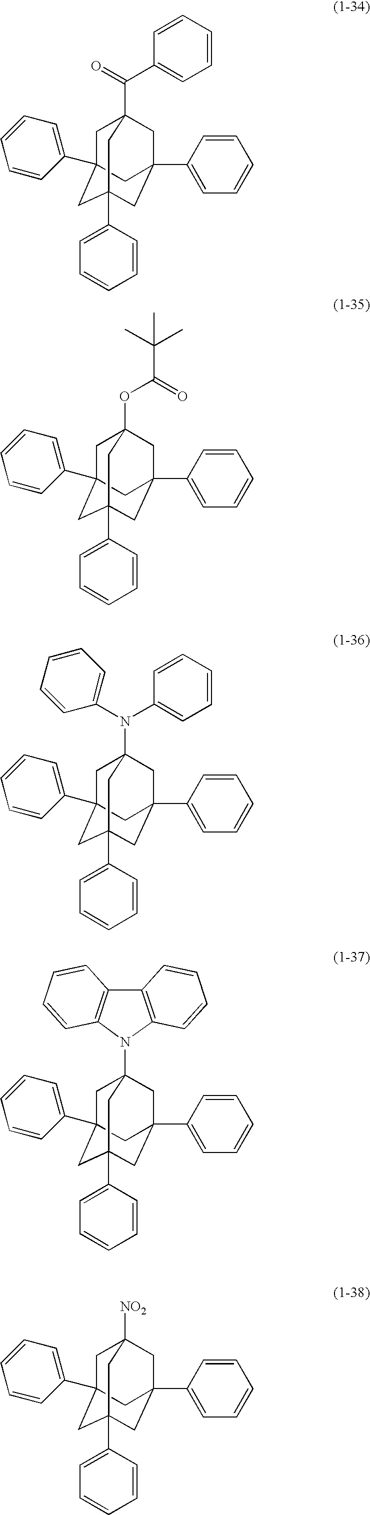

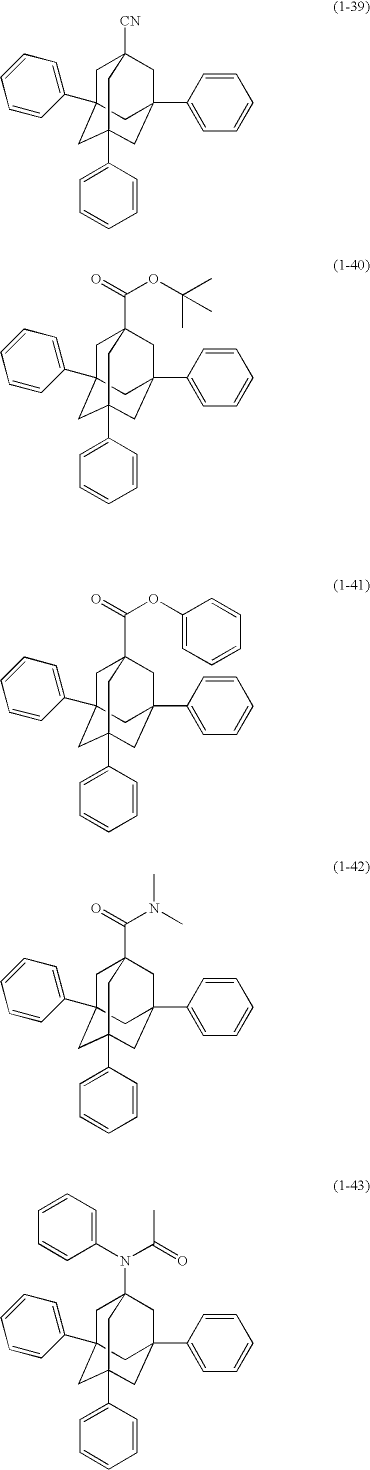

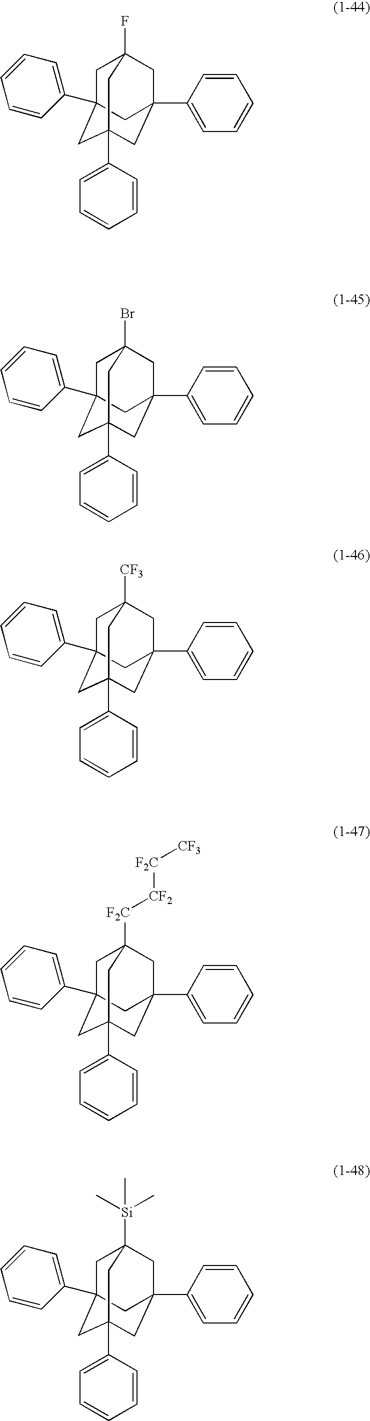

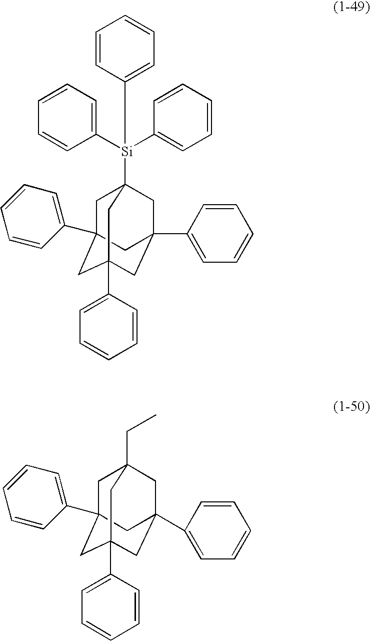

In the present invention, a compound represented by formula (1) may be used singularly or by mixing a plurality thereof. It is preferable to be used by mixing plural compounds different from each other in a group having a double bond or compounds different in the number of substitution thereof from each other. For instance, specific examples of the group having a double bond include a phenyl group, a biphenylyl group or a terphenylyl group as a group, and the number of substitutions thereof includes from 1 to 4. The phenyl group, biphenylyl group or terphenylyl group may further have a substituent which substitutes for a hydrogen atom on a benzene ring. In the invention, it is preferred to be used by mixing a mono-substituted body having the number of substitution of 1 and a tetra-substituted body having the number of substitution of 4. For instance, as a preferable example, a combination of a monophenyl substituted body and a tetra-phenyl substituted body is included.

In the present invention, when a mixture of plural compounds represented by formula (1) is used, a mixing ratio thereof is preferably in a range of from 1:99 to 99:1 by weight ratio, and more preferably from 20:80 to 80:20.

By using the compound represented by formula (1) by mixing a plurality thereof, a protective effect of an amorphous state of an amorphous material is further improved; accordingly, the drive durability is more improved.

The compound represented by formula (1) in the invention is contained in a charge transport layer adjacent to the light-emitting layer. One embodiment of the charge transport layer adjacent to the light-emitting layer is a charge transport layer disposed on an anode side of the light-emitting layer. Another embodiment thereof is a charge transport layer disposed on a cathode side of the light-emitting layer. Still another embodiment, which is preferable, is an embodiment where a charge transport layer containing the compound represented by formula (1) is disposed on an anode side of the light-emitting layer and on a cathode side of the light-emitting layer.

In the case where the charge transport layer adjacent to the light-emitting layer is a charge transport layer disposed on an anode side of the light-emitting layer, a hole transporting material is preferably used as a charge transporting material. The hole transporting material is not particularly limited and, for instance, a hole transporting host material, or a material for a hole injection layer or a hole transport layer, which is described below, are cited as preferable materials.

In the case where a charge transport layer disposed on an anode side contains the compound represented by formula (1), the charge transport layer is preferably a hole transport layer or a layer disposed between a hole transport and a light-emitting layer.

In the case where the charge transport layer adjacent to the light-emitting layer is a charge transport layer disposed on a cathode side of the light-emitting layer, an electron transporting material is preferably used as a charge transporting material. The electron transporting material is not particularly limited and, for instance, an electron transporting host material and materials for an electron injection layer and an electron transport layer, which are described below, are cited as preferable materials.

In the case where the compound represented by formula (1) is contained in a charge transport layer disposed on a cathode side, the charge transport layer is preferably an electron transport layer or a layer disposed between an electron transport layer and a light-emitting layer.

A content of the charge transporting material in the charge transport layer is, by weight ratio, preferably from 5% by weight to 90% by weight, and more preferably from 5% by weight to 50% by weight.

In the present invention, a thickness of the charge transport layer containing the compound represented by formula (1) is preferably from 1 nm to 200 nm, more preferably from 2 nm to 100 nm, and even more preferably from 5 nm to 50 nm.

### 2. Light-Emitting Layer

The light-emitting layer is a layer having functions of receiving holes from the anode, the hole injection layer, or the hole transport layer, and receiving electrons from the cathode, the electron injection layer, or the electron transport layer, and providing a field for recombination of the holes with the electrons to emit light, when an electric field is applied the layer.

The light emitting material used in the light-emitting layer in the present invention is not particularly limited, but either of a fluorescent light emitting material or a phosphorescent light emitting material may be used. Preferably, the light emitting material is a metal complex. It is preferred that the light-emitting layer in the present invention further includes a host material. As the host material, either of a hole transporting host material or an electron transporting host material may be used. In the present invention, a hole transporting host material is preferred.

A thickness of the light-emitting layer is not particularly limited, but is generally from 1 nm to 500 nm, preferably from 5 nm to 200 nm, and more preferably from 10 nm to 100 nm.

### 2-1. Light Emitting Material

A fluorescent light emitting material and a phosphorescent light emitting material are known as a light emitting material.

### (a) Phosphorescent Light Emitting Material

Examples of the above-described phosphorescent light emitting material generally include complexes containing a transition metal atom or a lanthanoid atom.

For instance, the transition metal atom is preferably ruthenium, rhodium, palladium, tungsten, rhenium, osmium, iridium, or platinum, more preferably rhenium, iridium, or platinum, and even more preferably iridium or platinum.

Examples of the lanthanoid atom include lanthanum, cerium, praseodymium, neodymium, samarium, europium, gadolinium, terbium, dysprosium, holmium, erbium, thulium, ytterbium, and lutetium. Among these lanthanoid atoms, neodymium, europium, and gadolinium are preferred.

Examples of ligands in the complex include the ligands described, for example, in “Comprehensive Coordination Chemistry” authored by G. Wilkinson et al., published by Pergamon Press Company in 1987; “Photochemistry and Photophysics of Coordination Compounds” authored by H. Yersin, published by Springer-Verlag Company in 1987; and “YUHKI KINZOKU KAGAKU—KISO TO OUYOU— (Organometallic Chemistry—Fundamental and Application—)” authored by Akio Yamamoto, published by Shokabo Publishing Co., Ltd. in 1982.

Specific examples of the ligands preferably include halogen ligands (preferably chlorine ligands), aromatic carbon ring ligands (e.g., cyclopentadienyl anions, benzene anions, naphthyl anions and the like), nitrogen-containing heterocyclic ligands (e.g., phenylpyridine, benzoquinoline, quinolinol, bipyridyl, phenanthroline and the like), diketone ligands (e.g., acetylacetone and the like), carboxylic acid ligands (e.g., acetic acid ligands and the like), alcoholato ligands (e.g., phenolato ligands and the like), carbon monoxide ligands, isonitryl ligands, and cyano ligand, and more preferably nitrogen-containing heterocyclic ligands.

The above-described complexes may be either a complex containing one transition metal atom in the compound, or a so-called polynuclear complex containing two or more transition metal atoms wherein different metal atoms may be contained at the same time.

Among these, specific examples of the light emitting materials include phosphorescent light-emitting compounds described in patent documents such as U.S. Pat. No. 6,303,238B1, U.S. Pat. No. 6,097,147, International Patent Application (WO) No. 00/57676, WO No. 00/70655, WO No. 01/08230, WO No. 01/39234A2, WO No. 01/41512A1, WO No. 02/02714A2, WO No. 02/15645A1, WO No. 02/44189A1, JP-A Nos. 2001-247859, 2002-302671, 2002-117978, 2002-225352, 2002-235076, 2003-123982, 2002-170684, European Patent (EP) No. 1211257, JP-A Nos. 2002-226495, 2002-234894, 2001-247859, 2001-298470, 2002-173674, 2002-203678, 2002-203679, 2004-357791, 2005-256999, and 2006-256999, etc.

### (b) Fluorescent Light Emitting Material

Examples of the fluorescent light emitting materials generally include benzoxazole, benzoimidazole, benzothiazole, styrylbenzene, polyphenyl, diphenylbutadiene, tetraphenylbutadiene, naphthalimide, coumarin, pyran, perinone, oxadiazole, aldazine, pyralidine, cyclopentadiene, bis-styrylanthracene, quinacridone, pyrrolopyridine, thiadiazolopyridine, cyclopentadiene, styrylamine, aromatic dimethylidine compounds, condensed polycyclic aromatic compounds (naphthalene, anthracene, phenanthrene, phenanthroline, pyrene, perylene, rubrene, pentacene and the like), a variety of metal complexes represented by metal complexes of 8-quinolinol, pyromethene complexes or rare-earth metal complexes, polymer compounds such as polythiophene, polyphenylene or polyphenylenevinylene, organosilanes, and derivatives thereof.

Preferably, the light emitting material used in the present invention is a phosphorescent light emitting material, which is an electron transporting phosphorescent light emitting material having an electron affinity (Ea) of from 2.5 eV to 3.5 eV, and an ionization potential (Ip) of from 5.7 eV to 7.0 eV

Specific examples include metal complexes of ruthenium, rhodium, palladium, tungsten, rhenium, osmium, iridium, platinum, lanthanum, cerium, praseodymium, neodymium, samarium, europium, gadolinium, terbium, dysprosium, holmium, erbium, thulium, ytterbium, and lutetium. Metal complexes of ruthenium, rhodium, palladium or platinum are preferred, and a platinum complex is most preferred.

The phosphorescent light emitting material used in the present invention is particularly preferably a metal complex having a tri- or higher-dentate ligand.

(Metal Complex having Poly-Dentate Ligand)

The metal complex having a tri- or higher-dentate ligand used in the present invention is to be described.

### 1) Metal Ion

An atom which coordinates to a metal ion in the metal complex is not particularly limited, but examples thereof preferably include an oxygen atom, a nitrogen atom, a carbon atom, a sulfur atom and a phosphorus atom, more preferably an oxygen atom, a nitrogen atom and a carbon atom, and even more preferably a nitrogen atom and a carbon atom.

The metal ion in the metal complex is not particularly limited, but a transition metal ion or a rare earth metal ion is preferable from the viewpoints of improving light-emission efficiency, improving durability and lowering driving voltage. Specific examples thereof include an iridium ion, a platinum ion, a gold ion, a rhenium ion, a tungsten ion, a rhodium ion, a ruthenium ion, an osmium ion, a palladium ion, a silver ion, a copper ion, a cobalt ion, a zinc ion, a nickel ion, a lead ion, an aluminum ion, a gallium ion and a rare earth metal ion (for example, a europium ion, a gadolinium ion, a terbium ion or the like). Preferred is an iridium ion, a platinum ion, a gold ion, a rhenium ion, a tungsten ion, a palladium ion, a zinc ion, an aluminum ion, a gallium ion, a europium ion, a gadolinium ion or a terbium ion, more preferred is an iridium ion, a platinum ion, a rhenium ion, a tungsten ion, a europium ion, a gadolinium ion or a terbium ion, even more preferred is an iridium ion, a platinum ion, a palladium ion, a zinc ion, an aluminum ion or a gallium ion, and most preferred is a platinum ion.

### 2) Coordination Number

The metal complex having a tri- or higher-dentate ligand in the present invention is preferably a metal complex having a tridentate to hexadentate ligand from the viewpoints of improving light-emission efficiency and improving durability. In the case where a metal ion is easy to form a hexadentate complex exemplified by an iridium ion, a metal complex having a tridentate ligand, a tetradentate ligand or a hexadentate ligand is preferable. In the case where a metal ion is easy to form a tetradentate complex exemplified by a platinum ion, a metal complex having a tridentate ligand or a tetradentate ligand is preferable, and a metal complex having a tetradentate ligand is more preferable.

### 3) Ligand

The ligand of the metal complex in the present invention is preferably a chain ligand or cyclic ligand from the viewpoints of improving light-emission efficiency and improving durability. More preferred is a ligand having at least one nitrogen-containing heterocycle which coordinates to a central metal (for example, M¹¹ in the compound represented by formula (A) described below) through a nitrogen atom. Examples of the nitrogen-containing heterocycle include a pyridine ring, a quinoline ring, a pyrimidine ring, a pyrazine ring, a pyrrole ring, an imidazole ring, a pyrazole ring, an oxazole ring, a thiazole ring, an oxadiazole ring, a thiadiazole ring, a triazole ring and the like. Among them, a 6-membered or 5-membered nitrogen-containing heterocycle is more preferred. The heterocycle may form a condensed ring with another ring.

The chain ligand in the metal complex is defined as a ligand having no cyclic structure in the metal complex (for example, a ter-pyridyl ligand or the like). The cyclic ligand of the metal complex is defined to indicate that plural ligands in the metal complex combine with each other to form a closed structure (for example, a phthalocyanine ligand, a crown ether ligand or the like).

### 4) Preferable Constitution of Metal Complex

The metal complex in the present invention is preferably an organic compound represented by formula (A), which are described below in detail.

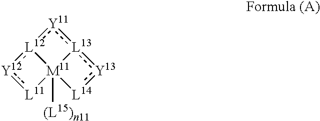

In formula (A), M¹¹ represents a metal ion. L¹¹ to L¹⁵ each represent a ligand which coordinates to M¹¹. An atomic group may further exist between L¹¹ to L¹⁴ to form a cyclic ligand. L¹⁵ may bond to both L¹¹ and L¹⁴ to form a cyclic ligand. Y¹¹, Y¹² and Y¹³ each represent a linking group, a single bond or a double bond. In the case where Y¹¹, Y¹²or Y¹³ represents a linking group, bonds between L¹¹ and Y¹², Y¹² and L¹², L¹² and Y¹¹, ¹¹ and L¹³, L¹³ and Y¹³, and Y¹³ and L¹⁴ each independently represent a single bond or a double bond. n11 represents from 0 to 4. Bonds between M¹¹ and L¹¹ to L¹⁵ are each independently a coordination bond, an ionic bond or a covalent bond.

The organic compound represented by formula (A) is to be described in detail.

In formula (A), M¹¹ represents a metal ion. The metal ion is not particularly limited, but a divalent or trivalent metal ion is preferred. Examples of the divalent or trivalent metal ion preferably include a platinum ion, an iridium ion, a rhenium ion, a palladium ion, a rhodium ion, a ruthenium ion, a copper ion, a europium ion, a gadolinium ion and a terbium ion, more preferably a platinum ion, an iridium ion and a europium ion, and even more preferably a platinum ion and an iridium ion. Among them, a platinum ion is particularly preferred.

In formula (A), L¹¹, L¹², L¹³ and L¹⁴ each independently represent a ligand which coordinates to M¹¹. Examples of the atom which is contained in L¹¹, L¹², L¹³ or L¹⁴ and coordinates to M¹¹ preferably include a nitrogen atom, an oxygen atom, a sulfur atom, a carbon atom and a phosphorus atom, more preferably a nitrogen atom, an oxygen atom, a sulfur atom and a carbon atom, and even more preferably a nitrogen atom, an oxygen atom and a carbon atom.

The bonds formed by M¹¹ and L¹¹, L¹², L¹³ or L¹⁴ are each independently a covalent bond, an ionic bond or a coordination bond. The term ligand in the present invention may include, for the sake of explanation, those formed by an ionic bond or a covalent bond besides a coordination bond.

The ligand formed by L¹¹, Y¹², L¹², Y¹¹, L¹³, Y¹³ and L¹⁴ is preferably an anionic ligand, wherein at least one anion is bonded to the metal. A number of the anion in the anionic ligand is preferably 1 to 3, more preferably 1 or 2, and even more preferably 2.

L¹¹, L¹², L¹³ or L¹⁴ which coordinates to M¹¹ through a carbon atom is not particularly limited, but examples thereof include independently an imino ligand, an aromatic carbon ring ligand (for example, a benzene ligand, a naphthalene ligand, an anthracene ligand, a phenanthrene ligand or the like), and a heterocyclic ligand (for example, a thiophene ligand, a pyridine ligand, a pyrazine ligand, a pyrimidine ligand, a thiazole ligand, an oxazole ligand, a pyrrole ligand, an imidazole ligand, a pyrazole ligand, a condensed ring body thereof (for example, a quinoline ligand, a benzothiazole ligand or the like) or a tautomer thereof).

L¹¹, L¹², L¹³ or L¹⁴ which coordinates to M¹¹ through a nitrogen atom is not particularly limited, but examples thereof include independently a nitrogen-containing heterocyclic ligand (for example, a pyridine ligand, a pyrazine ligand, a pyrimidine ligand, a pyridazine ligand, a triazine ligand, a thiazole ligand, an oxazole ligand, a pyrrole ligand, an imidazole ligand, a pyrazole ligand, a triazole ligand, an oxadiazole ligand, a thiadiazole ligand, a condensed ring body thereof (for example, a quinoline ligand, a benzoxazole ligand, a benzimidazole ligand or the like) and a tautomer thereof (the tautomer in the present invention is defined that the following examples are also regarded as the tautomer. For example, a 5-membered heterocyclic ligand of Compound (24) and a terminal 5-membered heterocyclic ligand of Compound (64), which are described on pages 37 and 41 respectively, are defined to be included in a pyrrole tautomer.), an amino ligand (an alkylamino ligand (having preferably 2 to 30 carbon atoms, more preferably 2 to 20 carbon atoms, and even more preferably 2 to 10 carbon atoms; for example, methylamino or the like), an arylamino ligand (for example, phenylamino or the like), an acylamino ligand (having preferably 2 to 30 carbon atoms, more preferably 2 to 20 carbon atoms, and even more preferably from 2 to 10 carbon atoms; for example, acetylamino, benzoylamino or the like), an alkoxycarbonylamino ligand (having preferably 2 to 30 carbon atoms, more preferably 2 to 20 carbon atoms, and even more preferably 2 to 12 carbon atoms; for example, methoxycarbonylamino or the like), an aryloxycarbonylamino ligand (having preferably 7 to 30 carbon atoms, more preferably 7 to 20 carbon atoms, and even more preferably 7 to 12 carbon atoms; for example, phenyloxycarbonylamino or the like), a sulfonylamino ligand (having preferably 1 to 30 carbon atoms, more preferably 1 to 20 carbon atoms, and even more preferably 1 to 12 carbon atoms; for example, methanesulfonylamino, benzenesulfonylamino or the like), an imino ligand and the like. These ligands may be further substituted.

L¹¹, L¹², L¹³ or L¹⁴ which coordinates to M¹¹ through an oxygen atom is not particularly limited, but examples thereof include independently an alkoxy ligand (having preferably 1 to 30 carbon atoms, more preferably 1 to 20 carbon atoms, and even more preferably 1 to 10 carbon atoms; for example, methoxy, ethoxy, butoxy, 2-ethylhexyloxy or the like), an aryloxy ligand (having preferably 6 to 30 carbon atoms, more preferably 6 to 20 carbon atoms, and even more preferably 6 to 12 carbon atoms; for example, phenyloxy, 1-naphthyloxy, 2-naphthyloxy or the like), a heterocyclic oxy ligand (having preferably 1 to 30 carbon atoms, more preferably 1 to 20 carbon atoms, and even more preferably 1 to 12 carbon atoms; for example, pyridyloxy, pyrazinyloxy, pyrimidyloxy, quinolyloxy or the like), an acyloxy ligand (having preferably 2 to 30 carbon atoms, more preferably 2 to 20 carbon atoms, and even more preferably 2 to 10 carbon atoms; for example, acetoxy, benzoyloxy or the like), a silyloxy ligand (having preferably 3 to 40 carbon atoms, more preferably 3 to 30 carbon atoms, and even more preferably 3 to 24 carbon atoms; for example, trimethylsilyloxy, triphenylsilyloxy or the like), a carbonyl ligand (for example, a ketone ligand, an ester ligand, an amido ligand or the like), and an ether ligand (for example, a dialkyl ether ligand, a diaryl ether ligand, a furyl ligand or the like). These ligands may be further substituted.

L¹¹, L¹², L¹³ or L¹⁴ which coordinates to M¹¹ through a sulfur atom is not particularly limited, but examples thereof include independently an alkylthio ligand (having preferably 1 to 30 carbon atoms, more preferably 1 to 20 carbon atoms, and even more preferably 1 to 12 carbon atoms; for example, methylthio, ethylthio or the like), an arylthio ligand (having preferably 6 to 30 carbon atoms, more preferably 6 to 20 carbon atoms, and even more preferably 6 to 12 carbon atoms; for example, phenylthio or the like), a heterocyclic thio ligand (having preferably 1 to 30 carbon atoms, more preferably 1 to 20 carbon atoms, and even more preferably 1 to 12 carbon atoms; for example, pyridylthio, 2-benzimidazolylthio, 2-benzoxazolylthio, 2-benzthiazolylthio or the like), a thiocarbonyl ligand (for example, a thioketone ligand, a thioester ligand or the like) and a thioether ligand (for example, a dialkylthio ether ligand, a diarylthio ether ligand, a thiofuryl ligand or the like). These ligands may be further substituted.

L¹¹, L¹², L¹³ or L¹⁴ which coordinates to M¹¹ through a phosphorus atom is not particularly limited, but examples thereof include independently a dialkylphosphino group, a diarylphosphino group, a trialkylphosphino group, a triarylphosphino group, a phosphinino group and the like. The groups may be further substituted.

L¹¹ and L¹⁴ each independently represent preferably an aromatic carbon ring ligand, an alkyloxy ligand, an aryloxy ligand, an ether ligand, an alkylthio ligand, an arylthio ligand, an alkylamino ligand, an arylamino ligand, an acylamino ligand, and a nitrogen-containing heterocyclic ligand (for example, a pyridine ligand, a pyrazine ligand, a pyrimidine ligand, a pyridazine ligand, a triazine ligand, a thiazole ligand, an oxazole ligand, a pyrrole ligand, an imidazole ligand, a pyrazole ligand, a triazole ligand, an oxadiazole ligand, a thiadiazole ligand, or a condensed ring body thereof (for example, a quinoline ligand, a benzoxazole ligand, a benzimidazole ligand or the like) or a tautomer thereof, more preferably an aromatic carbon ring ligand, an aryloxy ligand, an arylthio ligand, an arylamino ligand, a pyridine ligand, a pyrazine ligand, an imidazole ligand, a condensed ring body thereof (for example, a quinoline ligand, a quinoxaline ligand, a benzimidazole ligand or the like) or a tautomer thereof, and even more preferably an aromatic carbon ring ligand, an aryloxy ligand, an arylthio ligand, or an arylamino ligand. Among them, an aromatic carbon ring ligand or an aryloxy ligand is particularly preferable.

L¹²and L¹³ each independently preferably represent a ligand forming a coordination bond with M¹¹. Examples of the ligand forming a coordination bond with M¹¹ preferably include a pyridine ring, a pyrazine ring, a pyrimidine ring, a triazine ring, a thiazole ring, an oxazole ring, a pyrrole ring, a triazole ring, a condensed ring body thereof (for example, a quinoline ring, a benzoxazole ring, a benzimidazole ring, an indolenine ring or the like) and a tautomer thereof, more preferably a pyridine ring, a pyrazine ring, a pyrimidine ring, a pyrrole ring, a condensed ring body thereof (for example, a quinoline ring, benzpyrrole, or the like) and a tautomer thereof, and even more preferably a pyridine ring, a pyrazine ring, a pyrimidine ring and a condensed ring body thereof (for example, a quinoline ring or the like). Among them, a pyridine ring or a condensed ring body including a pyridine ring (for example, a quinoline ring or the like) is particularly preferable.

In formula (A), L¹⁵ represents a ligand which coordinates to M¹¹. L¹⁵ represents preferably a monodentate to tetradentate ligand, and more preferably an anionic monodentate to tetradentate ligand. The anionic monodentate to tetradentate ligand is not particularly limited, but preferred examples thereof include a halogen ligand, a 1,3-diketone ligand (for example, an acetylacetone ligand or the like), a monoanionic bidentate ligand including a pyridine ligand (for example, a picolinic acid ligand, a 2-(2-hydroxyphenyl)-pyridine ligand or the like) and a tetradentate ligand formed by L¹¹, Y¹², L¹², Y¹¹, L¹³, Y¹³ and L¹⁴, more preferably a 1,3-diketone ligand (for example, an acetylacetone ligand or the like), a monoanionic bidentate ligand including a pyridine ligand (for example, a picolinic acid ligand, a 2-(2-hydroxyphenyl)-pyridine ligand or the like), and a tetradentate ligand formed by L¹¹, Y¹², L¹², Y¹¹, L¹³, Y¹³ and L¹⁴, and even more preferably a 1,3-diketone ligand (for example, an acetylacetone ligand or the like) and a monoanionic bidentate ligand including a pyridine ligand (for example, a picolinic acid ligand, a 2-(2-hydroxyphenyl)-pyridine ligand or the like). Among them, a 1,3-diketone ligand (for example, acetylacetone ligand or the like) is particularly preferable. The coordination numbers and ligand numbers do not exceed the coordination number of the metal. L¹⁵ may bond to both L¹¹ and L¹⁴ to form a cyclic ligand with them.

In formula (A), Y¹¹, Y¹² and Y¹³ each independently represent a linking group, a single bond or a double bond. The linking group is not particularly limited, but a linking group comprising an atom selected from carbon atom, nitrogen atom, oxygen atom, sulfur atom, silicon atom and phosphorus atom is preferable. Specific examples of the linking group are described below.

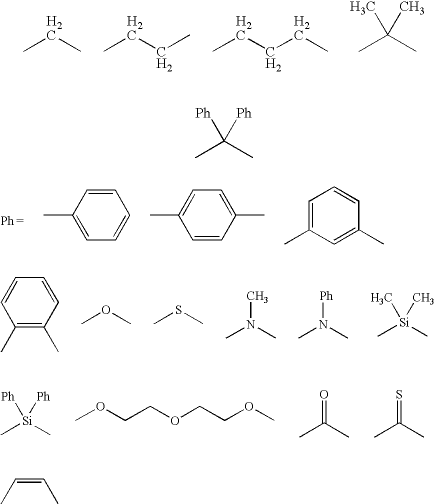

In the case where Y¹¹, Y¹² or Y¹³ represents a linking group, bonds between L¹¹ and Y¹², Y¹² and L¹², L¹² and Y¹¹, Y¹¹ and L¹³, L¹³ and Y¹³, and Y¹³ and L¹⁴ each independently represent a single bond or a double bond.

Preferably, Y¹¹, Y¹² and Y¹³ each independently represent a single bond, a double bond, a carbonyl linking group, an alkylene linking group, or an alkenylene group. Y¹¹ is more preferably a single bond or an alkylene group, and even more preferably an alkylene group. Y¹² and Y¹³ each independently represent more preferably a single bond or an alkenylene group, and even more preferably a single bond.

The ring formed by Y¹², L¹¹, L¹², and M¹¹, the ring formed by Y¹¹, L¹², L¹³ and M¹¹, and the ring formed by Y¹³, L¹³, L¹⁴ and M¹¹ are each preferably a 4- to 10-membered ring, more preferably a 5- to 7-membered ring, and even more preferably a 5- or 6-membered ring.

In formula (A), n11 represents from 0 to 4. When M¹¹ is a metal having a coordination number of 4, n11 represents 0. In the case where M¹¹ is a metal having a coordination number of 6, n11 preferably represents 1 or 2, and more preferably 1. When M¹¹ is a metal having a coordination number of 6 and n11 represents 1, L¹⁵ represents a bidentate ligand. When M¹¹ is a metal having a coordination number of 6 and n11 represents 2, L¹⁵ represents a monodentate ligand. In the case where M¹¹ is a metal having a coordination number of 8, n11 preferably represents 1 to 4, more preferably 1 or 2, and even more preferably 1. When M¹¹ is a metal having a coordination number of 8 and n11 represents 1, L¹⁵ represents a tetradentate ligand. When M¹¹ is a metal having a coordination number of 8 and n11 represents 2, L¹⁵ represents a bidentate ligand. When n11 is 2 or more, plural L¹⁵s may be the same or different from each other.

Specific examples of the compound represented by formula (A) include the following compounds, but it should be noted that the present invention is not limited thereto.

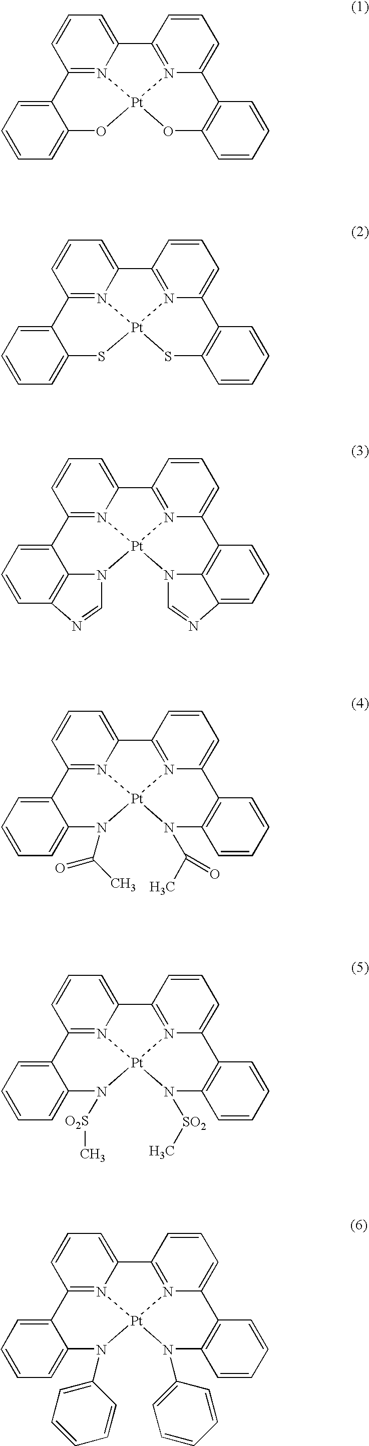

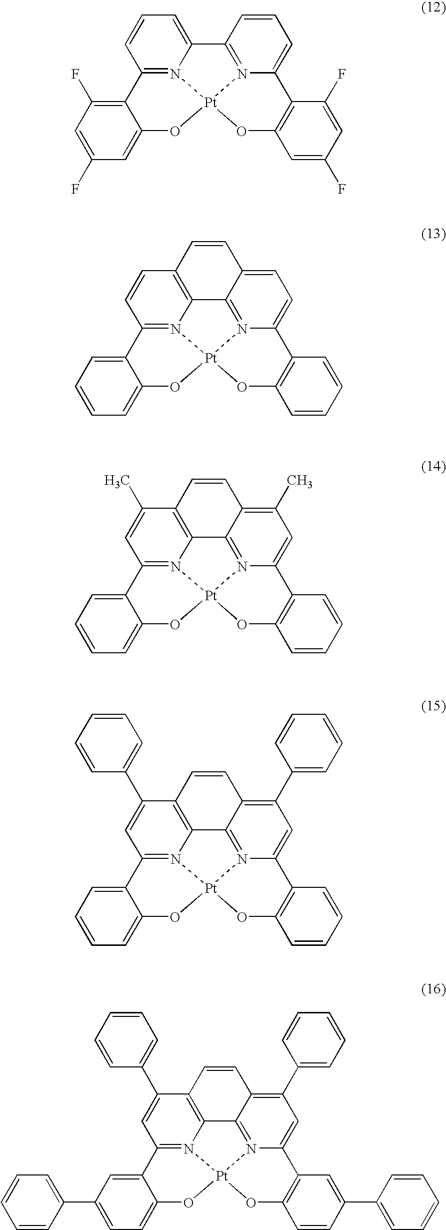

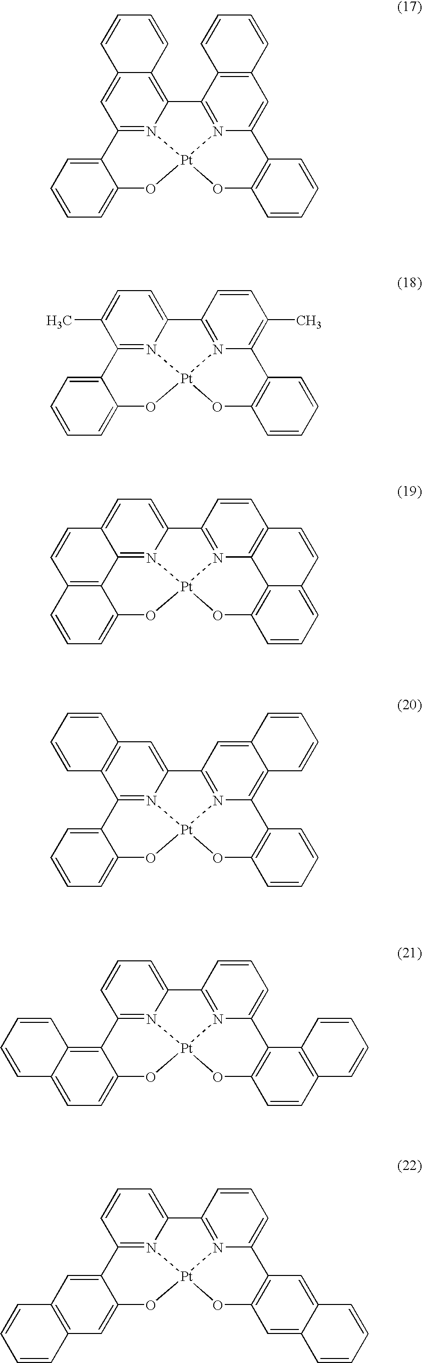

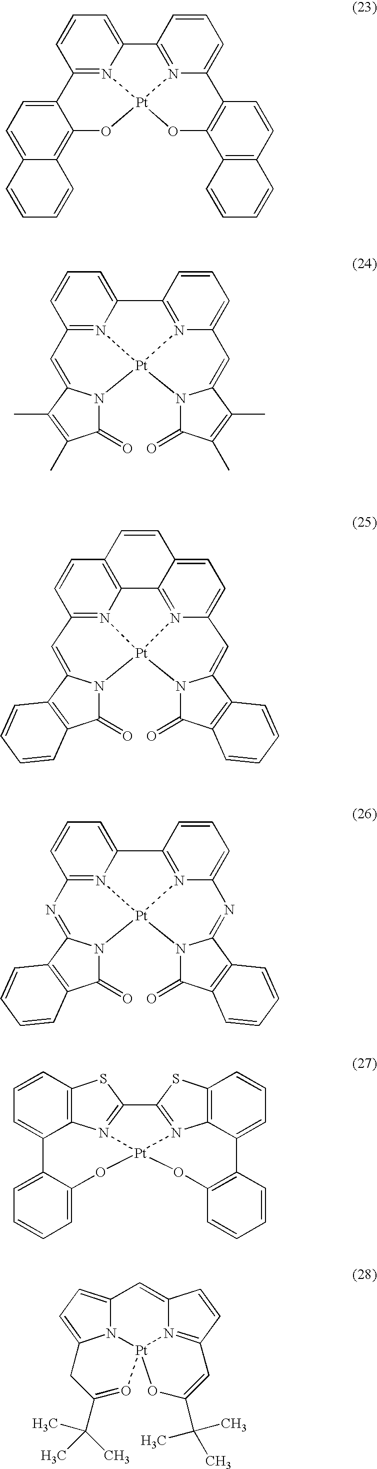

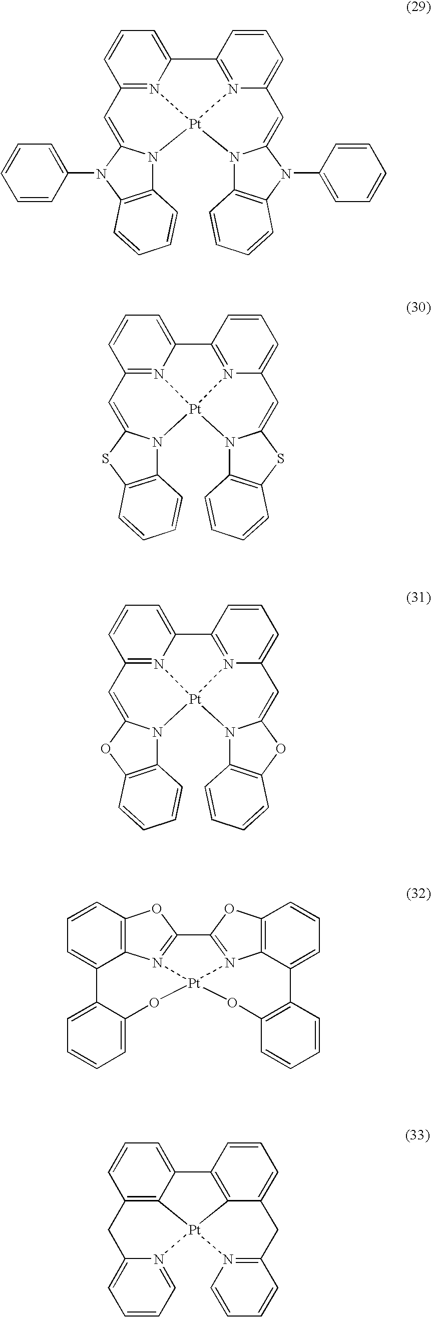

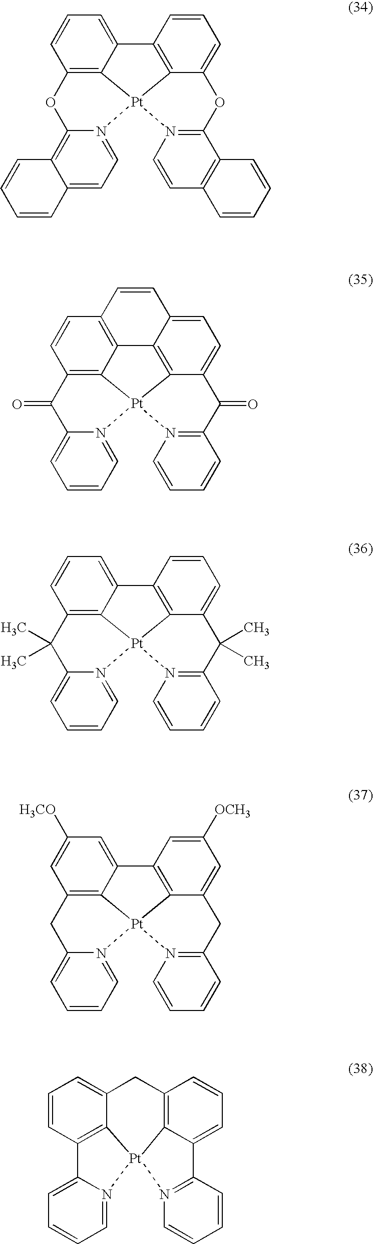

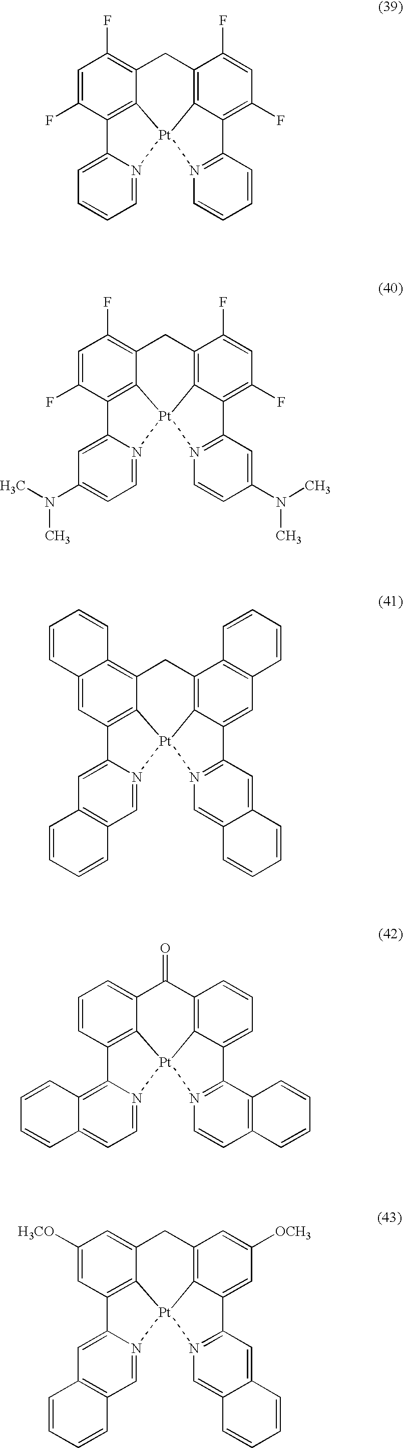

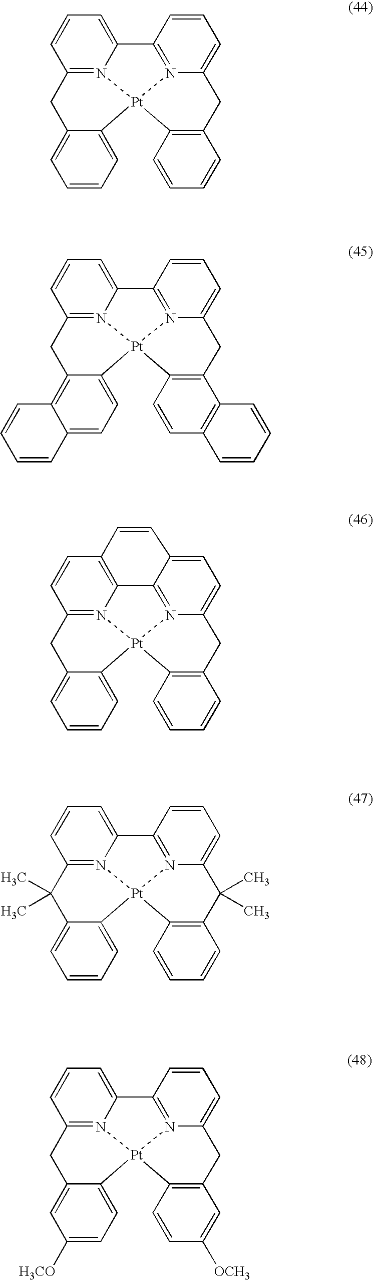

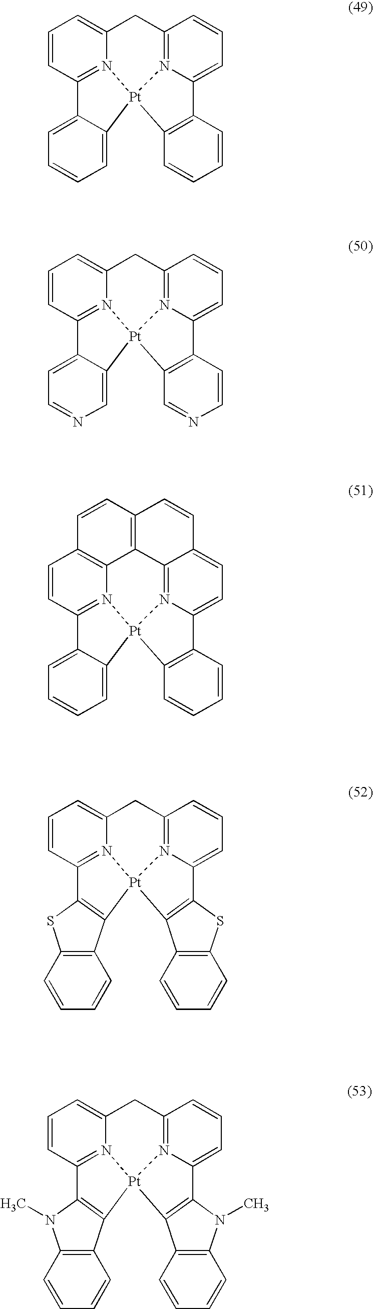

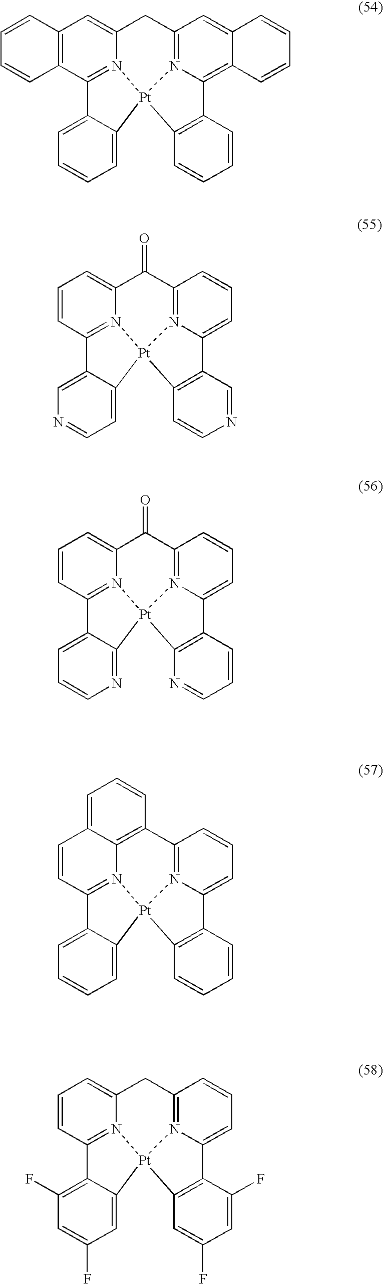

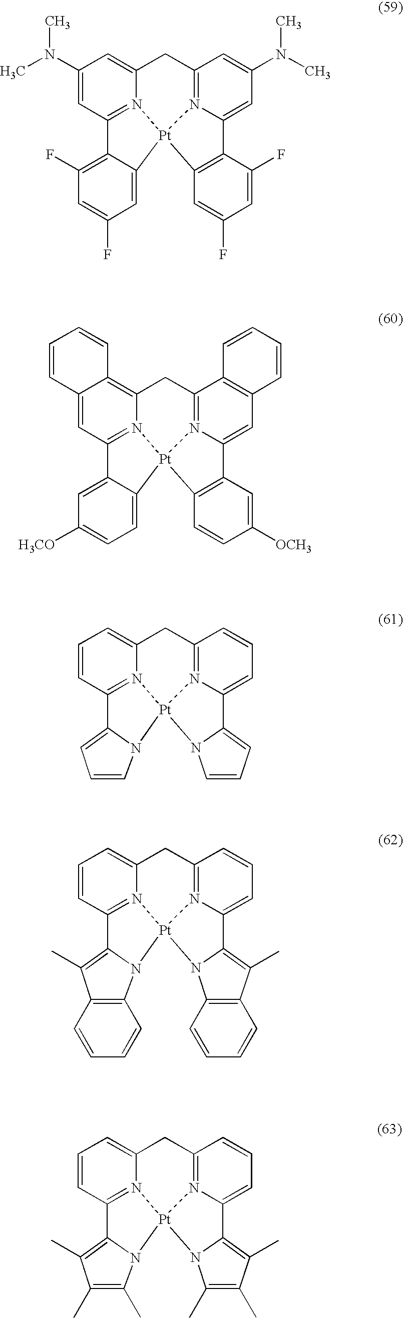

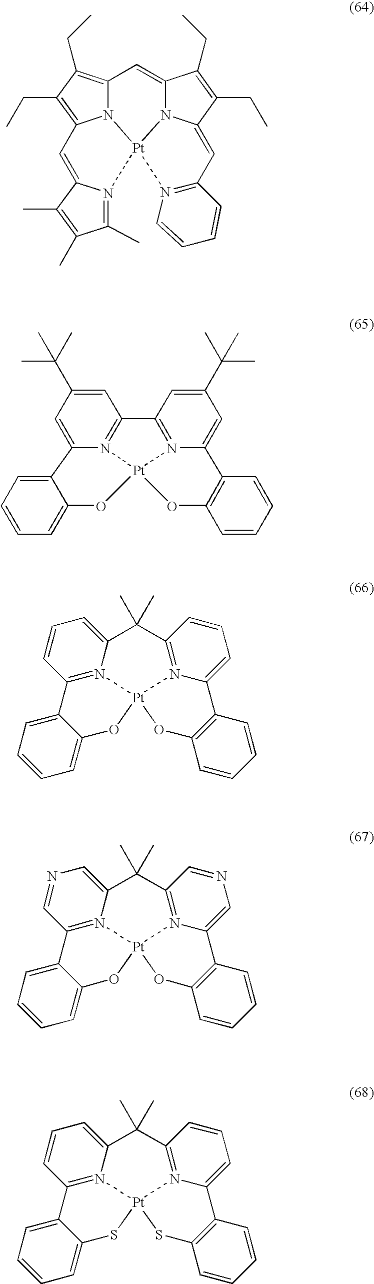

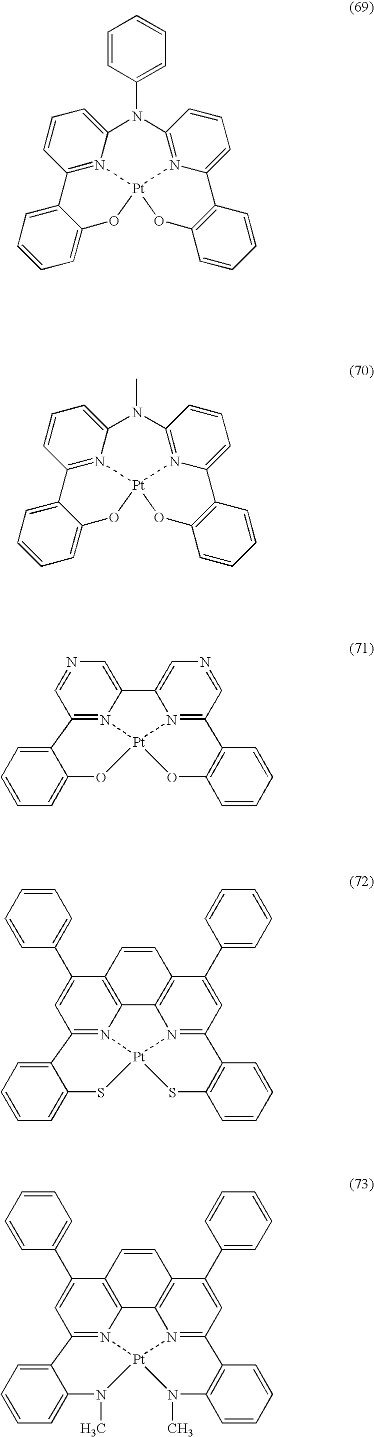

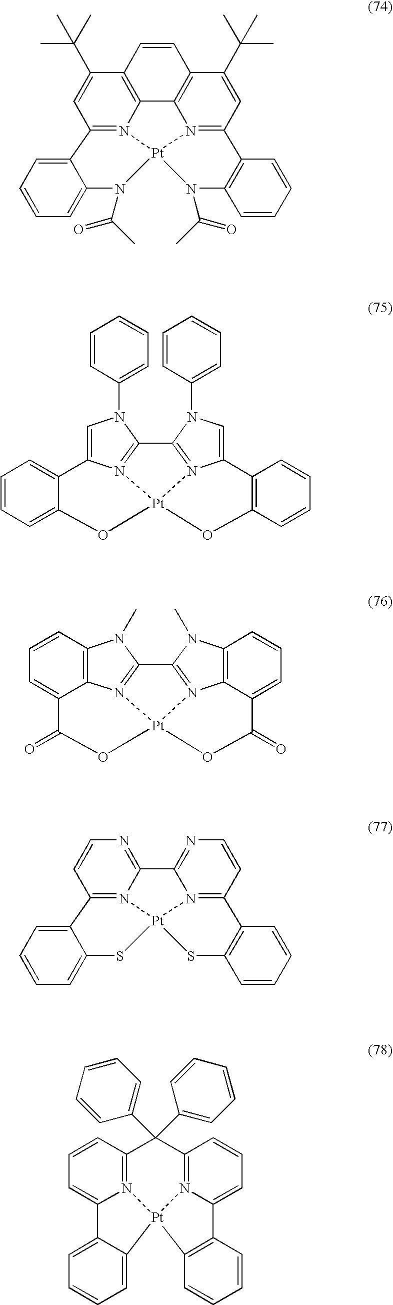

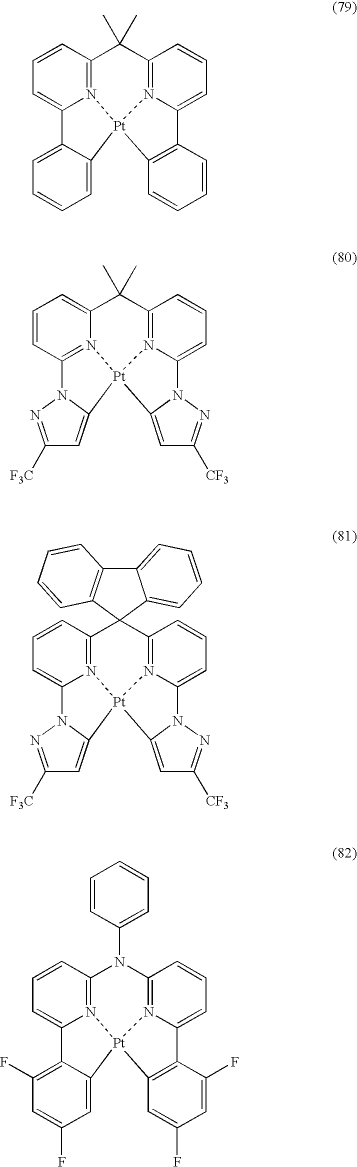

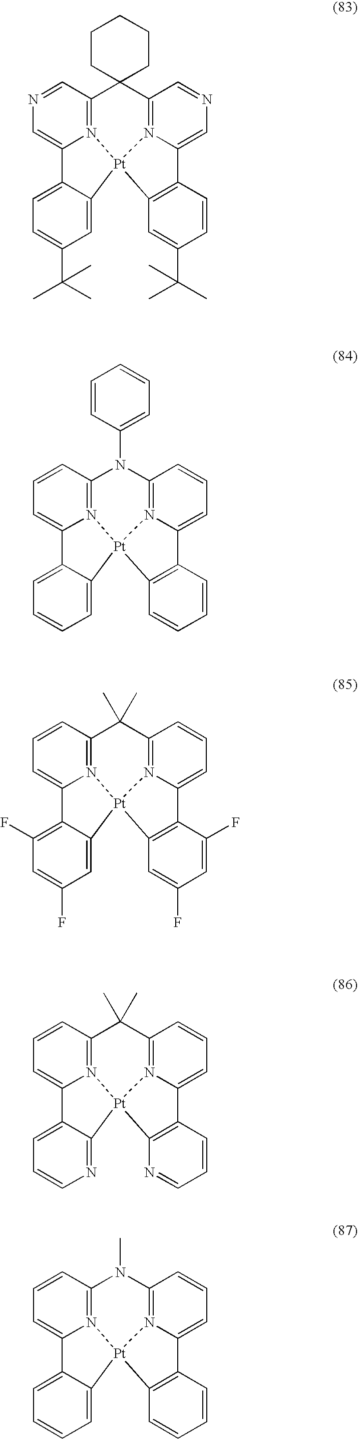

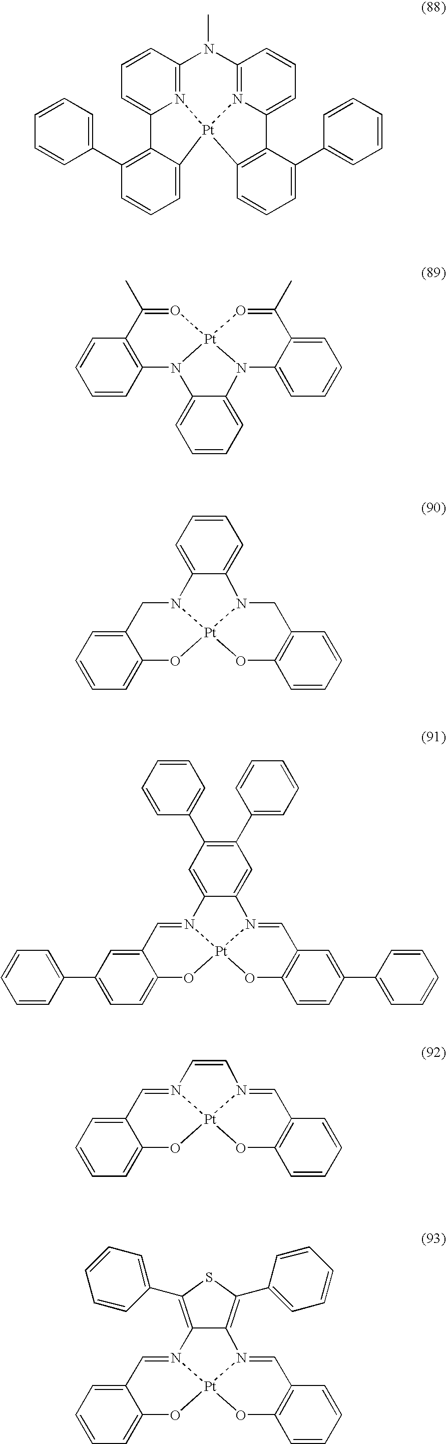

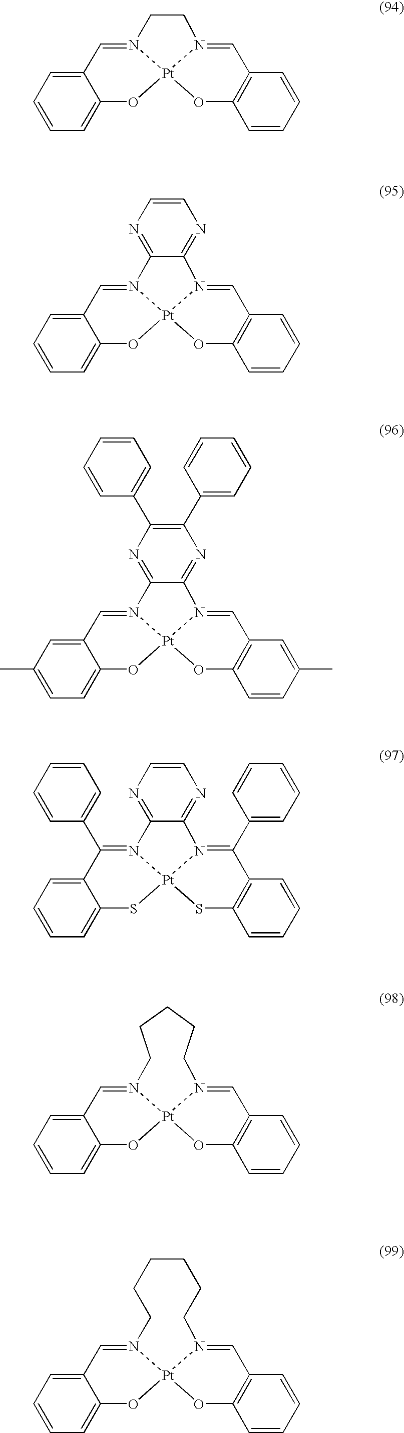

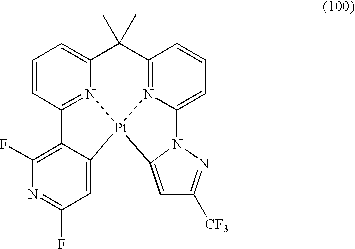

Furthermore, a hole transporting light emitting material described below can be preferably used. It should be noted that the present invention is not limited thereto.

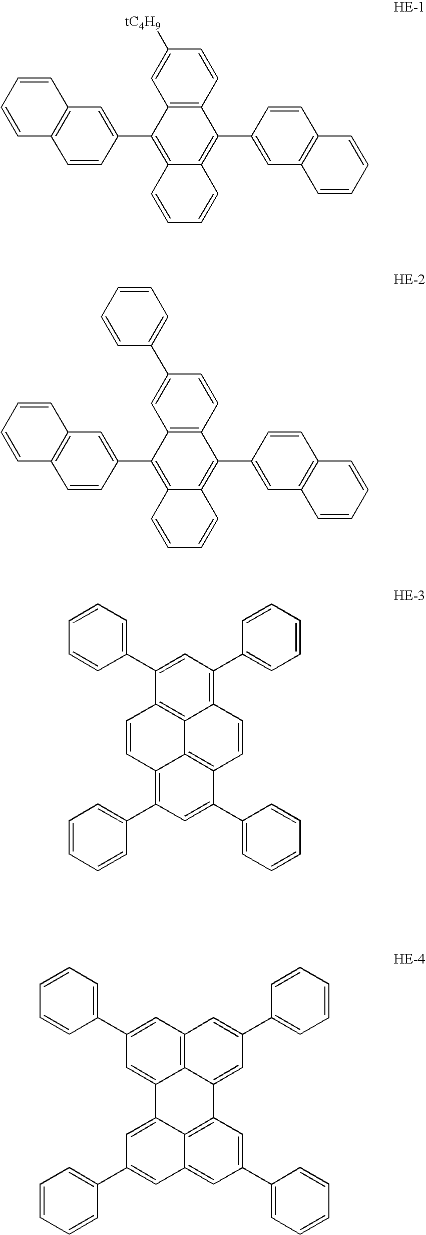

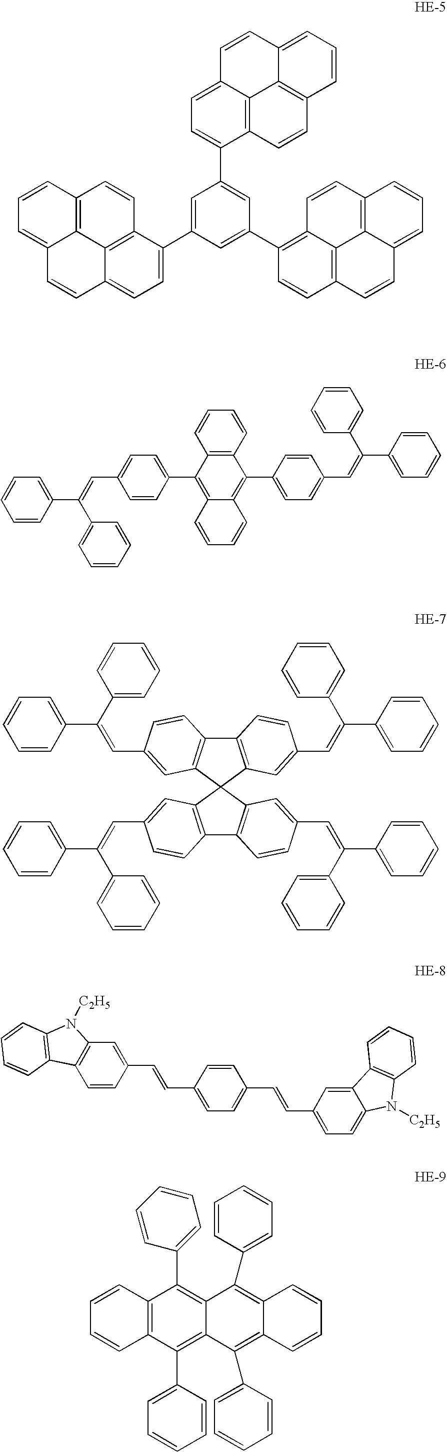

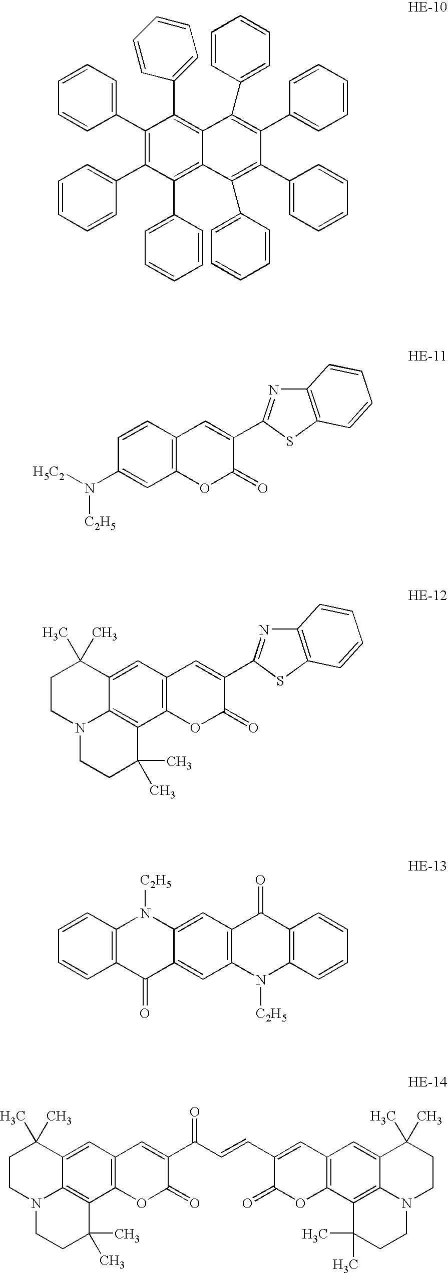

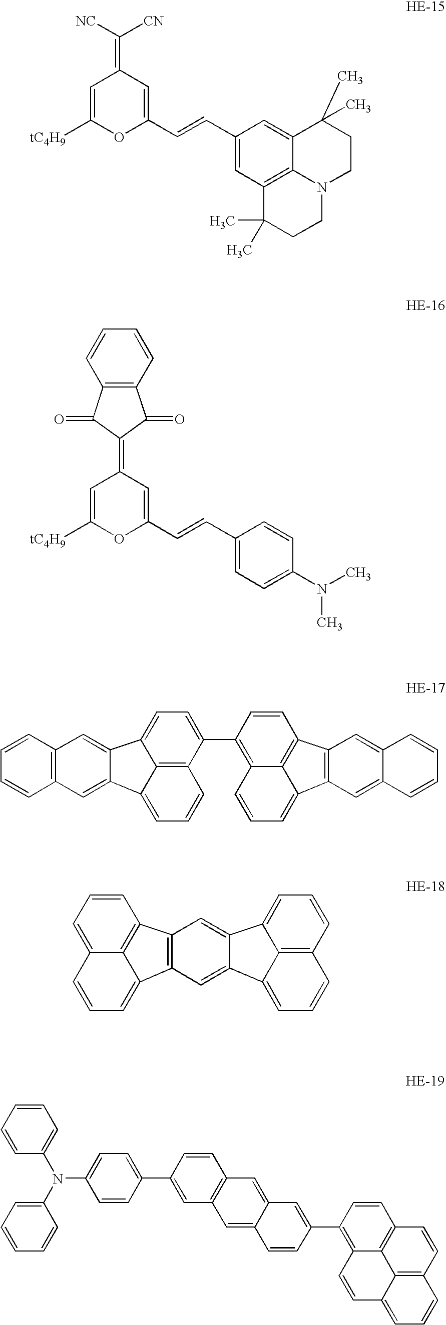

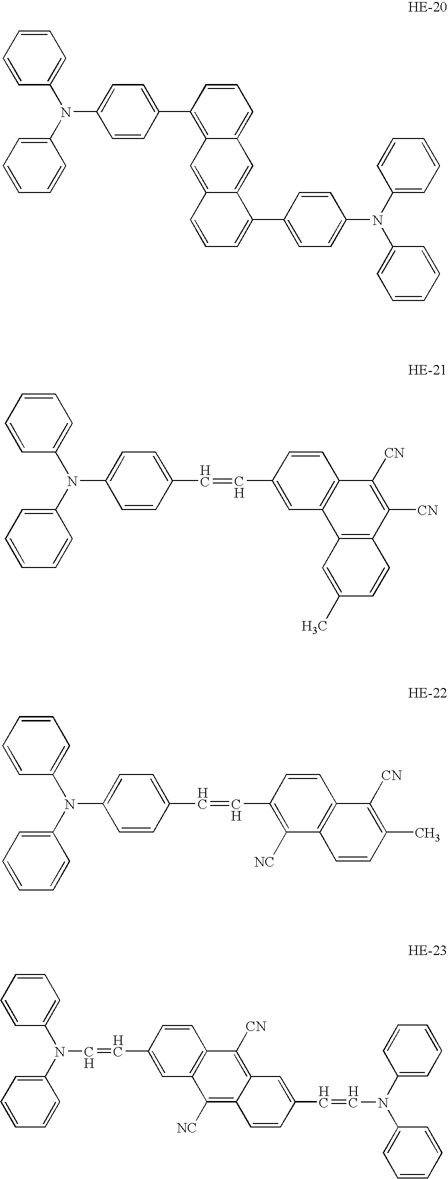

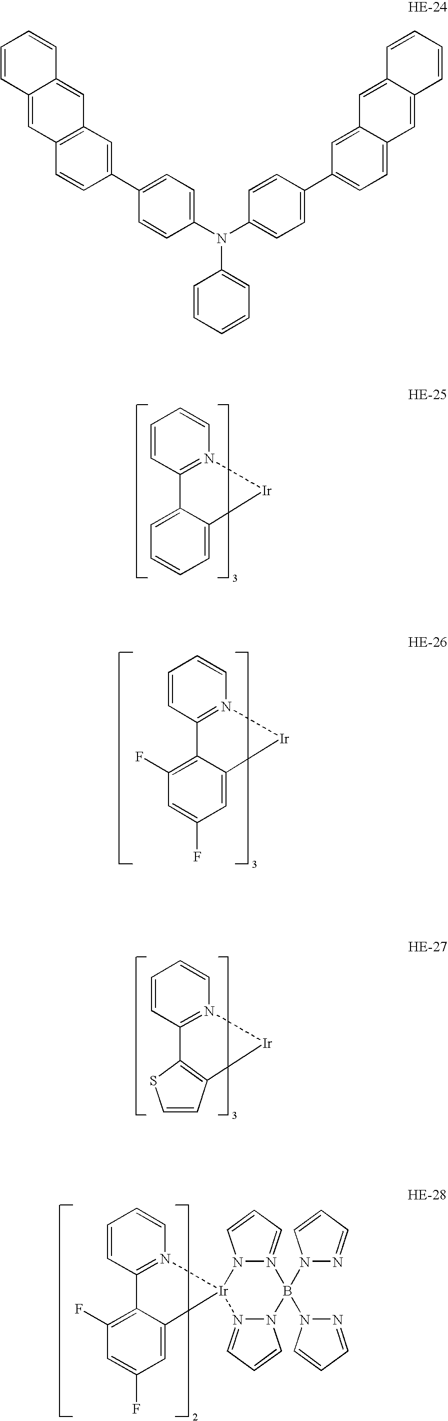

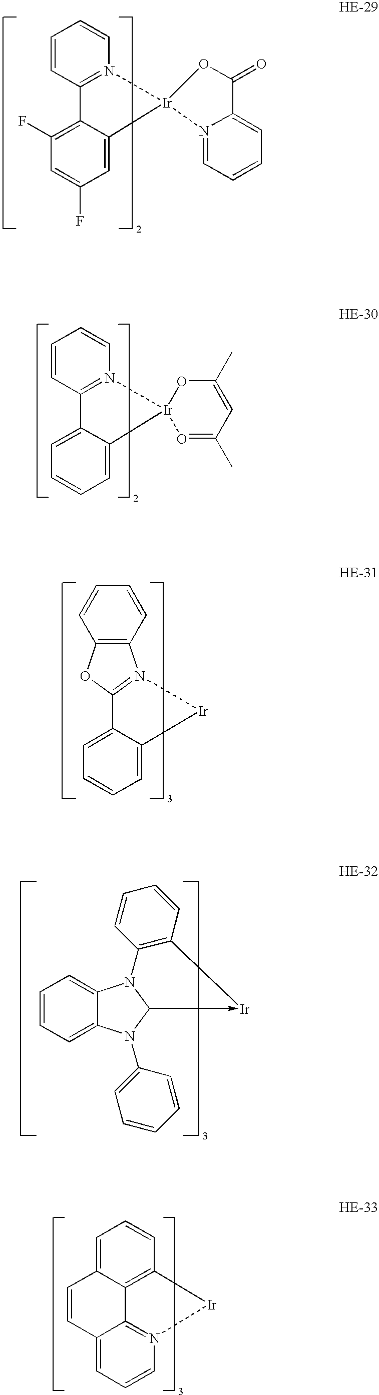

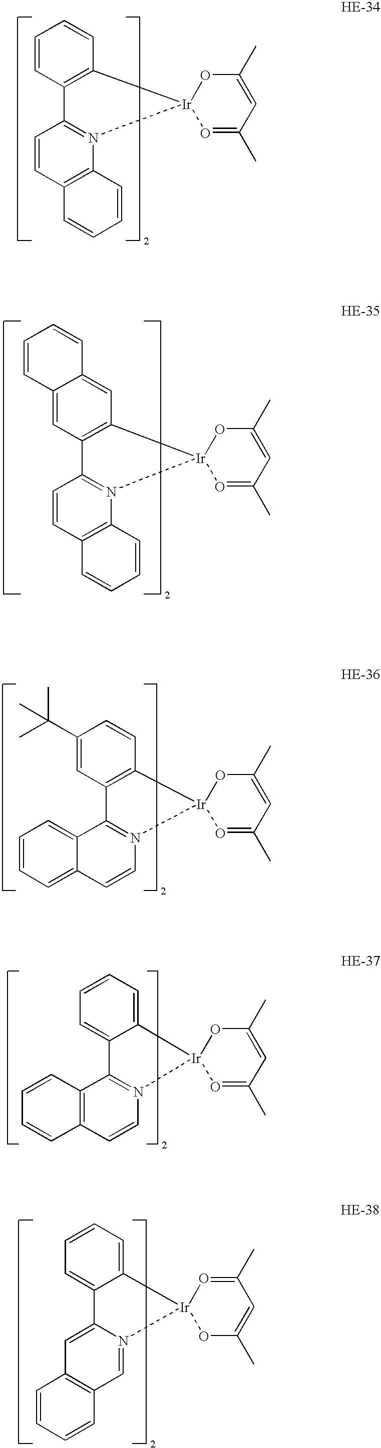

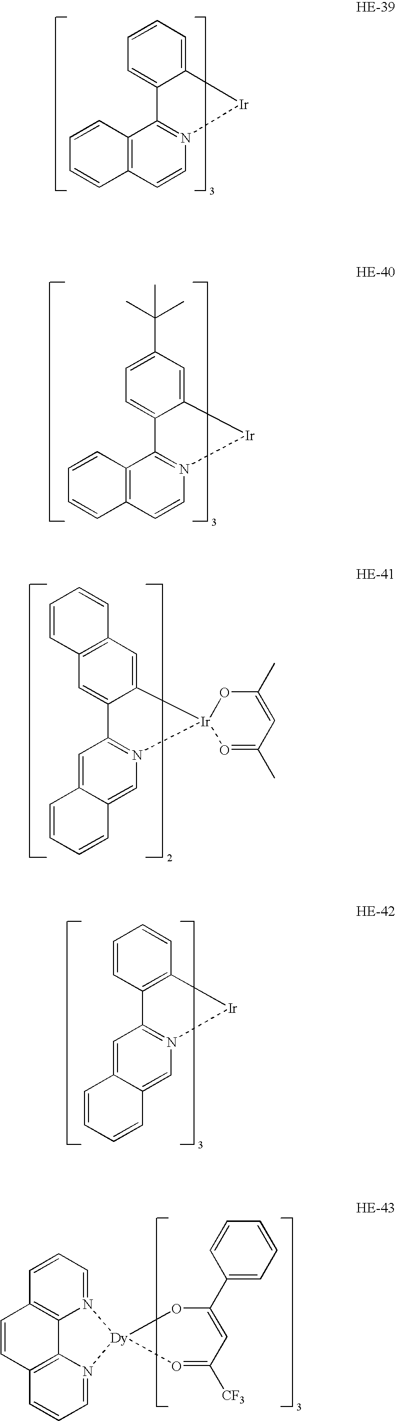

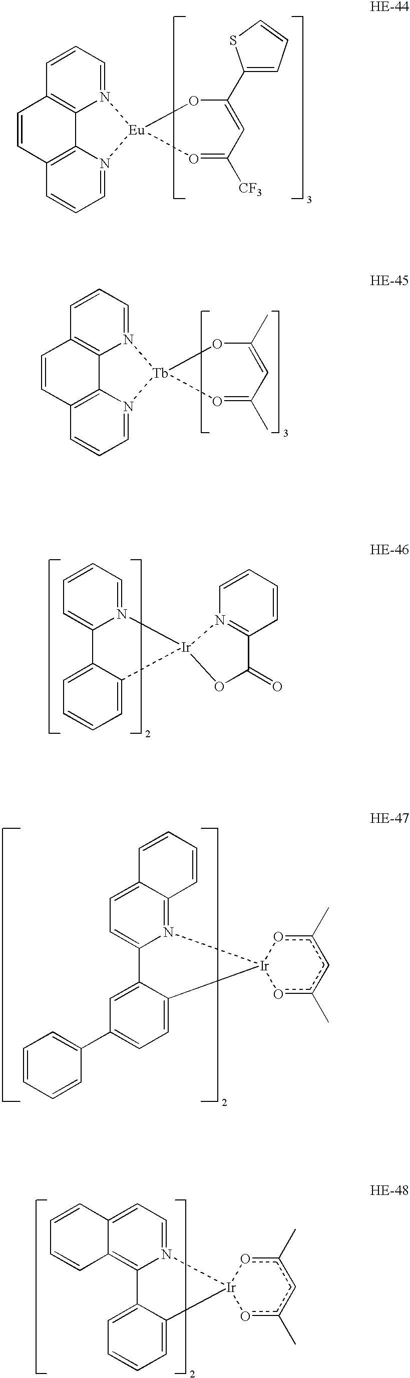

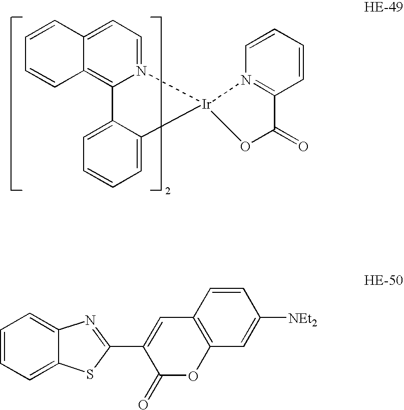

(Electron Transporting Host Material)

The electron transporting host material used in the present invention preferably has an electron affinity Ea of from 2.5 eV to 3.5 eV, more preferably from 2.6 eV to 3.4 eV, and even more preferably from 2.8 eV to 3.3 eV in view of improvement in durability and decrease in driving voltage. Furthermore, it is preferred that an ionization potential Ip of the electron transporting host material is from 5.7 eV to 7.5 eV, more preferably from 5.8 eV to 7.0 eV, and even more preferably from 5.9 eV to 6.5 eV in view of improvement in durability and decrease in driving voltage.

Specific examples of the electron transporting host material include pyridine, pyrimidine, triazine, imidazole, pyrazole, triazole, oxazole, oxadiazole, fluorenone, anthraquinonedimethane, anthrone, diphenylquinone, thiopyrandioxide, carbodiimide, fluorenylidenemethane, distyrylpyrazine, fluorine-substituted aromatic compounds, aromatic ring tetracarboxylic anhydrides of naphthalene, perylene or the like, phthalocyanine, derivatives thereof (which may form a condensed ring with another ring), and a variety of metal complexes represented by metal complexes of 8-quinolinol derivative, metal phthalocyanine, and metal complexes having benzoxazole or benzothiazole as the ligand.

Preferable electron transporting host materials are metal complexes, azole derivatives (benzimidazole derivatives, imidazopyridine derivatives and the like), and azine derivatives (pyridine derivatives, pyrimidine derivatives, triazine derivatives and the like). Among these, metal complex compounds are more preferred in the present invention in view of durability. As the metal complex compound, a metal complex containing a ligand having at least one nitrogen atom, oxygen atom, or sulfur atom to be coordinated to the metal is more preferable.

Although a metal ion in the metal complex is not particularly limited, a beryllium ion, a magnesium ion, an aluminum ion, a gallium ion, a zinc ion, an indium ion, a tin ion, a platinum ion, or a palladium ion is preferred; more preferable is a beryllium ion, an aluminum ion, a gallium ion, a zinc ion, a platinum ion, or a palladium ion; and even more preferable is an aluminum ion, a zinc ion, a platinum ion or a palladium ion.

Although there are a variety of well-known ligands to be contained in the above-described metal complexes, examples thereof include ligands described in “Photochemistry and Photophysics of Coordination Compounds” authored by H. Yersin, published by Springer-Verlag Company in 1987; “YUHKI KINZOKU KAGAKU —KISO TO OUYOU— (Organometallic Chemistry —Fundamental and Application—)” authored by Akio Yamamoto, published by Shokabo Publishing Co., Ltd. in 1982; and the like.

The ligands are preferably nitrogen-containing heterocyclic ligands (having preferably 1 to 30 carbon atoms, more preferably 2 to 20 carbon atoms, and particularly preferably 3 to 15 carbon atoms), and they may be a unidentate ligand or a bi- or higher-dentate ligand. Preferable are bi- to hexa-dentate ligands, and mixed ligands of bi- to hexa-dentate ligands with a unidentate ligand are also preferable.

Examples of the ligands include azine ligands (e.g., pyridine ligands, bipyridyl ligands, terpyridine ligands and the like); hydroxyphenylazole ligands (e.g. hydroxyphenylbenzimidazole ligands, hydroxyphenylbenzoxazole ligands, hydroxyphenylimidazole ligands, hydroxyphenylimidazopyridine ligands and the like); alkoxy ligands (those having preferably 1 to 30 carbon atoms, more preferably 1 to 20 carbon atoms, and particularly preferably 1 to 10 carbon atoms, examples of which include methoxy, ethoxy, butoxy, 2-ethylhexyloxy and the like); aryloxy ligands (those having preferably 6 to 30 carbon atoms, more preferably 6 to 20 carbon atoms, and particularly preferably 6 to 12 carbon atoms, examples of which include phenyloxy, 1-naphthyloxy, 2-naphthyloxy, 2,4,6-trimethylphenyloxy, 4-biphenyloxy and the like); heteroaryloxy ligands (those having preferably 1 to 30 carbon atoms, more preferably 1 to 20 carbon atoms, and particularly preferably 1 to 12 carbon atoms, examples of which include pyridyloxy, pyrazinyloxy, pyrimidyloxy, quinolyloxy and the like); alkylthio ligands (those having preferably 1 to 30 carbon atoms, more preferably 1 to 20 carbon atoms, and particularly preferably 1 to 12 carbon atoms, examples of which include methylthio, ethylthio and the like); arylthio ligands (those having preferably 6 to 30 carbon atoms, more preferably 6 to 20 carbon atoms, and particularly preferably 6 to 12 carbon atoms, examples of which include phenylthio and the like); heteroarylthio ligands (those having preferably 1 to 30 carbon atoms, more preferably 1 to 20 carbon atoms, and particularly preferably 1 to 12 carbon atoms, examples of which include pyridylthio, 2-benzimidazolylthio, 2-benzoxazolylthio, 2-benzothiazolylthio and the like); siloxy ligands (those having preferably 1 to 30 carbon atoms, more preferably 3 to 25 carbon atoms, and particularly preferably 6 to 20 carbon atoms, examples of which include a triphenylsiloxy group, a triethoxysiloxy group, a triisopropylsiloxy group and the like); aromatic hydrocarbon anion ligands (those having preferably 6 to 30 carbon atoms, more preferably 6 to 25 carbon atoms, and particularly preferably 6 to 20 carbon atoms, examples of which include a phenyl anion, a naphthyl anion, an anthranyl anion and the like); aromatic heterocyclic anion ligands (those having preferably 1 to 30 carbon atoms, more preferably 2 to 25 carbon atoms, and particularly preferably 2 to 20 carbon atoms, examples of which include a pyrrole anion, a pyrazole anion, a triazole anion, an oxazole anion, a benzoxazole anion, a thiazole anion, a benzothiazole anion, a thiophene anion, a benzothiophene anion and the like); indolenine anion ligands and the like. Among these, nitrogen-containing heterocyclic ligands, aryloxy ligands, heteroaryloxy groups, or siloxy ligands are preferable, and nitrogen-containing heterocyclic ligands, aryloxy ligands, siloxy ligands, aromatic hydrocarbon anion ligands, or aromatic heterocyclic anion ligands are more preferable.

Examples of the metal complex electron-transporting host material include compounds described, for example, in JP-A Nos. 2002-235076, 2004-214179, 2004-221062, 2004-221065, 2004-221068, 2004-327313 and the like.

Specific examples of the electron transporting host material include the following materials, but it should be noted that the present invention is not limited thereto.

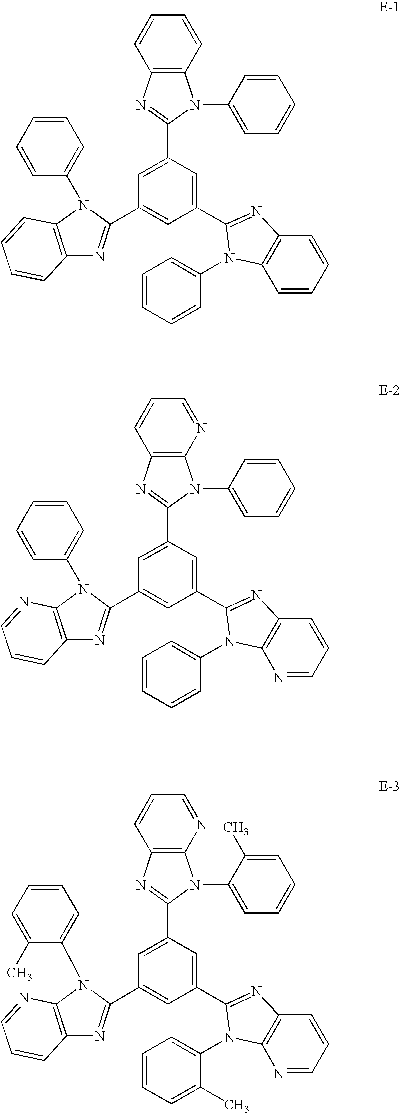

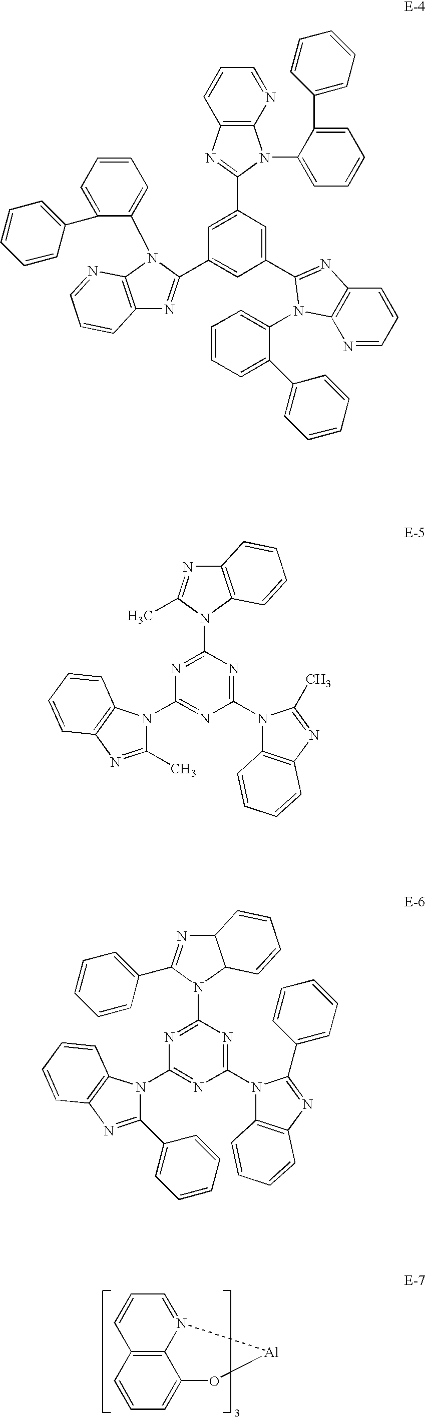

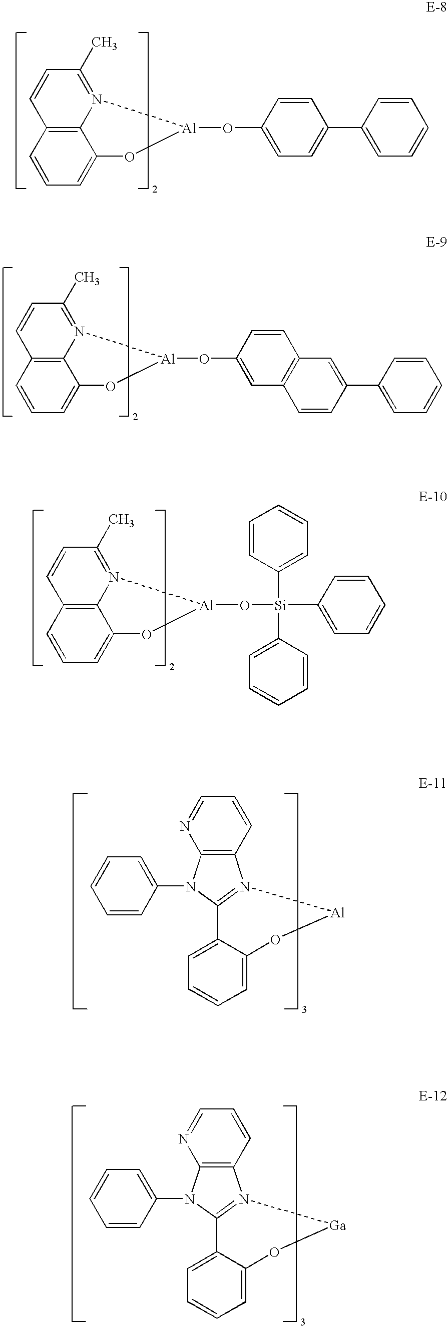

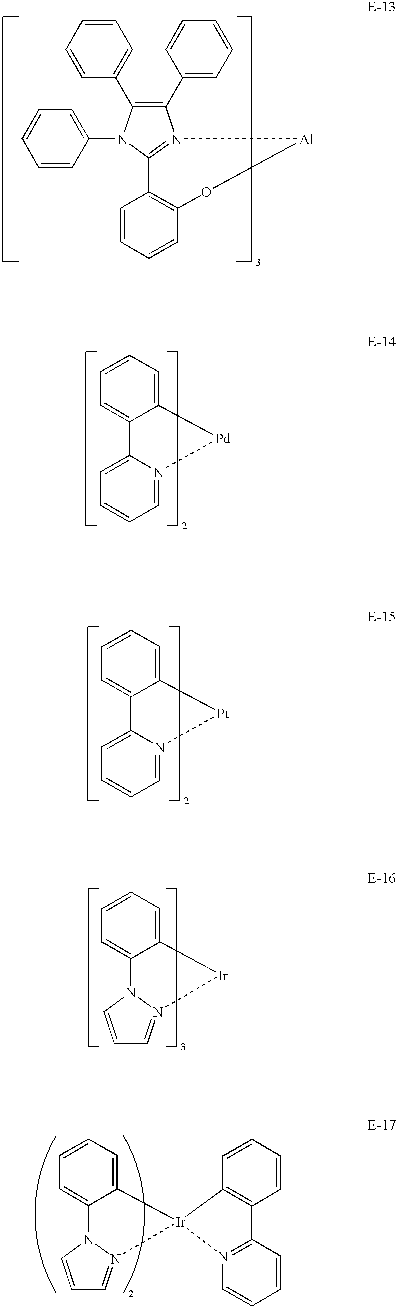

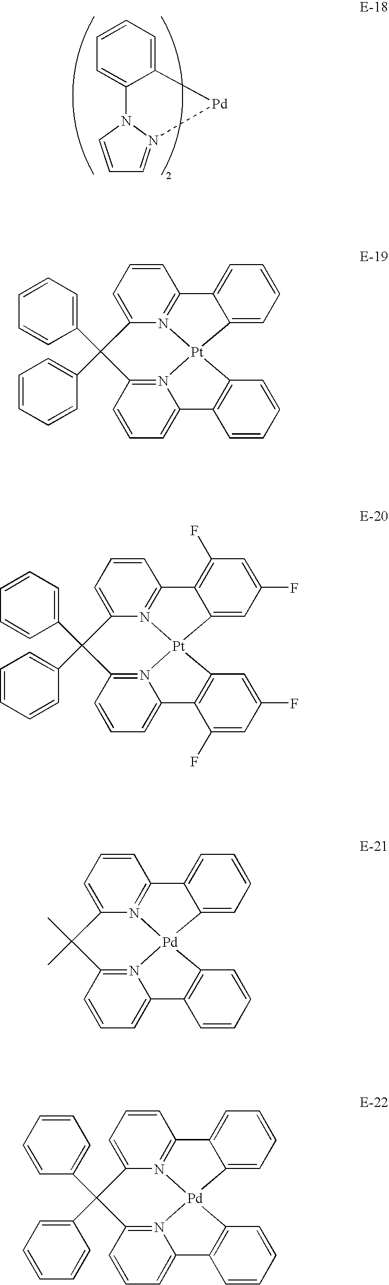

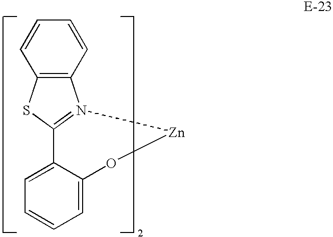

As the electron transporting host material, E-1 to E-6, E-8, E-9, E-10, E-21, or E-22 is preferred, E-3, E-4, E-6, E-8, E-9, E-10, E-21, or E-22 is more preferred, and E-3, E-4, E-8, E-9, E-21, or E-22 is even more preferred.

(Hole Transporting Host Material)

The hole transporting host material used in the light-emitting layer of the present invention preferably has an ionization potential Ip of from 5.1 eV to 6.4 eV, more preferably from 5.4 eV to 6.2 eV, and even more preferably from 5.6 eV to 6.0 eV in view of improvement in durability and decrease in driving voltage. Furthermore, it preferably has an electron affinity Ea of from 1.2 eV to 3.1 eV, more preferably from 1.4 eV to 3.0 eV, and even more preferably from 1.8 eV to 2.8 eV in view of improvement in durability and decrease in driving voltage.

Specific examples of such hole transporting host material include pyrrole, indole, carbazole, azaindole, azacarbazole, pyrazole, imidazole, polyarylalkane, pyrazoline, pyrazolone, phenylenediamine, arylamine, amino-substituted chalcone, styrylanthracene, fluorenone, hydrazone, stilbene, silazane, aromatic tertiary amine compounds, styrylamine compounds, aromatic dimethylidine compounds, porphyrin compounds, polysilane compounds, poly(N-vinylcarbazole), aniline copolymers, electric conductive high-molecular oligomers such as thiophene oligomers, polythiophenes and the like, organosilanes, carbon films, derivatives thereof, and the like.

Among these, indole derivatives, carbazole derivatives, azaindole derivatives, azacarbazole derivatives, aromatic tertiary amine compounds, and thiophene derivatives are preferable, and particularly, compounds containing a plurality of indole skeletons, carbazole skeletons, azaindole skeletons, azacarbazole skeletons, and/or aromatic tertiary amine skeletons in the molecule are preferred.

As specific examples of the hole transporting host material described above, the following compounds may be listed, but the present invention is not limited thereto.

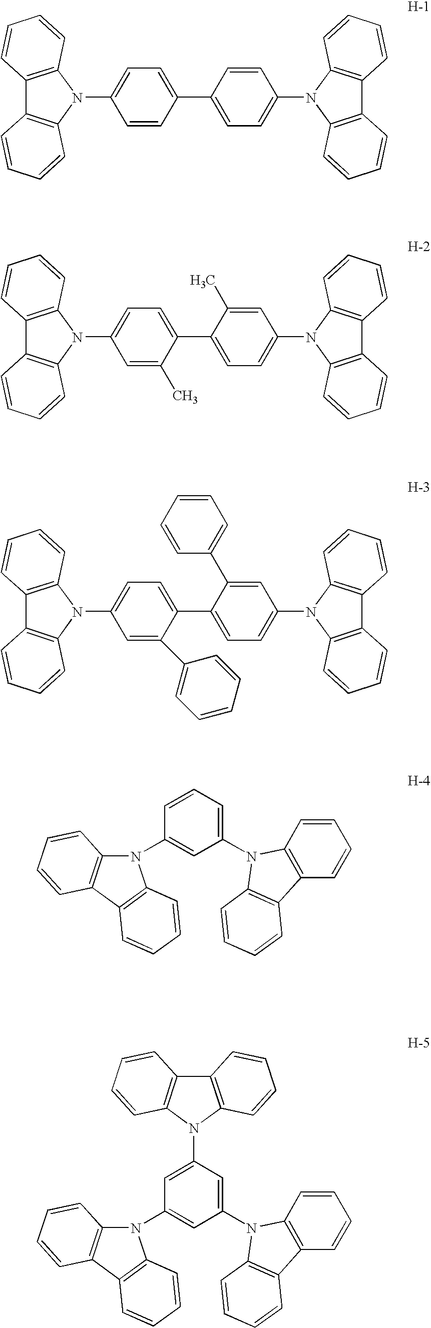

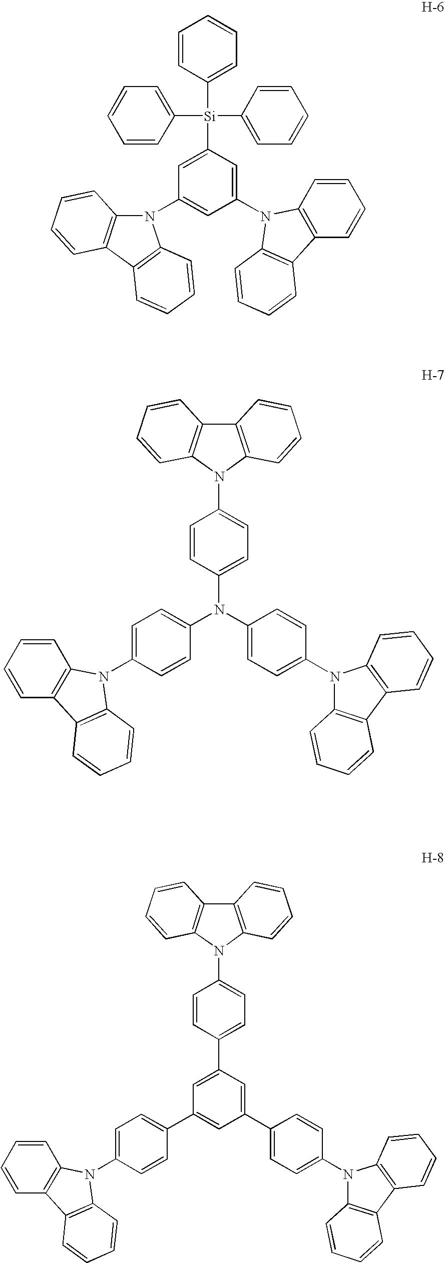

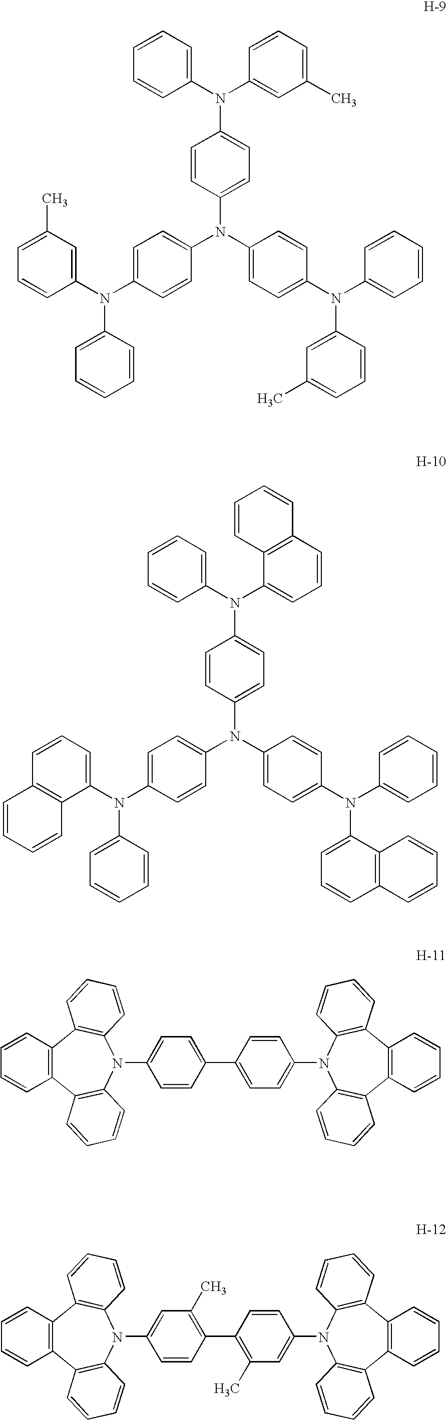

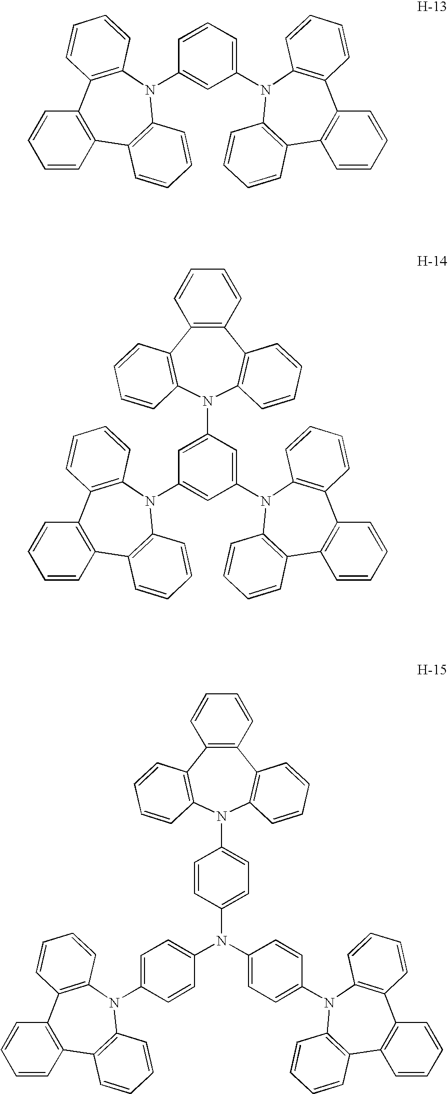

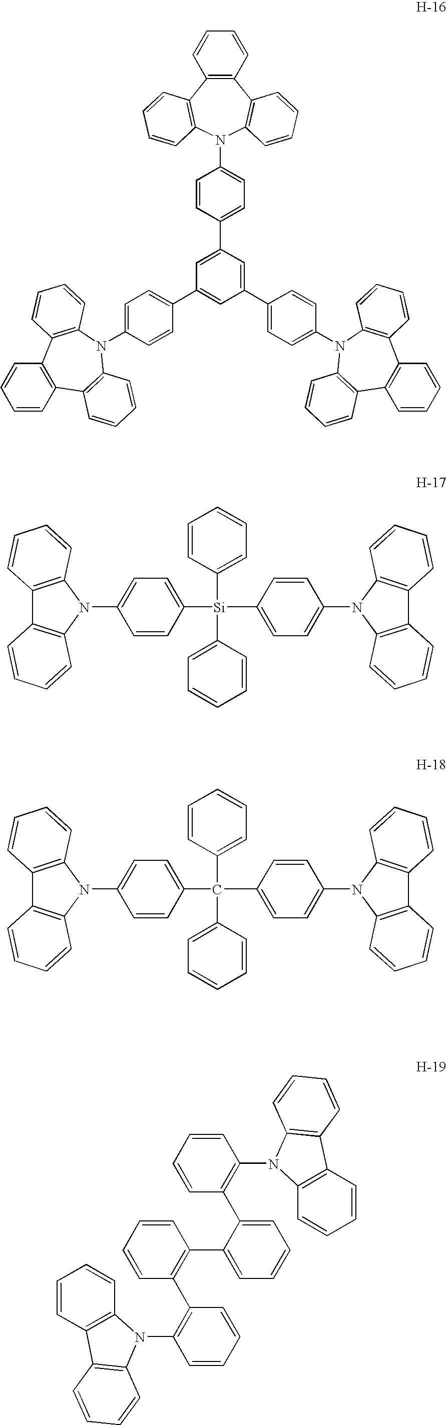

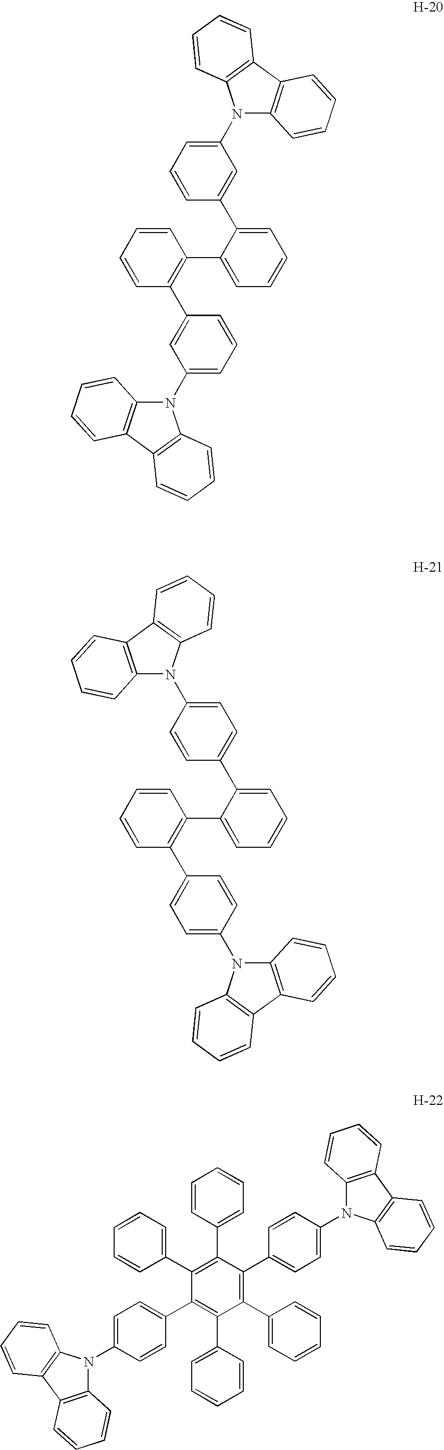

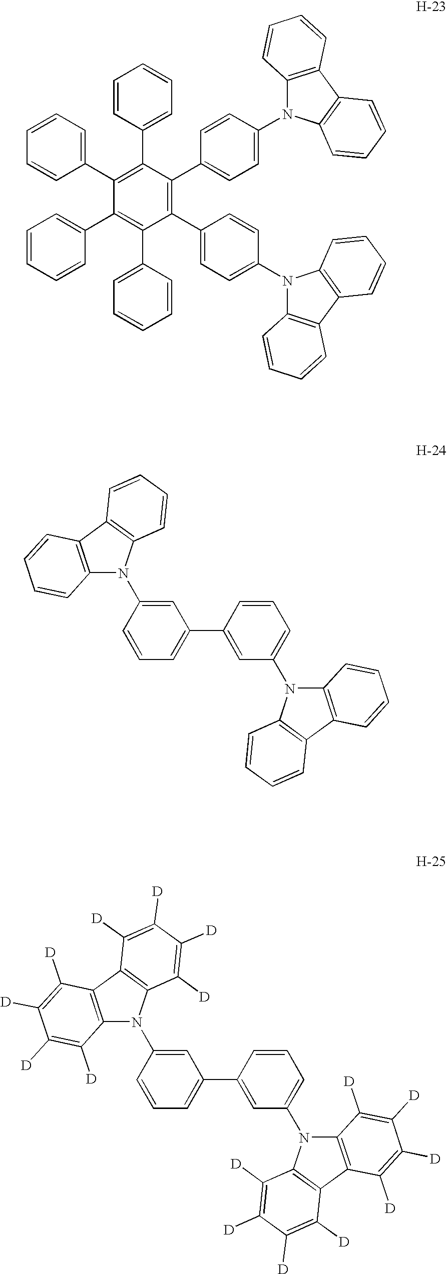

### 3. Constitution of Organic EL Element

In the following, the constitution of the organic EL element of the present invention will be described in detail.

The organic EL element in the present invention has an anode and a cathode on a substrate, and at least a light-emitting layer between the two electrodes, wherein organic compound layers are preferably disposed on both sides of the light-emitting layer and in contact with the light-emitting layer. Moreover, another organic compound layer may be disposed between the electrode and the organic compound layer in contact with the light-emitting layer.

Due to the nature of a light-emitting element, it is preferred that at least one electrode of an anode or a cathode is transparent. Generally, an anode is transparent.

As a lamination pattern of the organic compound layers of the organic EL element in the present invention, the organic compound layers are preferably laminated in the order of a hole transport layer, a light-emitting layer, and an electron transport layer from the anode side. Moreover, a charge blocking layer and the like may be disposed between the hole transport layer and the light-emitting layer, or between the light-emitting layer and the electron transport layer.

A preferable embodiment of the organic compound layer in the organic electroluminescence element of the present invention is as follows: the organic compound layer includes at least a hole injection layer, a hole transport layer, a light-emitting layer, a hole blocking layer, an electron transport layer, and an electron injection layer in this order from the anode side.

In the case where a hole blocking layer is disposed between a light-emitting layer and an electron transport layer, an organic compound layer adjacent to the light-emitting layer on an anode side is a hole transport layer, and an organic compound layer adjacent to the light-emitting layer on a cathode side is a hole blocking layer. Furthermore, a hole injection layer may be disposed between an anode and a hole transport layer, and an electron injection layer may be disposed between a cathode and an electron transport layer. Each of the layers mentioned above may be composed of a plurality of secondary layers.

### <Substrate>

The substrate to be applied in the invention is preferably one which does not scatter or attenuate light emitted from the light-emitting layer. Specific examples of materials for the substrate include inorganic materials such as zirconia-stabilized yttrium (YSZ) and glass; polyesters such as polyethylene terephthalate, polybutylene phthalate, and polyethylene naphthalate; and organic materials such as polystyrene, polycarbonate, polyethersulfone, polyarylate, polyimide, polycycloolefin, norbornene resin, polychlorotrifluoroethylene, and the like.

For instance, when glass is used as the substrate, non-alkali glass is preferably used with respect to the quality of material in order to decrease ions eluted from the glass. In the case of employing soda-lime glass, it is preferred to use glass on which a barrier coat of silica or the like has been applied. In the case of employing an organic material, it is preferred to use a material excellent in heat resistance, dimension stability, solvent resistance, electric insulation performance, and workability.

There is no particular limitation as to the shape, the structure, the size or the like of the substrate, but it may be suitably selected according to the application, purpose and the like of the light-emitting element. In general, a plate-like substrate is preferred as the shape of the substrate. A structure of the substrate may be a monolayer structure or a laminated structure. Furthermore, the substrate may be formed from a single member or two or more members.

Although the substrate may be transparent and colorless, or transparent and colored, it is preferred that the substrate is transparent and colorless from the viewpoint that the substrate does not scatter or attenuate light emitted from the organic light-emitting layer.

A moisture permeation preventive layer (gas barrier layer) may be provided on the front surface or the back surface of the substrate.

For a material of the moisture permeation preventive layer (gas barrier layer), inorganic substances such as silicon nitride and silicon oxide may be preferably applied. The moisture permeation preventive layer (gas barrier layer) may be formed in accordance with, for example, a high-frequency sputtering method or the like.

In the case of applying a thermoplastic substrate, a hard-coat layer or an under-coat layer may be further provided as needed.

### <Anode>

The anode may generally be any material as long as it has a function as an electrode for supplying holes to the organic compound layer, and there is no particular limitation as to the shape, the structure, the size or the like. However, it may be suitably selected from among well-known electrode materials according to the application and purpose of the light-emitting element. As mentioned above, the anode is usually provided as a transparent anode.

Materials for the anode preferably include, for example, metals, alloys, metal oxides, electric conductive compounds, and mixtures thereof. Specific examples of the anode materials include electric conductive metal oxides such as tin oxides doped with antimony, fluorine or the like (ATO and FTO), tin oxide, zinc oxide, indium oxide, indium tin oxide (ITO), and indium zinc oxide (IZO); metals such as gold, silver, chromium, and nickel; mixtures or laminates of these metals and the electric conductive metal oxides; inorganic electric conductive materials such as copper iodide and copper sulfide; organic electric conductive materials such as polyaniline, polythiophene, and polypyrrole; and laminates of these inorganic or organic electric conductive materials with ITO. Among these, the electric conductive metal oxides are preferred, and particularly, ITO is preferable in view of productivity, high electric conductivity, transparency and the like.

The anode may be formed on the substrate in accordance with a method which is appropriately selected from among wet methods such as printing methods, coating methods and the like; physical methods such as vacuum deposition methods, sputtering methods, ion plating methods and the like; and chemical methods such as chemical vapor deposition (CVD) and plasma CVD methods and the like, in consideration of the suitability to a material constituting the anode. For instance, when ITO is selected as a material for the anode, the anode may be formed in accordance with a direct current (DC) or high-frequency sputtering method, a vacuum deposition method, an ion plating method or the like.

In the organic electroluminescence element of the present invention, a position at which the anode is to be formed is not particularly limited, but it may be suitably selected according to the application and purpose of the light-emitting element. Preferably, the anode is formed on the substrate described above. In the case, the anode may be formed on either the whole surface or a part of the surface on either side of the substrate.

For patterning to form the anode, a chemical etching method such as photolithography, a physical etching method such as etching by laser, a method of vacuum deposition or sputtering through superposing masks, or a lift-off method or a printing method may be applied.

A thickness of the anode may be suitably selected according to the material constituting the anode and is therefore not definitely decided, but it is usually in a range of from 10 nm to 50 μm, and preferably from 50 nm to 20 μm.

A value of electric resistance of the anode is preferably 10³ Ω/□ or less, and more preferably 10² Ω/□ or less. In the case where the anode is transparent, it may be either transparent and colorless, or transparent and colored. For extracting luminescence from the transparent anode side, it is preferred that a light transmittance of the anode is 60% or higher, and more preferably 70% or higher.

Concerning transparent anodes, there is a detailed description in “TOUMEI DENNKYOKU-MAKU NO SHINTENKAI (Novel Developments in Transparent Electrode Films)” edited by Yutaka Sawada, published by C.M.C. in 1999, the contents of which are incorporated by reference herein. In the case where a plastic substrate having a low heat resistance is applied, it is preferred that ITO or IZO is used to obtain a transparent anode prepared by forming a film thereof at a low temperature of 150° C. or lower.

### <Cathode>

The cathode may generally be any material as long as it has a function as an electrode for injecting electrons to the organic compound layer, and there is no particular limitation as to the shape, the structure, the size or the like. However it may be suitably selected from among well-known electrode materials according to the application and purpose of the light-emitting element.

Materials constituting the cathode include, for example, metals, alloys, metal oxides, electric conductive compounds, and mixtures thereof. Specific examples thereof include alkali metals (e.g., Li, Na, K, Cs and the like), alkaline earth metals (e.g., Mg, Ca and the like), gold, silver, lead, aluminum, sodium-potassium alloys, lithium-aluminum alloys, magnesium-silver alloys, rare earth metals such as indium and ytterbium, and the like. They may be used alone, but it is preferred that two or more of them are used in combination from the viewpoint of satisfying both stability and electron injectability.

Among these, as the materials for constituting the cathode, alkaline metals or alkaline earth metals are preferred in view of electron injectability, and materials containing aluminum as a major component are preferred in view of excellent preservation stability.

The term “material containing aluminum as a major component” refers to a material constituted by aluminum alone; alloys comprising aluminum and 0.01% by weight to 10% by weight of an alkaline metal or an alkaline earth metal; or the mixtures thereof (e.g., lithium-aluminum alloys, magnesium-aluminum alloys and the like).

Regarding materials for the cathode, they are described in detail in JP-A Nos. 2-15595 and 5-121172, the contents of which are incorporated by reference herein.

A method for forming the cathode is not particularly limited, but it may be formed in accordance with a well-known method. For instance, the cathode may be formed in accordance with a method which is appropriately selected from among wet methods such as printing methods, coating methods and the like; physical methods such as vacuum deposition methods, sputtering methods, ion plating methods and the like; and chemical methods such as CVD and plasma CVD methods and the like, in consideration of the suitability to a material constituting the cathode. For example, when a metal (or metals) is (are) selected as a material (or materials) for the cathode, one or two or more of them may be applied at the same time or sequentially in accordance with a sputtering method or the like.

For patterning to form the cathode, a chemical etching method such as photolithography, a physical etching method such as etching by laser, a method of vacuum deposition or sputtering through superposing masks, or a lift-off method or a printing method may be applied.

In the present invention, a position at which the cathode is to be formed is not particularly limited, and it may be formed on either the whole or a part of the organic compound layer.

Furthermore, a dielectric material layer made of fluorides, oxides or the like of an alkaline metal or an alkaline earth metal may be inserted between the cathode and the organic compound layer with a thickness of from 0.1 nm to 5 nm. The dielectric layer may be considered to be a kind of electron injection layer. The dielectric material layer may be formed in accordance with, for example, a vacuum deposition method, a sputtering method, an ion plating method or the like.

A thickness of the cathode may be suitably selected according to materials for constituting the cathode and is therefore not definitely decided, but it is usually in a range of from 10 nm to 5 μm, and preferably from 50 nm to 1 μm.

Moreover, the cathode may be transparent or opaque. The transparent cathode may be formed by preparing a material for the cathode with a small thickness of from 1 nm to 10 nm, and further laminating a transparent electric conductive material such as ITO or IZO thereon.

### <Organic Compound Layer>

The organic compound layer according to the present invention is to be described.

The organic electroluminescence element of the present invention has at least one organic compound layer including a light-emitting layer. An organic compound layer apart from the light-emitting layer comprises a hole transport layer, an electron transport layer, a charge blocking layer, a hole injection layer, an electron injection layer and the like.

As described above, in the present invention, the organic EL element has, adjacent to the light-emitting layer, a charge transport layer containing the compound represented by formula (1). In the case where a charge transport layer disposed on the anode side contains the compound represented by formula (1), the charge transport layer is a hole transport layer or a layer disposed between a hole transport layer and a light-emitting layer. In the case where a charge transport layer disposed on the cathode side contains the compound represented by formula (1), the charge transport layer is an electron transport layer or a layer disposed between an electron transport layer and a light-emitting layer.

### —Formation of Organic Compound Layer—

In the organic electroluminescence element of the present invention, each of the layers constituting the organic compound layer can be suitably formed in accordance with any of a dry film-forming method such as a vapor deposition method or a sputtering method; a wet film-forming method; a transfer method; a printing method; an ink-jet method; or the like.

### —Hole Injection Layer and Hole Transport Layer—

The hole injection layer and the hole transport layer are layers functioning to receive holes from an anode or from an anode side and to transport the holes to a cathode side. Materials to be introduced into the hole injection layer or hole transport layer are not particularly limited, but either of a low molecular compound or a high molecular compound may be used.

As a material for the hole injection layer and hole transport layer, it is preferred to contain specifically pyrrole derivatives, carbazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthracene derivatives, fluorenone derivatives, hydrazone derivatives, stilbene derivatives, silazane derivatives, aromatic tertiary amine compounds, styrylamine compounds, aromatic dimethylidine compounds, phthalocyanine compounds, porphyrin compounds, thiophene derivatives, organosilane derivatives, carbon, metal complexes having a ligand of phenylazole compound or phenylazine, or the like.

An electron-accepting dopant may be introduced into a hole injection layer or a hole transport layer in the organic electroluminescence element of the present invention. As the electron-accepting dopant to be introduced into a hole injection layer or a hole transport layer, either of an inorganic compound or an organic compound may be used as long as the compound has electron accepting property and a function for oxidizing an organic compound.

Specifically, the inorganic compound includes metal halides, such as ferric chloride, aluminum chloride, gallium chloride, indium chloride and antimony pentachloride and the like, and metal oxides, such as vanadium pentaoxide, molybdenum trioxide and the like.

In the case of applying organic compounds, compounds having a substituent such as a nitro group, a halogen atom, a cyano group, a trifluoromethyl group or the like; quinone compounds; acid anhydride compounds; fullerenes; or the like may be preferably applied.

Specific examples thereof other than those above include compounds described in patent documents such as JP-A Nos. 6-212153, 11-111463, 11-251067, 2000-196140, 2000-286054, 2000-315580, 2001-102175, 2001-160493, 2002-252085, 2002-56985, 2003-157981, 2003-217862, 2003-229278, 2004-342614, 2005-72012, 2005-166637, 2005-209643 and the like.

These electron-accepting dopants may be used alone or in a combination of two or more of them. Although an applied amount of these electron-accepting dopants depends on the type of material, 0.01% by weight to 50% by weight is preferred with respect to a hole injection layer material or a hole transport layer material, 0.05% by weight to 20% by weight is more preferable, and 0.1% by weight to 10% by weight is particularly preferred.

A thickness of the hole injection layer and a thickness of the hole transport layer are each preferably 500 nm or less, in view of decrease in driving voltage.

The thickness of the hole transport layer is preferably from 1 nm to 500 nm, more preferably from 5 nm to 300 nm, and even more preferably from 10 nm to 200 nm. The thickness of the hole injection layer is preferably from 0.1 nm to 500 nm, more preferably from 0.5 nm to 300 nm, and even more preferably from 1 nm to 200 nm.

The hole injection layer and the hole transport layer may be composed of a monolayer structure comprising one or two or more of the above-mentioned materials, or a multilayer structure composed of plural layers of a homogeneous composition or a heterogeneous composition.

### —Electron Injection Layer and Electron Transport Layer—

The electron injection layer and electron transport layer are layers having a function of receiving electrons from the cathode or cathode side and transporting the electrons to the anode side. Materials to be introduced into the electron injection layer and electron transport layer according to the invention are not particularly limited, but either of a low molecular compound or a high molecular compound may be used.

Specific examples of the materials applied for the electron injection layer and the electron transport layer include pyridine derivatives, quinoline derivatives, pyrimidine derivatives, pyrazine derivatives, phthalazine derivatives, phenanthroline derivatives, triazine derivatives, triazole derivatives, oxazole derivatives, oxadiazole derivatives, imidazole derivatives, fluorenone derivatives, anthraquinodimethane derivatives, anthrone derivatives, diphenylquinone derivatives, thiopyrandioxide derivatives, carbodiimide derivatives, fluorenylidenemethane derivatives, distyrylpyradine derivatives, aromatic ring tetracarboxylic anhydrides of naththalene, perylene or the like, phthalocyanine derivatives, and metal complexes represented by metal complexes of 8-quinolinol derivative, metal phthalocyanine, metal complexes containing benzoxazole or benzothiazole as the ligand, or organosilane derivatives represented by silol.

The electron injection layer or electron transport layer in the organic EL element in the present invention may include an electron-donating dopant. As a material applied for the electron-donating dopant which is added into the electron injection layer or the electron transport layer, any material may be used as long as it has an electron-donating property and a property for reducing an organic compound, and alkaline metals such as Li, alkaline earth metals such as Mg, transition metals including rare-earth metals, or reducing organic compounds are preferably used. Particularly, metals having a work function of 4.2 V or less are preferably applied, and specific examples thereof include Li, Na, K, Be, Mg, Ca, Sr, Ba, Y, Cs, La, Sm, Gd, and Yb. Specific examples of the reducing organic compound include nitrogen-containing compounds, sulfur-containing compounds, phosphorus-containing compounds, and the like.

In addition, materials described in JP-A Nos. 6-212153, 2000-196140, 2003-68468, 2003-229278 and 2004-342614 may be used.

These electron-donating dopants may be used alone or in a combination of two or more of them. An applied amount of the electron-donating dopants differs dependent on the types of the materials, but it is preferably from 0.1% by weight to 30% by weight with respect to an electron transport layer material, more preferably from 0.1% by weight to 20% by weight, and particularly preferably from 0.1% by weight to 10% by weight.

A thickness of the electron injection layer and a thickness of the electron transport layer are each preferably 500 nm or less in view of decrease in driving voltage.

The thickness of the electron transport layer is preferably from 1 nm to 500 nm, more preferably from 5 nm to 200 nm, and even more preferably from 10 nm to 100 nm. The thickness of the electron injection layer is preferably from 0.1 nm to 200 nm, more preferably from 0.2 nm to 100 nm, and even more preferably from 0.5 nm to 50 nm.

The electron injection layer and the electron transport layer may be composed of a monolayer structure comprising one or two or more of the above-mentioned materials, or a multilayer structure composed of plural layers of a homogeneous composition or a heterogeneous composition.

### 13 Hole-Blocking Layer—

A hole-blocking layer is a layer having a function to prevent the holes transported from the anode side to the light-emitting layer from passing through to the cathode side. According to the present invention, a hole-blocking layer may be provided as an organic compound layer adjacent to the light-emitting layer on the cathode side.

Examples of the compound constituting the hole-blocking layer include an aluminum complex such as aluminum (III) bis(2-methyl-8-quinolinato)-4-phenylphenolate (BAlq), a triazole derivative, a phenanthroline derivative such as 2,9-dimethyl-4,7-diphenyl-1,10-phenanthroline (BCP), or the like.

A thickness of the hole-blocking layer is preferably from 1 nm to 500 nm, more preferably from 5 nm to 200 nm, and even more preferably from 10 nm to 100 nm.

The hole-blocking layer may have either a monolayer structure comprising one or two or more of the above-mentioned materials, or a multilayer structure composed of plural layers of a homogeneous composition or a heterogeneous composition.

### —Electron-Blocking Layer—

An electron-blocking layer is a layer having a function to prevent the electron transported from the cathode side to the light-emitting layer from passing through to the anode side. According to the present invention, an electron-blocking layer may be provided as an organic compound layer adjacent to the light-emitting layer on the anode side.

Examples of the compound constituting the electron-blocking layer include compounds explained above as a hole transporting material.

A thickness of the electron-blocking layer is preferably from 1 nm to 500 nm, more preferably from 5 nm to 200 nm, and even more preferably from 10 nm to 100 nm.

The electron-blocking layer may have either a monolayer structure comprising one or two or more of the above-mentioned materials, or a multilayer structure composed of plural layers of a homogeneous composition or a heterogeneous composition.

<Protective layer>

According to the present invention, the whole organic EL element may be protected by a protective layer.

It is sufficient that a material contained in the protective layer is one having a function to prevent penetration of substances such as moisture and oxygen, which accelerate deterioration of the element, into the element.

Specific examples thereof include metals such as In, Sn, Pb, Au, Cu, Ag, Al, Ti, Ni and the like; metal oxides such as MgO, SiO, SiO₂, Al₂O₃, GeO, NiO, CaO, BaO, Fe₂O₃, Y₂O₃, TiO₂ and the like; metal nitrides such as SiNₓ, SiNₓO_{y} and the like; metal fluorides such as MgF₂, LiF, AlF₃, CaF₂ and the like; polyethylene; polypropylene; polymethyl methacrylate; polyimide; polyurea; polytetrafluoroethylene; polychlorotrifluoroethylene; polydichlorodifluoroethylene; a copolymer of chlorotrifluoroethylene and dichlorodifluoroethylene; copolymers obtained by copolymerizing a monomer mixture containing tetrafluoroethylene and at least one co-monomer; fluorine-containing copolymers each having a cyclic structure in the copolymerization main chain; water-absorbing materials each having a coefficient of water absorption of 1% or more; moisture permeation preventive substances each having a coefficient of water absorption of 0.1% or less; and the like.

There is no particular limitation as to a method for forming the protective layer. For instance, a vacuum deposition method, a sputtering method, a reactive sputtering method, an MBE (molecular beam epitaxial) method, a cluster ion beam method, an ion plating method, a plasma polymerization method (high-frequency excitation ion plating method), a plasma CVD method, a laser CVD method, a thermal CVD method, a gas source CVD method, a coating method, a printing method, or a transfer method may be applied.

### <Sealing>

The whole organic electroluminescence element of the present invention may be sealed with a sealing cap.

Furthermore, a moisture absorbent or an inert liquid may be used to seal a space defined between the sealing cap and the light-emitting element. Although the moisture absorbent is not particularly limited, specific examples thereof include barium oxide, sodium oxide, potassium oxide, calcium oxide, sodium sulfate, calcium sulfate, magnesium sulfate, phosphorus pentaoxide, calcium chloride, magnesium chloride, copper chloride, cesium fluoride, niobium fluoride, calcium bromide, vanadium bromide, molecular sieve, zeolite, magnesium oxide and the like. Although the inert liquid is not particularly limited, specific examples thereof include paraffins; liquid paraffins; fluorocarbon solvents such as perfluoroalkanes, perfluoroamines, perfluoroethers and the like; chlorine-based solvents; silicone oils; and the like.

### <Driving>

In the organic electroluminescence element of the present invention, when DC (AC components may be contained as needed) voltage (usually 2 volts to 15 volts) or DC is applied across the anode and the cathode, luminescence can be obtained.

For the driving method of the organic electroluminescence element of the present invention, driving methods described in JP-A Nos. 2-148687, 6-301355, 5-29080, 7-134558, 8-234685, and 8-241047; Japanese Patent No. 2784615, U.S. Pat. Nos. 5,828,429 and 6,023,308 are applicable.

In the light-emitting element of the present invention, the light-extraction efficiency can be improved by various known methods. It is possible to elevate the light-extraction efficiency and to improve the external quantum efficiency, for example, by modifying the surface shape of the substrate (for example by forming fine irregularity pattern), by controlling the refractive index of the substrate, the ITO layer and/or the organic compound layer, or by controlling the thickness of the substrate, the ITO layer and/or the organic compound layer.

The organic electroluminescence element of the present invention may have a so-called top-emission configuration in which the emitted light is extracted from the anode side.

### (Application of the Present Invention)

The organic electroluminescence element of the present invention can be appropriately used for indicating elements, displays, backlights, electronic photographs, illumination light sources, recording light sources, exposure light sources, reading light sources, signages, advertising displays, interior accessories, optical communications and the like.

All publications, patent applications, and technical standards mentioned in this specification are herein incorporated by reference to the same extent as if each individual publication, patent application, or technical standard was specifically and individually indicated to be incorporated by reference.

### EXAMPLES

In the following, the present invention will be explained by examples thereof, but the present invention is by no means limited by such examples.

### Example 1

### 1. Preparation of Organic EL Element

(Preparation of Comparative Organic EL Element A)

1) Formation of Anode

As a transparent substrate, the one in which indium tin oxide (which is referred to hereinafter as ITO) was deposited on a glass substrate having a size of 25 mm×25 mm×0.7 mm to form a film having a thickness of 100 nm (manufactured by Tokyo Sanyo Vacuum Co., Ltd.) was used. The transparent substrate was subjected to etching and cleaning.

2) Hole Injection Layer and Hole Transport Layer

Hole injection layer: 4,4′,4″-tris(2-naphthylphenylamino)triphenylamine (which is referred to as 2-TNATA) and 2,3,5,6-tetrafluoro-7,7,8,8-tetracyanoquinodimethane (which is referred to as F4-TCNQ) were co-deposited so that the amount of F4-TCNQ would be 1.0% by weight with respect to the amount of 2-TNATA. The thickness was 160 nm.

Hole transport layer: N,N′-dinaphthyl-N,N′-diphenyl-[1,1′-biphenyl]-4,4′-diamine (which is referred to as α-NPD) was deposited at a thickness of 10 nm.

3) Light-Emitting Layer

Light-emitting layer (a): N,N′-dicarbazolyl-1,3-benzene (which is referred to as mCP, corresponding to “H-4” exemplified as a specific example of the hole transporting material), which is a hole transporting host material, and electron transporting light emitting material Pt-1 were co-deposited. The deposition rate of each component was controlled so that the mixing ratio would be mCP:Pt-1=85% by weight:15% by weight. The thickness of the light-emitting layer was 60 nm.

4) Electron Transport Layer and Electron Injection Layer

Subsequently, on the light-emitting layer, the following electron transport layer and electron injection layer were provided.

Electron transport layer: aluminum (III) bis(2-methyl-8-quinolinato)-4-phenylphenolate (which is referred to as BAlq) was deposited at a thickness of 39 nm.

Electron injection layer: bathocuproine (which is referred to as BCP) was deposited at a thickness of 1 nm.

5) Formation of Cathode

Further, after depositing lithium fluoride (LiF) at a thickness of 1 nm, patterning was performed using a shadow mask, and aluminum metal (Al) with a thickness of 100 nm was provided as a cathode. Each layer was provided by resistance heating vacuum deposition.

The lamination body thus produced was placed in a glove box substituted with nitrogen gas, and was sealed using a stainless-steel sealing cap and an ultraviolet light-curable adhesive (XNR5516HV, manufactured by Nagase-Ciba Co., Ltd.).

(Preparation of Inventive Organic EL Element Nos. 1 to 14)

Preparation of inventive organic EL element Nos. 1 to 14 was conducted in a similar manner to the process in the preparation of the comparative organic EL element A, except that, in the preparation of the comparative organic EL element A, compound (AD-1) of formula (1) was added to the hole transport layer and/or the electron transport layer as shown in Table 1.

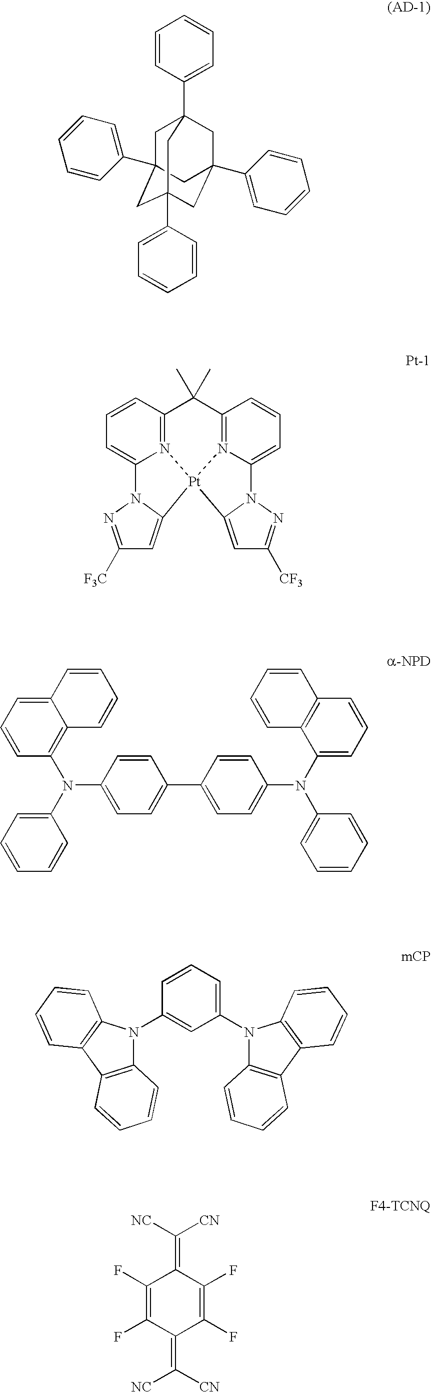

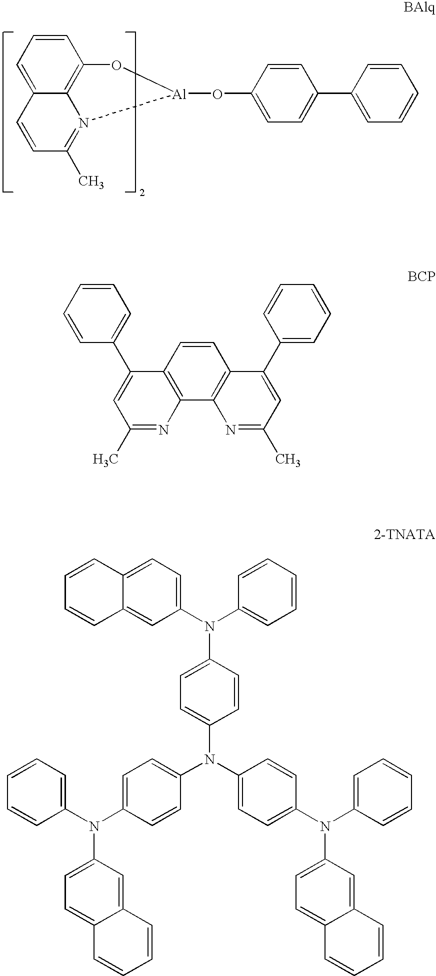

### 2. Performance Evaluation of Organic EL Element

1) External Quantum Efficiency

DC voltage was applied to each element using a source measuring unit, model 2400, manufactured by TOYO Corporation, to emit light. The brightness of the light was measured by using a brightness photometer BM-8, manufactured by Topcon Corporation. The emission spectrum and emission wavelength were measured using a spectral analyzer PMA-11 manufactured by Hamamatsu Photonics K.K. From the obtained values, the external quantum efficiency at a brightness of 1000 cd/m² was calculated by a brightness conversion method.

2) Driving Voltage

DC voltage was applied to each element using a source measuring unit, model 2400, manufactured by TOYO Corporation, to emit light. As the driving voltage, the voltage when an electric current of 10 mA/cm² was applied to the element was measured.

3) Drive Durability: Brightness Half-Value Time

DC voltage was applied to each element to emit light having a brightness of 1000 cd/m². Then, the element was subjected to continuous driving, and the time until the brightness was reduced to 500 cd/m² was measured. In terms of this brightness half-value time, drive durability is expressed.

The obtained results are shown in Table 2.

TABLE 1

| | Compound of | | | |
|---|---|---|---|---|
| | Formula (1) | | | |
| | in Hole | | | |
| | Transport Layer | | Compound of Formula (1) | |
| | | Content | in Electron Transport Layer | |
| | Compound | (% by | Compound | Content |
| Element No. | No. | weight) | No. | (% by weight) |
| Comparative | — | — | — | — |
| Element A | | | | |
| Inventive Element | (AD-1) | 5 | — | — |
| No. 1 | | | | |
| Inventive Element | (AD-1) | 5 | (AD-1) | 5 |
| No. 2 | | | | |
| Inventive Element | (AD-1) | 5 | (AD-1) | 10 |
| No. 3 | | | | |
| Inventive Element | (AD-1) | 5 | (AD-1) | 20 |
| No. 4 | | | | |
| Inventive Element | (AD-1) | 10 | — | — |
| No. 5 | | | | |
| Inventive Element | (AD-1) | 10 | (AD-1) | 5 |
| No. 6 | | | | |
| Inventive Element | (AD-1) | 10 | (AD-1) | 10 |
| No. 7 | | | | |
| Inventive Element | (AD-1) | 10 | (AD-1) | 20 |
| No. 8 | | | | |
| Inventive Element | (AD-1) | 20 | — | — |
| No. 9 | | | | |
| Inventive Element | (AD-1) | 20 | (AD-1) | 5 |
| No. 10 | | | | |
| Inventive Element | (AD-1) | 20 | (AD-1) | 10 |
| No. 11 | | | | |
| Inventive Element | — | — | (AD-1) | 5 |
| No. 12 | | | | |
| Inventive Element | — | — | (AD-1) | 10 |
| No. 13 | | | | |
| Inventive Element | — | — | (AD-1) | 20 |
| No. 14 | | | | |

TABLE 2

| | | External | |
|---|---|---|---|
| | | Quantum | Brightness |
| | Driving Voltage | Efficiency | Half-Value Time |
| Element No. | (V) | (%) | (h) |
| Comparative | 11.2 | 8.4 | 1000 |
| Element A | | | |
| Inventive Element | 7.9 | 11.1 | 1800 |
| No. 1 | | | |
| Inventive Element | 7.8 | 11.5 | 1900 |
| No. 2 | | | |
| Inventive Element | 7.6 | 11.8 | 2000 |
| No. 3 | | | |
| Inventive Element | 7.4 | 12.3 | 2100 |
| No. 4 | | | |
| Inventive Element | 7.8 | 11.4 | 1900 |
| No. 5 | | | |
| Inventive Element | 7.6 | 11.8 | 2000 |
| No. 6 | | | |
| Inventive Element | 7.5 | 12.0 | 2200 |
| No. 7 | | | |
| Inventive Element | 7.3 | 12.3 | 2300 |
| No. 8 | | | |
| Inventive Element | 7.5 | 12.0 | 2000 |
| No. 9 | | | |
| Inventive Element | 7.3 | 12.2 | 2200 |
| No. 10 | | | |
| Inventive Element | 7.2 | 12.4 | 2400 |
| No. 11 | | | |
| Inventive Element | 7.9 | 11.0 | 1800 |
| No. 12 | | | |
| Inventive Element | 7.7 | 11.3 | 1900 |
| No. 13 | | | |
| Inventive Element | 7.5 | 11.8 | 2000 |
| No. 14 | | | |

It is clear from the results shown in Table 2 that the inventive elements exhibit light-emission characteristics of unexpectedly high external quantum efficiency, low driving voltage, and high drive durability, as compared with the comparative element A. Particularly, by adding compound (AD-1) of formula (1) to both of the hole transport layer and electron transport layer, higher performance is obtained as compared with the performance obtained by adding compound (AD-1) to only one of these layers.

### Example 2

### 1. Preparation of Sample

Preparation of inventive organic EL element Nos. 15 to 28 was conducted in a similar manner to that in the process in the preparation of the organic EL elements of Example 1, except that, in the preparation of the organic EL elements of Example 1, the following compound (AD-2) of formula (1) was added to the hole transport layer and/or the electron transport layer as shown in Table 3.

TABLE 3

| | |
|---|---|
| | (AD-2) |
| 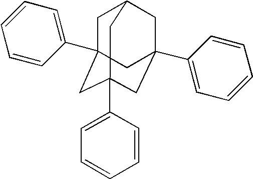 | |

| | Compound of Formula (1) | | Compound of Formula (1) | |
|---|---|---|---|---|
| | in Hole Transport Layer | | in Electron Transport Layer | |
| Element | Compound | Content | Compound | Content |
| No. | No. | (% by weight) | No. | (% by weight) |
| Inventive | (AD-2) | 5 | — | — |
| Element | | | | |
| No. 15 | | | | |
| Inventive | (AD-2) | 5 | (AD-2) | 5 |
| Element | | | | |
| No. 16 | | | | |
| Inventive | (AD-2) | 5 | (AD-2) | 10 |
| Element | | | | |
| No. 17 | | | | |
| Inventive | (AD-2) | 5 | (AD-2) | 20 |
| Element | | | | |
| No. 18 | | | | |
| Inventive | (AD-2) | 10 | — | — |
| Element | | | | |
| No. 19 | | | | |
| Inventive | (AD-2) | 10 | (AD-2) | 5 |
| Element | | | | |
| No. 20 | | | | |
| Inventive | (AD-2) | 10 | (AD-2) | 10 |
| Element | | | | |
| No. 21 | | | | |
| Inventive | (AD-2) | 10 | (AD-2) | 20 |
| Element | | | | |
| No. 22 | | | | |
| Inventive | (AD-2) | 20 | — | — |
| Element | | | | |
| No. 23 | | | | |
| Inventive | (AD-2) | 20 | (AD-2) | 5 |
| Element | | | | |
| No. 24 | | | | |
| Inventive | (AD-2) | 20 | (AD-2) | 10 |
| Element | | | | |
| No. 25 | | | | |
| Inventive | — | — | (AD-2) | 5 |
| Element | | | | |
| No. 26 | | | | |
| Inventive | — | — | (AD-2) | 10 |
| Element | | | | |
| No. 27 | | | | |
| Inventive | — | — | (AD-2) | 20 |
| Element | | | | |
| No. 28 | | | | |

### 2. Performance Evaluation

Evaluation of driving voltage, external quantum efficiency and drive durability was performed in a similar manner to that in Example 1. The obtained results are shown in Table 4.

TABLE 4

| | | External | |
|---|---|---|---|
| | Driving | Quantum | Brightness |
| | Voltage | Efficiency | Half-Value Time |
| Element No. | (V) | (%) | (h) |
| Inventive Element | 8.3 | 10.7 | 1600 |
| No. 15 | | | |
| Inventive Element | 8.0 | 10.4 | 1750 |
| No. 16 | | | |
| Inventive Element | 8.0 | 11.4 | 1800 |
| No. 17 | | | |
| Inventive Element | 7.7 | 11.8 | 2000 |
| No. 18 | | | |
| Inventive Element | 8.2 | 11.1 | 1800 |
| No. 19 | | | |
| Inventive Element | 8.2 | 11.7 | 1850 |
| No. 20 | | | |
| Inventive Element | 7.8 | 11.8 | 2050 |
| No. 21 | | | |
| Inventive Element | 7.6 | 12.0 | 2100 |
| No. 22 | | | |
| Inventive Element | 7.9 | 11.7 | 1900 |
| No. 23 | | | |
| Inventive Element | 7.7 | 11.9 | 2000 |
| No. 24 | | | |
| Inventive Element | 7.5 | 12.0 | 2200 |
| No. 25 | | | |
| Inventive Element | 8.3 | 10.8 | 1700 |
| No. 26 | | | |
| Inventive Element | 8.0 | 11.0 | 1800 |
| No. 27 | | | |
| Inventive Element | 7.9 | 11.5 | 1900 |
| No. 28 | | | |

As is clear from the results shown in Table 4, the inventive elements exhibit light-emission characteristics of unexpectedly high external quantum efficiency, low driving voltage and high drive durability, as compared with the comparative element A. Particularly, by adding compound (AD-2) of formula (1) to both of the hole transport layer and electron transport layer, higher performance is obtained as compared with the performance obtained by adding compound (AD-2) to one of these layers.

### Example 3

### 1. Preparation of Sample

Preparation of inventive organic EL element Nos. 29 to 42 was conducted in a similar manner to that in the process in the preparation of the organic EL elements of Example 1, except that, in the preparation of the organic EL elements of Example 1, the following compound (AD-3) of formula (1) was added to the hole transport layer and/or the electron transport layer as shown in Table 5.

TABLE 5

| | |
|---|---|
| | (AD-3) |
| 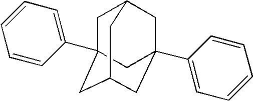 | |

| | Compound of Formula (1) | | Compound of Formula (1) | |
|---|---|---|---|---|
| | in Hole Transport Layer | | in Electron Transport Layer | |
| Element | Compound | Content | Compound | Content |
| No. | No. | (% by weight) | No. | (% by weight) |
| Inventive | (AD-3) | 5 | — | — |
| Element | | | | |
| No. 29 | | | | |
| Inventive | (AD-3) | 5 | (AD-3) | 5 |
| Element | | | | |
| No. 30 | | | | |
| Inventive | (AD-3) | 5 | (AD-3) | 10 |
| Element | | | | |
| No. 31 | | | | |
| Inventive | (AD-3) | 5 | (AD-3) | 20 |
| Element | | | | |
| No. 32 | | | | |
| Inventive | (AD-3) | 10 | — | — |
| Element | | | | |
| No. 33 | | | | |
| Inventive | (AD-3) | 10 | (AD-3) | 5 |
| Element | | | | |
| No. 34 | | | | |
| Inventive | (AD-3) | 10 | (AD-3) | 10 |
| Element | | | | |
| No. 35 | | | | |
| Inventive | (AD-3) | 10 | (AD-3) | 20 |
| Element | | | | |
| No. 36 | | | | |
| Inventive | (AD-3) | 20 | — | — |
| Element | | | | |
| No. 37 | | | | |
| Inventive | (AD-3) | 20 | (AD-3) | 5 |
| Element | | | | |
| No. 38 | | | | |
| Inventive | (AD-3) | 20 | (AD-3) | 10 |
| Element | | | | |
| No. 39 | | | | |
| Inventive | — | — | (AD-3) | 5 |
| Element | | | | |
| No. 40 | | | | |
| Inventive | — | — | (AD-3) | 10 |
| Element | | | | |
| No. 41 | | | | |
| Inventive | — | — | (AD-3) | 20 |
| Element | | | | |
| No. 42 | | | | |

### 2. Performance Evaluation

Evaluation of driving voltage, external quantum efficiency and drive durability was performed in a similar manner to that in Example 1. The obtained results are shown in Table 6.

TABLE 6

| | | External | |
|---|---|---|---|
| | | Quantum | Brightness |
| | Driving Voltage | Efficiency | Half-Value Time |
| Element No. | (V) | (%) | (h) |
| Inventive Element | 9.5 | 10.0 | 1600 |
| No. 29 | | | |
| Inventive Element | 9.0 | 9.7 | 1680 |
| No. 30 | | | |
| Inventive Element | 9.0 | 10.7 | 1700 |
| No. 31 | | | |
| Inventive Element | 8.8 | 11.0 | 1900 |
| No. 32 | | | |
| Inventive Element | 8.9 | 10.4 | 1700 |
| No. 33 | | | |
| Inventive Element | 8.9 | 11.0 | 1740 |
| No. 34 | | | |
| Inventive Element | 8.5 | 11.0 | 1970 |
| No. 35 | | | |
| Inventive Element | 8.6 | 11.3 | 2000 |
| No. 36 | | | |
| Inventive Element | 8.4 | 10.7 | 1800 |
| No. 37 | | | |
| Inventive Element | 8.4 | 11.2 | 1900 |
| No. 38 | | | |
| Inventive Element | 8.0 | 11.1 | 2070 |
| No. 39 | | | |
| Inventive Element | 8.8 | 10.1 | 1600 |
| No. 40 | | | |
| Inventive Element | 8.5 | 10.2 | 1700 |
| No. 41 | | | |
| Inventive Element | 8.4 | 10.7 | 1800 |
| No. 42 | | | |

As is clear from the results shown in Table 6, the inventive elements exhibit light-emission characteristics of unexpectedly high external quantum efficiency, low driving voltage and high drive durability, as compared with the comparative element A. Particularly, by adding compound (AD-3) of formula (1) to both of the hole transport layer and electron transport layer, higher performance is obtained as compared with the performance obtained by adding compound (AD-3) to one of these layers.

### Example 4

### 1. Preparation of Sample

Preparation of inventive organic EL element Nos. 43 to 56 was conducted in a similar manner to that in the process in the preparation of the organic EL elements of Example 1, except that, in the preparation of the organic EL elements of Example 1, the following compound (AD-4) of formula (1) was added to the hole transport layer and/or the electron transport layer as shown in Table 7.

TABLE 7

| | |
|---|---|
| | (AD-4) |
| 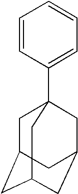 | |

| | Compound of Formula (1) | | Compound of Formula (1) | |
|---|---|---|---|---|
| | in Hole Transport Layer | | in Electron Transport Layer | |
| Element | Compound | Content | Compound | Content |
| No. | No. | (% by weight) | No. | (% by weight) |
| Inventive | (AD-4) | 5 | — | — |
| Element | | | | |
| No. 43 | | | | |
| Inventive | (AD-4) | 5 | (AD-4) | 5 |
| Element | | | | |
| No. 44 | | | | |
| Inventive | (AD-4) | 5 | (AD-4) | 10 |
| Element | | | | |
| No. 45 | | | | |
| Inventive | (AD-4) | 5 | (AD-4) | 20 |
| Element | | | | |
| No. 46 | | | | |
| Inventive | (AD-4) | 10 | — | — |
| Element | | | | |
| No. 47 | | | | |
| Inventive | (AD-4) | 10 | (AD-4) | 5 |
| Element | | | | |
| No. 48 | | | | |
| Inventive | (AD-4) | 10 | (AD-4) | 10 |
| Element | | | | |
| No. 49 | | | | |
| Inventive | (AD-4) | 10 | (AD-4) | 20 |
| Element | | | | |
| No. 50 | | | | |
| Inventive | (AD-4) | 20 | — | — |
| Element | | | | |
| No. 51 | | | | |
| Inventive | (AD-4) | 20 | (AD-4) | 5 |
| Element | | | | |
| No. 52 | | | | |
| Inventive | (AD-4) | 20 | (AD-4) | 10 |
| Element | | | | |
| No. 53 | | | | |
| Inventive | — | — | (AD-4) | 5 |
| Element | | | | |
| No. 54 | | | | |
| Inventive | — | — | (AD-4) | 10 |
| Element | | | | |
| No. 55 | | | | |
| Inventive | — | — | (AD-4) | 20 |
| Element | | | | |
| No. 56 | | | | |

### 2. Performance Evaluation

Evaluation of driving voltage, external quantum efficiency and drive durability was performed in a similar manner to that in Example 1. The obtained results are shown in Table 8.

TABLE 8

| | | External | |
|---|---|---|---|
| | | Quantum | Brightness |
| | Driving Voltage | Efficiency | Half-Value Time |
| Element No. | (V) | (%) | (h) |
| Inventive Element | 10.0 | 9.8 | 1700 |
| No. 43 | | | |
| Inventive Element | 9.6 | 9.4 | 1800 |
| No. 44 | | | |
| Inventive Element | 9.5 | 10.3 | 1600 |
| No. 45 | | | |
| Inventive Element | 9.3 | 10.5 | 1800 |
| No. 46 | | | |
| Inventive Element | 9.4 | 9.9 | 1600 |
| No. 47 | | | |
| Inventive Element | 9.4 | 10.5 | 1650 |
| No. 48 | | | |
| Inventive Element | 9.0 | 10.6 | 1900 |
| No. 49 | | | |
| Inventive Element | 9.3 | 10.8 | 1920 |
| No. 50 | | | |
| Inventive Element | 9.0 | 10.1 | 1700 |
| No. 51 | | | |
| Inventive Element | 8.9 | 10.7 | 1800 |
| No. 52 | | | |
| Inventive Element | 8.5 | 10.6 | 2000 |
| No. 53 | | | |
| Inventive Element | 9.4 | 9.6 | 1700 |
| No. 54 | | | |
| Inventive Element | 9.0 | 9.8 | 1600 |
| No. 55 | | | |
| Inventive Element | 9.4 | 10.0 | 1700 |
| No. 56 | | | |

As is clear from the results shown in Table 8, the inventive elements exhibit light-emission characteristics of unexpectedly high external quantum efficiency, low driving voltage and high drive durability, as compared with the comparative element A. Particularly, by adding compound (AD-4) of formula (1) to both of the hole transport layer and electron transport layer, higher performance is obtained as compared with the performance obtained by adding compound (AD-4) to one of these layers.

It is clear from the results of Examples 1 to 4 described above that by adding the compound of formula (1) to both of the hole transport layer and electron transport layer, light-emission characteristics of unexpectedly high external quantum efficiency, low driving voltage and high drive durability are obtained.

### Example 5

### 1. Preparation of Sample

Preparation of a comparative organic EL element and inventive organic EL elements was conducted in a similar manner to that in the process in the preparation of the organic EL elements of Example 1, except that, in the preparation of the organic EL elements of Example 1, the light-emitting layer was changed to the following layer, and compound (AD-1) of formula (1) was added to the hole transport layer and/or the electron transport layer as shown in Table 9.

Light-emitting layer (b): N,N′-dicarbazolyl-1,3-benzene (which is referred to as mCP), which is a hole transporting host material, and electron transporting light emitting material Pt-2 were co-deposited. The deposition rate of each component was controlled so that the mixing ratio would be mCP:Pt-2=85% by weight:15% by weight. The thickness of the light-emitting layer was 60 nm.

TABLE 9

| | |
|---|---|
| | Pt-2 |
| 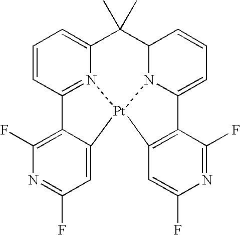 | |

| | Compound of Formula (1) | | Compound of Formula (1) | |
|---|---|---|---|---|
| | in Hole Transport Layer | | in Electron Transport Layer | |
| Element | Compound | Content | Compound | Content |
| No. | No. | (% by weight) | No. | (% by weight) |
| Com- | — | — | — | — |
| parative | | | | |
| Element B | | | | |
| Inventive | (AD-1) | 5 | — | — |
| Element | | | | |
| No. 101 | | | | |
| Inventive | (AD-1) | 5 | (AD-1) | 5 |
| Element | | | | |
| No. 102 | | | | |
| Inventive | (AD-1) | 5 | (AD-1) | 10 |
| Element | | | | |
| No. 103 | | | | |
| Inventive | (AD-1) | 5 | (AD-1) | 20 |
| Element | | | | |
| No. 104 | | | | |
| Inventive | (AD-1) | 10 | — | — |
| Element | | | | |
| No. 105 | | | | |
| Inventive | (AD-1) | 10 | (AD-1) | 5 |
| Element | | | | |
| No. 106 | | | | |
| Inventive | (AD-1) | 10 | (AD-1) | 10 |
| Element | | | | |
| No. 107 | | | | |
| Inventive | (AD-1) | 10 | (AD-1) | 20 |
| Element | | | | |
| No. 108 | | | | |
| Inventive | (AD-1) | 20 | — | — |
| Element | | | | |
| No. 109 | | | | |
| Inventive | (AD-1) | 20 | (AD-1) | 5 |
| Element | | | | |
| No. 110 | | | | |
| Inventive | (AD-1) | 20 | (AD-1) | 10 |
| Element | | | | |
| No. 111 | | | | |
| Inventive | — | — | (AD-1) | 5 |
| Element | | | | |
| No. 112 | | | | |
| Inventive | — | — | (AD-1) | 10 |
| Element | | | | |
| No. 113 | | | | |
| Inventive | — | — | (AD-1) | 20 |
| Element | | | | |
| No. 114 | | | | |

### 2. Performance Evaluation

Evaluation of driving voltage, external quantum efficiency and drive durability was performed in a similar manner to that in Example 1. The obtained results are shown in Table 10.

TABLE 10

| | | External | |
|---|---|---|---|
| | | Quantum | Brightness |
| | Driving Voltage | Efficiency | Half-Value Time |
| Element No. | (V) | (%) | (h) |
| Comparative | 10.5 | 9.0 | 1300 |
| Element B | | | |
| Inventive Element | 7.5 | 12.1 | 1850 |
| No. 101 | | | |
| Inventive Element | 7.4 | 12.6 | 1990 |
| No. 102 | | | |
| Inventive Element | 7.3 | 12.9 | 2110 |
| No. 103 | | | |
| Inventive Element | 7.0 | 13.2 | 2200 |
| No. 104 | | | |
| Inventive Element | 7.4 | 12.4 | 2100 |
| No. 105 | | | |
| Inventive Element | 7.5 | 12.8 | 2100 |
| No. 106 | | | |
| Inventive Element | 7.1 | 12.9 | 2290 |
| No. 107 | | | |
| Inventive Element | 7.0 | 12.7 | 2400 |
| No. 108 | | | |
| Inventive Element | 7.2 | 13.0 | 2100 |
| No. 109 | | | |
| Inventive Element | 6.9 | 13.2 | 2300 |
| No. 110 | | | |
| Inventive Element | 6.8 | 13.3 | 2500 |
| No. 111 | | | |
| Inventive Element | 7.5 | 11.6 | 1910 |
| No. 112 | | | |
| Inventive Element | 7.3 | 11.9 | 2000 |
| No. 113 | | | |
| Inventive Element | 7.0 | 12.6 | 2100 |
| No. 114 | | | |

As is clear from the results shown above, the inventive elements exhibit light-emission characteristics of unexpectedly high external quantum efficiency, low driving voltage and high drive durability, as compared with the comparative element B. Particularly, by adding compound (AD-1) of formula (1) to both of the hole transport layer and electron transport layer, higher performance is obtained as compared with the performance obtained by adding compound (AD-1) to one of these layers.

### Example 6

### 1. Preparation of Sample

Preparation of inventive organic EL elements was conducted in a similar manner to that in the process in the preparation of the organic EL elements of Example 5, except that, in the preparation of the organic EL elements of Example 5, compound (AD-2) of formula (1) was added to the hole transport layer and/or the electron transport layer as shown in Table 11.

TABLE 11

| | Compound of | | Compound of | |
|---|---|---|---|---|
| | Formula (1) in | | Formula (1) in Electron | |
| | Hole Transport Layer | | Transport Layer | |
| | | Content | | Content |
| | | (% | Compound | (% |
| Element No. | Compound No. | by weight) | No. | by weight) |
| Inventive Element | (AD-2) | 5 | — | — |
| No. 115 | | | | |
| Inventive Element | (AD-2) | 5 | (AD-2) | 5 |
| No. 116 | | | | |
| Inventive Element | (AD-2) | 5 | (AD-2) | 10 |
| No. 117 | | | | |
| Inventive Element | (AD-2) | 5 | (AD-2) | 20 |
| No. 118 | | | | |
| Inventive Element | (AD-2) | 10 | — | — |
| No. 119 | | | | |
| Inventive Element | (AD-2) | 10 | (AD-2) | 5 |
| No. 120 | | | | |
| Inventive Element | (AD-2) | 10 | (AD-2) | 10 |
| No. 121 | | | | |
| Inventive Element | (AD-2) | 10 | (AD-2) | 20 |
| No. 122 | | | | |
| Inventive Element | (AD-2) | 20 | — | — |
| No. 123 | | | | |
| Inventive Element | (AD-2) | 20 | (AD-2) | 5 |
| No. 124 | | | | |
| Inventive Element | (AD-2) | 20 | (AD-2) | 10 |
| No. 125 | | | | |
| Inventive Element | — | — | (AD-2) | 5 |
| No. 126 | | | | |
| Inventive Element | — | — | (AD-2) | 10 |
| No. 127 | | | | |
| Inventive Element | — | — | (AD-2) | 20 |
| No. 128 | | | | |

### 2. Performance Evaluation

Evaluation of driving voltage, external quantum efficiency and drive durability was performed in a similar manner to that in Example 1. The obtained results are shown in Table 12.

TABLE 12

| | | External | |
|---|---|---|---|
| | | Quantum | Brightness |
| | Driving Voltage | Efficiency | Half-Value Time |
| Element No. | (V) | (%) | (h) |
| Inventive Element | 8.2 | 11.0 | 1700 |
| No. 115 | | | |
| Inventive Element | 7.8 | 10.8 | 1850 |
| No. 116 | | | |
| Inventive Element | 7.6 | 11.7 | 1900 |
| No. 117 | | | |
| Inventive Element | 7.4 | 12.2 | 2100 |
| No. 118 | | | |
| Inventive Element | 7.8 | 11.6 | 1900 |
| No. 119 | | | |
| Inventive Element | 7.7 | 12.1 | 1930 |
| No. 120 | | | |
| Inventive Element | 7.3 | 12.4 | 2100 |
| No. 121 | | | |
| Inventive Element | 7.3 | 12.6 | 2170 |
| No. 122 | | | |
| Inventive Element | 7.6 | 12.1 | 2000 |
| No. 123 | | | |
| Inventive Element | 7.3 | 12.4 | 2100 |
| No. 124 | | | |
| Inventive Element | 7.1 | 12.6 | 2300 |
| No. 125 | | | |
| Inventive Element | 7.9 | 11.3 | 1800 |
| No. 126 | | | |
| Inventive Element | 7.7 | 11.4 | 1900 |
| No. 127 | | | |
| Inventive Element | 7.5 | 11.9 | 2000 |
| No. 128 | | | |

As is clear from the results shown above, the inventive elements exhibit light-emission characteristics of unexpectedly high external quantum efficiency, low driving voltage and high drive durability, as compared with the comparative element B. Particularly, by adding compound (AD-2) of formula (1) to both of the hole transport layer and electron transport layer, higher performance is obtained as compared with the performance obtained by adding compound (AD-2) to one of these layers.

### Example 7

### 1. Preparation of Sample

Preparation of inventive organic EL elements was conducted in a similar manner to that in the process in the preparation of the organic EL elements of Example 5, except that, in the preparation of the organic EL elements of Example 5, compound (AD-3) of formula (1) was added to the hole transport layer and/or the electron transport layer as shown in Table 13.

TABLE 13

| | Compound of | | Compound of | |
|---|---|---|---|---|
| | Formula (1) in | | Formula (1) in Electron | |
| | Hole Transport Layer | | Transport Layer | |
| | | Content | | Content |
| | | (% | Compound | (% |
| Element No. | Compound No. | by weight) | No. | by weight) |
| Inventive Element | (AD-3) | 5 | — | — |
| No. 129 | | | | |
| Inventive Element | (AD-3) | 5 | (AD-3) | 5 |
| No. 130 | | | | |
| Inventive Element | (AD-3) | 5 | (AD-3) | 10 |
| No. 131 | | | | |
| Inventive Element | (AD-3) | 5 | (AD-3) | 20 |
| No. 132 | | | | |
| Inventive Element | (AD-3) | 10 | — | — |
| No. 133 | | | | |
| Inventive Element | (AD-3) | 10 | (AD-3) | 5 |
| No. 134 | | | | |
| Inventive Element | (AD-3) | 10 | (AD-3) | 10 |
| No. 135 | | | | |
| Inventive Element | (AD-3) | 10 | (AD-3) | 20 |
| No. 136 | | | | |
| Inventive Element | (AD-3) | 20 | — | — |
| No. 137 | | | | |
| Inventive Element | (AD-3) | 20 | (AD-3) | 5 |
| No. 138 | | | | |
| Inventive Element | (AD-3) | 20 | (AD-3) | 10 |
| No. 139 | | | | |
| Inventive Element | — | — | (AD-3) | 5 |
| No. 140 | | | | |
| Inventive Element | — | — | (AD-3) | 10 |
| No. 141 | | | | |
| Inventive Element | — | — | (AD-3) | 20 |
| No. 142 | | | | |

### 2. Performance Evaluation

Evaluation of driving voltage, external quantum efficiency and drive durability was performed in a similar manner to that in Example 1. The obtained results are shown in Table 14.

TABLE 14

| | | External | |
|---|---|---|---|
| | | Quantum | Brightness |
| | Driving Voltage | Efficiency | Half-Value Time |
| Element No. | (V) | (%) | (h) |
| Inventive Element | 9.2 | 10.5 | 1700 |
| No. 129 | | | |
| Inventive Element | 8.7 | 10.0 | 1750 |
| No. 130 | | | |
| Inventive Element | 8.6 | 11.0 | 1760 |
| No. 131 | | | |
| Inventive Element | 8.5 | 11.5 | 1970 |
| No. 132 | | | |
| Inventive Element | 8.6 | 10.9 | 1800 |
| No. 133 | | | |
| Inventive Element | 8.6 | 11.5 | 1800 |
| No. 134 | | | |
| Inventive Element | 8.1 | 11.4 | 2050 |
| No. 135 | | | |
| Inventive Element | 8.2 | 11.8 | 2100 |
| No. 136 | | | |
| Inventive Element | 8.0 | 11.1 | 1910 |
| No. 137 | | | |
| Inventive Element | 8.0 | 11.6 | 1990 |
| No. 138 | | | |
| Inventive Element | 7.6 | 11.7 | 2130 |
| No. 139 | | | |
| Inventive Element | 8.5 | 10.6 | 1700 |
| No. 140 | | | |
| Inventive Element | 8.1 | 10.5 | 1800 |
| No. 141 | | | |
| Inventive Element | 8.0 | 11.0 | 1890 |
| No. 142 | | | |

As is clear from the results shown above, the inventive elements exhibit light-emission characteristics of unexpectedly high external quantum efficiency, low driving voltage and high drive durability, as compared with the comparative element B. Particularly, by adding compound (AD-3) of formula (1) to both of the hole transport layer and electron transport layer, higher performance is obtained as compared with the performance obtained by adding compound (AD-3) to one of these layers.

### Example 8

### 1. Preparation of Sample

Preparation of inventive organic EL elements was conducted in a similar manner to that in the process in the preparation of the organic EL elements of Example 5, except that, in the preparation of the organic EL elements of Example 5, compound (AD-4) of formula (1) was added to the hole transport layer and/or the electron transport layer as shown in Table 15.

TABLE 15

| | Compound of | | Compound of | |
|---|---|---|---|---|
| | Formula (1) in | | Formula (1) in Electron | |
| | Hole Transport Layer | | Transport Layer | |
| | | Content | | Content |
| | | (% | Compound | (% |
| Element No. | Compound No. | by weight) | No. | by weight) |
| Inventive Element | (AD-4) | 5 | — | — |
| No. 143 | | | | |
| Inventive Element | (AD-4) | 5 | (AD-4) | 5 |
| No. 144 | | | | |
| Inventive Element | (AD-4) | 5 | (AD-4) | 10 |
| No. 145 | | | | |
| Inventive Element | (AD-4) | 5 | (AD-4) | 20 |
| No. 146 | | | | |
| Inventive Element | (AD-4) | 10 | — | — |
| No. 147 | | | | |
| Inventive Element | (AD-4) | 10 | (AD-4) | 5 |
| No. 148 | | | | |
| Inventive Element | (AD-4) | 10 | (AD-4) | 10 |
| No. 149 | | | | |
| Inventive Element | (AD-4) | 10 | (AD-4) | 20 |
| No. 150 | | | | |
| Inventive Element | (AD-4) | 20 | — | — |
| No. 151 | | | | |
| Inventive Element | (AD-4) | 20 | (AD-4) | 5 |
| No. 152 | | | | |
| Inventive Element | (AD-4) | 20 | (AD-4) | 10 |
| No. 153 | | | | |
| Inventive Element | — | — | (AD-4) | 5 |
| No. 154 | | | | |
| Inventive Element | — | — | (AD-4) | 10 |
| No. 155 | | | | |
| Inventive Element | — | — | (AD-4) | 20 |
| No. 156 | | | | |

### 2. Performance Evaluation

Evaluation of driving voltage, external quantum efficiency and drive durability was performed in a similar manner to that in Example 1. The obtained results are shown in Table 16.

TABLE 16

| | | External | |
|---|---|---|---|
| | | Quantum | Brightness |
| | Driving Voltage | Efficiency | Half-Value Time |
| Element No. | (V) | (%) | (h) |
| Inventive Element | 9.4 | 10.0 | 1800 |
| No. 143 | | | |
| Inventive Element | 9.2 | 9.8 | 1900 |
| No. 144 | | | |
| Inventive Element | 9.1 | 10.8 | 1780 |
| No. 145 | | | |
| Inventive Element | 8.7 | 10.9 | 1870 |
| No. 146 | | | |
| Inventive Element | 8.8 | 10.5 | 1680 |
| No. 147 | | | |
| Inventive Element | 8.8 | 11.0 | 1720 |
| No. 148 | | | |
| Inventive Element | 8.5 | 11.2 | 1980 |
| No. 149 | | | |
| Inventive Element | 8.7 | 11.5 | 1990 |
| No. 150 | | | |
| Inventive Element | 8.6 | 10.7 | 1800 |
| No. 151 | | | |
| Inventive Element | 8.4 | 11.2 | 1900 |
| No. 152 | | | |
| Inventive Element | 8.0 | 11.0 | 2100 |
| No. 153 | | | |
| Inventive Element | 9.0 | 10.0 | 1790 |
| No. 154 | | | |
| Inventive Element | 8.5 | 10.3 | 1700 |
| No. 155 | | | |
| Inventive Element | 9.0 | 10.5 | 1780 |
| No. 156 | | | |

As is clear from the results shown above, the inventive elements exhibit light-emission characteristics of unexpectedly high external quantum efficiency, low driving voltage and high drive durability, as compared with the comparative element B. Particularly, by adding compound (AD-4) of formula (1) to both of the hole transport layer and electron transport layer, higher performance is obtained as compared with the performance obtained by adding compound (AD-4) to one of these layers.

It is clear from the results of Examples 5 to 8 described above that by adding the compound of formula (1) to both of the hole transport layer and electron transport layer, light-emission characteristics of unexpectedly high external quantum efficiency, low driving voltage and high drive durability are obtained.

### Example 9

### 1. Preparation of Sample

Preparation of comparative organic EL elements and inventive organic EL elements was conducted in a similar manner to that in the process in the preparation of the organic EL elements of Example 1, except that, in the preparation of the organic EL elements of Example 1, the light-emitting layer was changed to the following layer, and compound (AD-1) of formula (1) was added to the hole transport layer and/or the electron transport layer as shown in Table 17.

Light-emitting layer (c): N,N′-di-carbazolyl-4,4′-biphenyl (which is referred to as CBP, corresponding to “H-1” exemplified as a specific example of the hole transporting material), which is a host material, and fac-tris(2-phenylpyridinato-N, C2′)iridium (III) (which is referred to as Ir(ppy)₃), which is a light emitting material, were co-deposited so that the amount of Ir(ppy)₃ would be 5% by weight with respect to the amount of CBP. The thickness of the light-emitting layer was 60 nm.

Light-emitting layer (d): the host material BAlq and light emitting material tris(1-phenylisoquinolinate)iridium (III) (which is referred to as Ir(piq)₃) were co-deposited so that the amount of Ir(piq)₃ would be 5% by weight with respect to the amount of BAlq. The thickness of the light-emitting layer was 60 nm.

TABLE 17

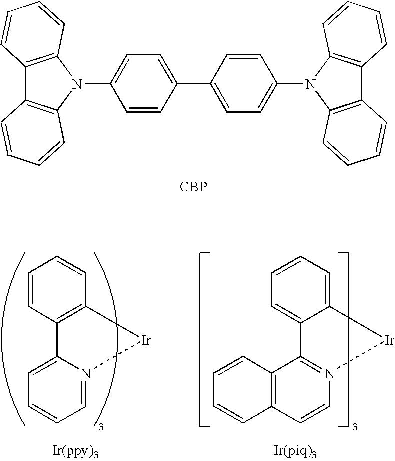

| | | Compound of Formula (1) | | Compound of Formula (1) | |
|---|---|---|---|---|---|
| | | in Hole Transport Layer | | in Electron Transport Layer | |
| Element | Light-Emitting | Compound | Content | Compound | Content |
| No. | Layer | No. | (% by weight) | No. | (% by weight) |
| Comparative | Light-emitting | — | — | — | — |
| Element C | layer (c) | | | | |
| Comparative | Light-emitting | — | — | — | — |
| Element D | layer (d) | | | | |
| Inventive | Light-emittting | (AD-1) | 50 | — | — |
| Element | layer (c) | | | | |
| No. 157 | | | | | |
| Inventive | Light-emittting | — | — | (AD-1) | 50 |
| Element | layer (c) | | | | |
| No. 158 | | | | | |
| Inventive | Light-emittting | (AD-1) | 50 | — | — |
| Element | layer (d) | | | | |
| No. 159 | | | | | |
| Inventive | Light-emittting | (AD-1) | 20 | (AD-1) | 20 |
| Element | layer (c) | | | | |
| No. 160 | | | | | |
| Inventive | Light-emittting | (AD-1) | 20 | (AD-1) | 20 |
| Element | layer (d) | | | | |
| No. 161 | | | | | |

### 2. Performance Evaluation

Concerning the obtained elements, performance was evaluated in a similar manner to that in Example 1. Results are shown in Table 18.

As a result, as is clear from the results shown in Table 18, the inventive element Nos. 157, 158 and 160 as compared with the comparative element C, and the inventive element Nos. 159 and 161 as compared with the comparative element D, exhibit light-emission characteristics of unexpectedly high external quantum efficiency, low driving voltage and high drive durability, respectively.

As is clear from the results shown in Table 18, the inventive element Nos. 157 to 159, in which a charge transport layer containing the compound of formula (1) is disposed on only one side of the light-emitting layer, exhibit light-emission characteristics of unexpectedly high external quantum efficiency, low driving voltage and high drive durability, as compared with the comparative elements C and D, respectively. Particularly, the inventive element Nos. 160 and 161, in which compound (AD-1) of formula (1) is added to both of the hole transport layer and electron transport layer, exhibit higher performance as compared with the element in which compound (AD-1) is added to one of these layers.

TABLE 18

| | | External | |
|---|---|---|---|
| | | Quantum | Brightness |
| | Driving Voltage | Efficiency | Half-Value Time |
| Element No. | (V) | (%) | (h) |
| Comparative | 8.5 | 12.8 | 500 |
| Element C | | | |
| Comparative | 7.5 | 12.0 | 18000 |
| Element D | | | |
| Inventive Element | 7.0 | 14.0 | 1000 |
| No. 157 | | | |
| Inventive Element | 7.2 | 13.8 | 900 |
| No. 158 | | | |
| Inventive Element | 6.5 | 13.7 | 20000 |
| No. 159 | | | |
| Inventive Element | 6.7 | 13.5 | 2500 |
| No. 160 | | | |
| Inventive Element | 6.7 | 14.0 | 22000 |
| No. 161 | | | |

### Example 10

### 1. Preparation of Organic EL Element

(Preparation of Comparative Organic EL Element E)

1) Formation of Anode

As a transparent substrate, the one in which ITO was deposited on a glass substrate having a size of 25 mm×25 mm×0.7 mm to form a film having a thickness of 100 nm (manufactured by Tokyo Sanyo Vacuum Co., Ltd.) was used. The transparent substrate was subjected to etching and cleaning.

2) Hole Injection Layer and Hole Transport Layer

Hole injection layer: 2-TNATA and F4-TCNQ were co-deposited so that the amount of F4-TCNQ would be 1.0% by weight with respect of the amount of 2-TNATA. The thickness was 160 nm.

Hole transport layer: α-NPD was deposited at a thickness of 10 nm.

3) Light-Emitting Layer

Light-emitting layer (e): hole transporting host material H-24 and electron transporting light emitting material Pt-3 were co-deposited. The deposition rate of each component was controlled so that the mixing ratio would be H-24:Pt-3=85% by weight:15% by weight. The thickness of the light-emitting layer was 30 nm.

4) Electron Transport Layer and Electron Injection Layer

Subsequently, on the light-emitting layer, the following electron transport layer and electron injection layer were provided.

Electron transport layer: BAlq was deposited at a thickness of 39 nm.

Electron injection layer: BCP was deposited at a thickness of 1 nm.

5) Formation of Cathode

Further, after depositing LiF at a thickness of 1 nm, patterning was performed using a shadow mask, and Al with a thickness of 100 nm was provided as a cathode. Each layer was provided by resistance heating vacuum deposition.

The lamination body thus produced was placed in a glove box substituted with nitrogen gas, and was sealed using a stainless-steel cap and an ultraviolet-curable adhesive (XNR5516HV, manufactured by Nagase-Ciba Co., Ltd.).

(Preparation of Inventive Organic EL Element Nos. 171 to 184)

Preparation of inventive organic EL element Nos. 171 to 184 was conducted in a similar manner to the process in the preparation of the comparative organic EL element E, except that, in the preparation of the comparative organic EL element E, compound (AD-5) of formula (1) was added to the hole transport layer and/or the electron transport layer as shown in Table 19.

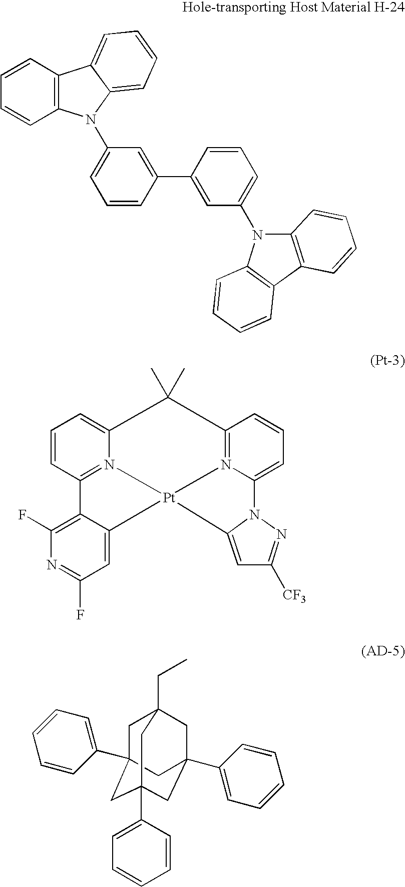

### 2. Performance Evaluation

Evaluation of driving voltage, external quantum efficiency and dive durability was performed in a similar manner to that in Example 1. The obtained results are shown in Table 20.

As is clear from the results shown in Table 20, the inventive elements exhibit light-emission characteristics of unexpectedly high external quantum efficiency, low driving voltage and high drive durability, as compared with the comparative element E. Particularly, by adding compound (AD-5) of formula (1) to both of the hole transport layer and electron transport layer, higher performance is obtained as compared with the performance obtained by adding compound (AD-5) to only one of these layers.

TABLE 19

| | Compound | | Compound | |
|---|---|---|---|---|
| | of Formula (1) | | of Formula (1) in | |
| | in Hole | | Electron | |
| | Transport Layer | | Transport Layer | |
| | | Content | Com- | Content |
| | Compound | (% by | pound | (% by |
| Element No. | No. | weight) | No. | weight) |
| Comparative Element E | — | — | — | — |
| Inventive Element No. 171 | (AD-5) | 5 | — | — |
| Inventive Element No. 172 | (AD-5) | 5 | (AD-5) | 5 |
| Inventive Element No. 173 | (AD-5) | 5 | (AD-5) | 10 |
| Inventive Element No. 174 | (AD-5) | 5 | (AD-5) | 20 |
| Inventive Element No. 175 | (AD-5) | 10 | — | — |
| Inventive Element No. 176 | (AD-5) | 10 | (AD-5) | 5 |
| Inventive Element No. 177 | (AD-5) | 10 | (AD-5) | 10 |
| Inventive Element No. 178 | (AD-5) | 10 | (AD-5) | 20 |
| Inventive Element No. 179 | (AD-5) | 20 | — | — |
| Inventive Element No. 180 | (AD-5) | 20 | (AD-5) | 5 |
| Inventive Element No. 181 | (AD-5) | 20 | (AD-5) | 10 |
| Inventive Element No. 182 | — | — | (AD-5) | 5 |
| Inventive Element No. 183 | — | — | (AD-5) | 10 |
| Inventive Element No. 184 | — | — | (AD-5) | 20 |

TABLE 20

| | Driving | External Quantum | Brightness |
|---|---|---|---|
| | Voltage | Efficiency | Half-Value |
| Element No. | (V) | (%) | Time (h) |
| Comparative Element E | 9.0 | 10.0 | 1000 |
| Inventive Element No. 171 | 7.4 | 13.2 | 2450 |
| Inventive Element No. 172 | 7.3 | 13.5 | 2400 |
| Inventive Element No. 173 | 6.9 | 14.2 | 2800 |
| Inventive Element No. 174 | 6.8 | 14.1 | 2750 |
| Inventive Element No. 175 | 7.0 | 13.7 | 2500 |
| Inventive Element No. 176 | 6.9 | 14.1 | 2850 |
| Inventive Element No. 177 | 6.7 | 14.5 | 3000 |
| Inventive Element No. 178 | 6.0 | 15.2 | 3500 |
| Inventive Element No. 179 | 6.9 | 14.1 | 2760 |
| Inventive Element No. 180 | 6.4 | 14.8 | 3200 |
| Inventive Element No. 181 | 6.2 | 15.0 | 3400 |
| Inventive Element No. 182 | 7.3 | 13.6 | 2550 |
| Inventive Element No. 183 | 7.1 | 13.6 | 2500 |
| Inventive Element No. 184 | 6.8 | 14.1 | 2700 |

### Example 11

### 1. Preparation of Organic EL Element

(Preparation of Comparative Organic EL Element F)

1) Formation of Anode

As a transparent substrate, the one in which ITO was deposited on a glass substrate having a size of 25 mm×25 mm×0.7 mm to form a film having a thickness of 100 nm (manufactured by Tokyo Sanyo Vacuum Co., Ltd.) was used. The transparent substrate was subjected to etching and cleaning.

2) Hole Injection Layer and Hole Transport Layer

Hole injection layer: 2-TNATA and F4-TCNQ were co-deposited so that the amount of F4-TCNQ would be 1.0% by weight with respect of the amount of 2-TNATA. The thickness was 160 nm.

Hole transport layer: N,N′-dinaphthyl-N,N′-diphenyl-[1,1′-biphenyl]-4,4′-diamine (which is referred to as α-NPD) was deposited at a thickness of 10 nm.

3) Light-Emitting Layer

Light-emitting layer (f): hole transporting host material H-25 and electron transporting light emitting material Pt-3 were co-deposited. The deposition rate of each component was controlled so that the mixing ratio would be H-25:Pt-3=85% by weight:15% by weight. The thickness of the light-emitting layer was 30 nm.

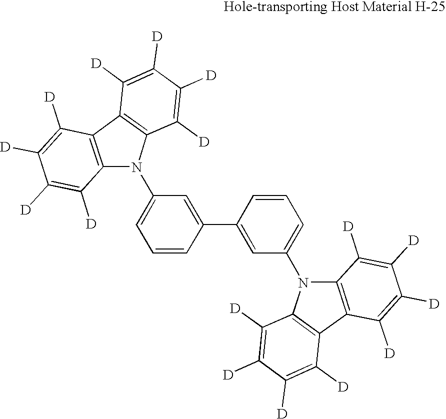

4) Electron Injection Layer and Electron Transport Layer

Subsequently, on the light-emitting layer, the following electron transport layer and electron injection layer were provided.

Electron transport layer: BAlq was deposited at a thickness of 39 nm.

Electron injection layer: BCP was deposited at a thickness of 1 nm.

5) Formation of Cathode

Further, after depositing LiF at a thickness of 1 nm, patterning was performed using a shadow mask, and Al with a thickness of 100 nm was provided as a cathode. Each layer was provided by resistance heating vacuum deposition.

The lamination body thus produced was placed in a glove box substituted with nitrogen gas, and was sealed using a stainless-steel cap and an ultraviolet-curable adhesive (XNR5516HV, manufactured by Nagase-Ciba Co., Ltd.).

(Preparation of Inventive Organic EL Element Nos. 185 to 198)

Preparation of inventive organic EL element Nos. 185 to 198 was conducted in a similar manner to the process in the preparation of the comparative organic EL element F, except that, in the preparation of the comparative organic EL element F, compound (AD-5) of formula (1) was added to the hole transport layer and/or the electron transport layer as shown in Table 21.

### 2. Performance Evaluation

Evaluation of driving voltage, external quantum efficiency and drive durability was performed in a similar manner to that in Example 1 The obtained results are shown in Table 22.

As is clear from the results shown in Table 22, the inventive elements exhibit light-emission characteristics of unexpectedly high external quantum efficiency, low driving voltage and high drive durability, as compared with the comparative element F. Particularly, by adding compound (AD-5) of formula (1) to both of the hole transport layer and electron transport layer, higher performance is obtained as compared with the performance obtained by adding compound (AD-5) to only one of these layers.

TABLE 21

| | Compound | | Compound | |
|---|---|---|---|---|
| | of Formula (1) | | of Formula (1) in | |
| | in Hole | | Electron | |
| | Transport Layer | | Transport Layer | |
| | | Content | Com- | Content |
| | Compound | (% by | pound | (% by |
| Element No. | No. | weight) | No. | weight) |
| Comparative Element F | — | — | — | — |
| Inventive Element No. 185 | (AD-5) | 5 | — | — |
| Inventive Element No. 186 | (AD-5) | 5 | (AD-5) | 5 |
| Inventive Element No. 187 | (AD-5) | 5 | (AD-5) | 10 |
| Inventive Element No. 188 | (AD-5) | 5 | (AD-5) | 20 |
| Inventive Element No. 189 | (AD-5) | 10 | — | — |
| Inventive Element No. 190 | (AD-5) | 10 | (AD-5) | 5 |
| Inventive Element No. 191 | (AD-5) | 10 | (AD-5) | 10 |
| Inventive Element No. 192 | (AD-5) | 10 | (AD-5) | 20 |
| Inventive Element No. 193 | (AD-5) | 20 | — | — |
| Inventive Element No. 194 | (AD-5) | 20 | (AD-5) | 5 |
| Inventive Element No. 195 | (AD-5) | 20 | (AD-5) | 10 |
| Inventive Element No. 196 | — | — | (AD-5) | 5 |
| Inventive Element No. 197 | — | — | (AD-5) | 10 |
| Inventive Element No. 198 | — | — | (AD-5) | 20 |

TABLE 22

| | Driving | External | |
|---|---|---|---|
| | Voltage | Quantum | Brightness Half- |
| Element No. | (V) | Efficiency (%) | Value Time (h) |
| Comparative Element F | 8.5 | 10.4 | 1500 |
| Inventive Element No. 185 | 7.3 | 13.5 | 2700 |
| Inventive Element No. 186 | 7.2 | 13.6 | 2800 |
| Inventive Element No. 187 | 6.3 | 14.7 | 3300 |
| Inventive Element No. 188 | 6.5 | 14.4 | 3250 |
| Inventive Element No. 189 | 7.1 | 13.6 | 2900 |
| Inventive Element No. 190 | 6.2 | 14.9 | 3400 |
| Inventive Element No. 191 | 6.0 | 15.0 | 3550 |
| Inventive Element No. 192 | 5.5 | 16.0 | 4000 |
| Inventive Element No. 193 | 6.6 | 14.3 | 3200 |
| Inventive Element No. 194 | 5.9 | 15.2 | 3600 |
| Inventive Element No. 195 | 5.8 | 15.8 | 3800 |
| Inventive Element No. 196 | 6.8 | 14.0 | 3100 |
| Inventive Element No. 197 | 6.9 | 13.8 | 3000 |
| Inventive Element No. 198 | 6.7 | 14.4 | 3200 |

### Example 12

### 1. Preparation of Organic EL Element

(Preparation of Comparative Organic EL Elements G1 to G12)

1) Formation of Anode

As a transparent substrate, the one in which ITO was deposited on a glass substrate having a size of 25 mm×25 mm×0.7 mm to form a film having a thickness of 100 nm (manufactured by Tokyo Sanyo Vacuum Co., Ltd.) was used. The transparent substrate was subjected to etching and cleaning.

2) Hole Injection Layer and Hole Transport Layer

Hole injection layer: 2-TNATA and F4-TCNQ were co-deposited so that the amount of F4-TCNQ would be 1.0% by weight with respect of the amount of 2-TNATA. The thickness was 160 nm.

Hole transport layer: α-NPD was deposited at a thickness of 10 nm.

3) Light-Emitting Layer

Light-emitting layer (g): according to the following Table 23, a host material and a light emitting material were co-deposited. The deposition rate of each component was controlled so that the mixing ratio would be host material:light emitting material=85% by weight:15% by weight. The thickness of the light-emitting layer was 30 nm.

4) Electron Injection Layer and Electron Transport Layer

Subsequently, on the light-emitting layer, the following electron transport layer and electron injection layer were provided.

Electron transport layer: BAlq was deposited at a thickness of 39 nm.

Electron injection layer: BCP was deposited at a thickness of 1 nm.

5) Formation of Cathode

Further, after depositing LiF at a thickness of 1 nm, patterning was performed using a shadow mask, and Al with a thickness of 100 nm was provided as a cathode. Each layer was provided by resistance heating vacuum deposition.

The lamination body thus produced was placed in a glove box substituted with nitrogen gas, and was sealed using a stainless-steel cap and an ultraviolet-curable adhesive (XNR5516HV, manufactured by Nagase-Ciba Co., Ltd.).

(Preparation of Inventive Organic EL Element Nos. 199 to 210)

Preparation of inventive organic EL element Nos. 199 to 210 was conducted in a similar manner to the process in the preparation of the comparative organic EL elements G1 to G12, except that, in the preparation of the comparative organic EL elements G1 to G12, compound (AD-5) of formula (1) was added to the hole transport layer and/or the electron transport layer as shown in Table 23.

### 2. Performance Evaluation

Evaluation of driving voltage, external quantum efficiency and drive durability was performed in a similar manner to that in Example 1. The obtained results are shown in Table 24.

As is clear from the results shown in Table 24, the inventive elements exhibit light-emission characteristics of unexpectedly high external quantum efficiency, low driving voltage and high drive durability, as compared with the respective comparative element. Particularly, by adding compound (AD-5) of formula (1) to both of the hole transport layer and electron transport layer, higher performance is obtained as compared with the performance obtained by adding compound (AD-5) to only one of these layers.

TABLE 23

| | |
|---|---|
| | Pt-5 |
| 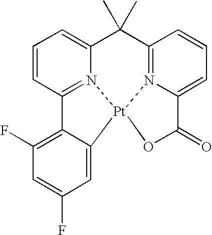 | |
| | Pt-6 |
| 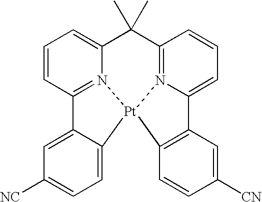 | |
| | Pt-7 |
| 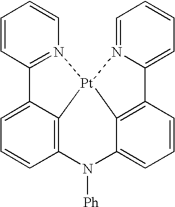 | |
| | Zn-1 |
| 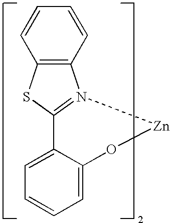 | |
| | Ir-1 |
| 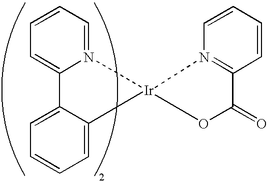 | |
| | Ir-2 |
| 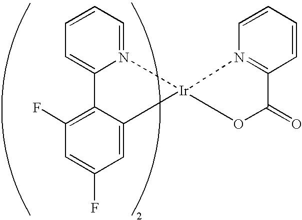 | |
| | Ir-3 |
| 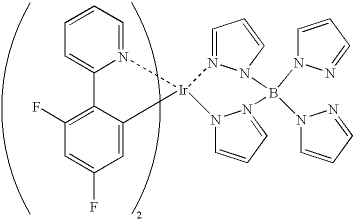 | |
| | Ir-4 |
| 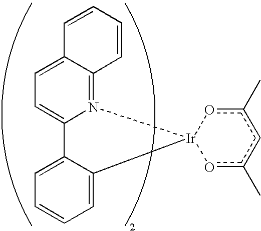 | |
| | Ir-5 |
| 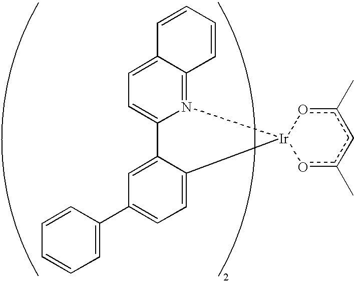 | |
| | Ir-6 |
| 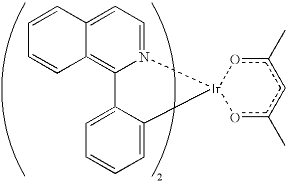 | |
| | Ir-7 |
| 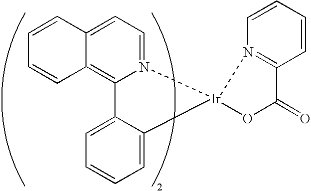 | |

| | |
|---|---|
| | F-1 |
| 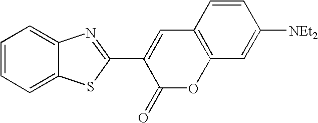 | |
| | F-2 |
| 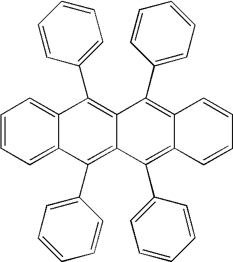 | |

| | | | Compound of Formula (1) | | Compound of Formula (1) | |
|---|---|---|---|---|---|---|
| | | | in Hole Transport Layer | | in Electron Transport Layer | |
| Element | Host | Light-Emitting | Compound | Content | Compound | Content |
| No. | Material | Material | No. | (% by weight) | No. | (% by weight) |
| Inventive | mCP | Pt-5 | (AD-5) | 5.0 | (AD-5) | 5.0 |
| Element | | | | | | |
| No. 199 | | | | | | |
| Comparative | mCP | Pt-5 | — | — | — | — |
| Element G1 | | | | | | |
| Inventive | H-25 | Pt-6 | (AD-5) | 15.0 | — | — |
| Element | | | | | | |
| No. 200a | | | | | | |
| Inventive | H-25 | Pt-6 | — | — | (AD-5) | 15.0 |
| Element | | | | | | |
| No. 200b | | | | | | |
| Inventive | H-25 | Pt-6 | (AD-5) | 15.0 | (AD-5) | 15.0 |
| Element | | | | | | |
| No. 200c | | | | | | |
| Comparative | H-25 | Pt-6 | — | — | — | — |
| Element G2 | | | | | | |
| Inventive | BAlq | Pt-7 | — | — | (AD-5) | 5.0 |
| Element | | | | | | |
| No. 201 | | | | | | |
| Comparative | BAlq | Pt-7 | — | — | — | — |
| Element G3 | | | | | | |
| Inventive | CBP | Ir-1 | (AD-5) | 5.0 | — | — |
| Element | | | | | | |
| No. 202 | | | | | | |
| Comparative | CBP | Ir-1 | — | — | — | — |
| Element G4 | | | | | | |
| Inventive | H-24 | Ir-2 | (AD-5) | 5.0 | — | — |
| Element | | | | | | |
| No. 203 | | | | | | |
| Comparative | H-24 | Ir-2 | — | — | — | — |
| Element G5 | | | | | | |
| Inventive | mCP | Ir-3 | (AD-5) | 5.0 | (AD-5) | 5.0 |
| Element | | | | | | |
| No. 204 | | | | | | |
| Comparative | mCP | Ir-3 | — | — | — | — |
| Element G6 | | | | | | |
| Inventive | Zn-1 | Ir-4 | (AD-5) | 15.0 | — | — |
| Element | | | | | | |
| No. 205 | | | | | | |
| Comparative | Zn-1 | Ir-4 | — | — | — | — |
| Element G7 | | | | | | |
| Inventive | BAlq | Ir-5 | (AD-5) | 5.0 | — | — |
| Element | | | | | | |
| No. 206 | | | | | | |
| Comparative | BAlq | Ir-5 | — | — | — | — |
| Element G8 | | | | | | |
| Inventive | Zn-1 | Ir-6 | (AD-5) | 5.0 | — | — |
| Element | | | | | | |
| No. 207 | | | | | | |
| Comparative | Zn-1 | Ir-6 | — | — | — | — |
| Element G9 | | | | | | |
| Inventive | BAlq | Ir-7 | (AD-5) | 5.0 | — | — |
| Element | | | | | | |
| No. 208 | | | | | | |
| Comparative | BAlq | Ir-7 | — | — | — | — |
| Element G10 | | | | | | |
| Inventive | BAlq | F-1 | (AD-5) | 5.0 | — | — |
| Element | | | | | | |
| No. 209 | | | | | | |
| Comparative | BAlq | F-1 | — | — | — | — |
| Element G11 | | | | | | |
| Inventive | BAlq | F-2 | (AD-5) | 5.0 | — | — |
| Element | | | | | | |
| No. 210 | | | | | | |
| Comparative | BAlq | F-2 | — | — | — | — |
| Element G12 | | | | | | |

TABLE 24

| | | | | | Brightness |
|---|---|---|---|---|---|
| | | | | External | Half- |
| | | Light- | Driving | Quantum | Value |
| | Host | Emitting | Voltage | Efficiency | Time |
| Element No. | Material | Material | (V) | (%) | (h) |
| Inventive Element | mCP | Pt-5 | 10.1 | 10.2 | 2200 |
| No. 199 | | | | | |
| Comparative | mCP | Pt-5 | 10.6 | 9.2 | 1800 |
| Element G1 | | | | | |
| Inventive Element | H-25 | Pt-6 | 8.4 | 12.5 | 4800 |
| No. 200a | | | | | |
| Inventive Element | H-25 | Pt-6 | 8.6 | 12.4 | 4700 |
| No. 200b | | | | | |
| Inventive Element | H-25 | Pt-6 | 8.2 | 13.1 | 5300 |
| No. 200c | | | | | |
| Comparative | H-25 | Pt-6 | 8.9 | 11.4 | 3600 |
| Element G2 | | | | | |
| Inventive Element | BAlq | Pt-7 | 9.2 | 9.5 | 6800 |
| No. 201 | | | | | |
| Comparative | BAlq | Pt-7 | 8.7 | 8.5 | 5300 |
| Element G3 | | | | | |
| Inventive Element | CBP | Ir-1 | 9.4 | 10.6 | 3700 |
| No. 202 | | | | | |
| Comparative | CBP | Ir-1 | 10.0 | 9.7 | 3100 |
| Element G4 | | | | | |
| Inventive Element | H-24 | Ir-2 | 11.2 | 9.4 | 1200 |
| No. 203 | | | | | |
| Comparative | H-24 | Ir-2 | 11.9 | 8.7 | 830 |
| Element G5 | | | | | |
| Inventive Element | mCP | Ir-3 | 13.2 | 6.9 | 610 |
| No. 204 | | | | | |
| Comparative | mCP | Ir-3 | 14.0 | 6.0 | 480 |
| Element G6 | | | | | |
| Inventive Element | Zn-1 | Ir-4 | 7.8 | 9.1 | 5200 |
| No. 205 | | | | | |
| Comparative | Zn-1 | Ir-4 | 8.5 | 8.6 | 4000 |
| Element G7 | | | | | |
| Inventive Element | BAlq | Ir-5 | 8.6 | 8.8 | 5700 |
| No. 206 | | | | | |
| Comparative | BAlq | Ir-5 | 9.2 | 8.2 | 4600 |
| Element G8 | | | | | |
| Inventive Element | Zn-1 | Ir-6 | 8.0 | 8.8 | 5000 |
| No. 207 | | | | | |
| Comparative | Zn-1 | Ir-6 | 8.6 | 8.3 | 3900 |
| Element G9 | | | | | |
| Inventive Element | BAlq | Ir-7 | 9.3 | 7.4 | 5600 |
| No. 208 | | | | | |
| Comparative | BAlq | Ir-7 | 9.8 | 6.8 | 4700 |
| Element G10 | | | | | |
| Inventive Element | BAlq | F-1 | 8.7 | 2.9 | 2000 |
| No. 209 | | | | | |
| Comparative | BAlq | F-1 | 9.2 | 2.5 | 1400 |
| Element G11 | | | | | |
| Inventive Element | BAlq | F-2 | 7.9 | 3.9 | 3200 |
| No. 210 | | | | | |
| Comparative | BAlq | F-2 | 8.3 | 3.4 | 2600 |
| Element G12 | | | | | |

### Example 13

### 1. Preparation of Organic EL Element

(Preparation of Comparative Organic EL Elements H1 and H2)

Preparation of comparative organic EL elements H1 and H2 was conducted in a similar manner to that in the process in the preparation of the comparative organic EL element G1 of Example 12, except that, in the preparation of the comparative organic EL element G1 of Example 12, the light-emitting layer was changed to the following layer.

Light-emitting layer (h-1): mCP and light emitting material Pt-2 were co-deposited so that the amount of Pt-2 would be 15% by weight with respect to the amount of mCP. The thickness of the light-emitting layer was 60 nm.

Light-emitting layer (h-2): ternary element co-deposition using mCP, light emitting material Pt-2 and compound (AD-1) of formula (1) was conducted so that the mixing ratio would be mCP:Pt-2:AD-1=70% by weight:15% by weight:15% by weight. The thickness of the light-emitting layer was 60 nm.

(Preparation of Inventive Organic EL Element Nos. 211 to 213)

Preparation of inventive organic EL element Nos. 211 to 213 was conducted in a similar manner to that in the process in the preparation of the comparative organic EL elements H1 and H2, except that, in the preparation of the comparative organic EL elements H1 and H2, the light-emitting layer (h-2) was used as the light-emitting layer, and compound (AD-5) of formula (1) was added to the hole transport layer and/or the electron transport layer as shown in Table 25.

### 2. Performance Evaluation

Evaluation of driving voltage, external quantum efficiency and drive durability was performed in a similar manner to that in Example 1. The obtained results are shown in Table 26.

TABLE 25

| | Light- | Compound of Formula (1) | | Compound of Formula (1) | |
|---|---|---|---|---|---|
| | Emitting | in Hole Transport Layer | | in Electron Transport Layer | |
| | Layer | Compound | Content | Compound | Content |
| Element No. | No. | No. | (% by weight) | No. | (% by weight) |
| Comparative | h-1 | — | — | — | — |
| Element H1 | | | | | |
| Comparative | h-2 | — | — | — | — |
| Element H2 | | | | | |
| Inventive Element | h-2 | (AD-5) | 15.0 | — | — |
| No. 211 | | | | | |
| Inventive Element | h-2 | — | — | (AD-5) | 5.0 |
| No. 212 | | | | | |
| Inventive Element | h-2 | (AD-5) | 15.0 | (AD-5) | 5.0 |
| No. 213 | | | | | |

TABLE 26

| | | Quantum | External Brightness |
|---|---|---|---|
| | Driving Voltage | Efficiency | Half-Value Time |
| Element No. | (V) | (%) | (h) |
| Comparative | 10.5 | 9.0 | 1300 |
| Element H1 | | | |
| Comparative | 10.7 | 9.4 | 1500 |
| Element H2 | | | |
| Inventive Element | 10.1 | 9.9 | 1700 |
| No. 211 | | | |
| Inventive Element | 10.2 | 9.8 | 1600 |
| No. 212 | | | |
| Inventive Element | 9.7 | 10.2 | 2000 |
| No. 213 | | | |

As is clear from the results shown above, the inventive elements exhibit light-emission characteristics of unexpectedly high external quantum efficiency, low driving voltage and high drive durability, as compared with the comparative elements. Particularly, by adding compound (AD-5) of formula (1) to both of the hole transport layer and electron transport layer, higher performance is obtained as compared with the performance obtained by adding compound (AD-5) to only one of these layers.

What is claimed is:

1. An organic electroluminescence element comprising at least one organic compound layer including a light-emitting layer, which is disposed between a pair of electrodes, wherein a charge transport layer which contains a charge transporting material and a compound represented by the following formula (1) is disposed adjacent to the light-emitting layer: 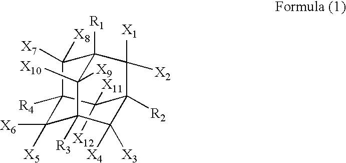
wherein in formula (1), R₁ through R₄ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group; at least one of R₁ through R₄ is a group having a double bond or a triple bond; and X₁ through X₁₂ each independently represent a hydrogen atom, an alkyl group having 1 to 6 carbon atoms, an alkenyl group having 2 to 6 carbon atoms, an alkynyl group having 2 to 6 carbon atoms, an aryl group, a heteroaryl group, an alkoxy group having 1 to 6 carbon atoms, an acyl group, an acyloxy group, an amino group, a nitro group, a cyano group, an ester group, an amido group, a halogen atom, a perfluoroalkyl group having 1 to 6 carbon atoms or a silyl group.

2. The organic electroluminescence element according to claim 1, wherein the charge transport layer is disposed on an anode side of the light-emitting layer.

3. The organic electroluminescence element according to claim 1, wherein the charge transport layer is disposed on a cathode side of the light-emitting layer.

4. The organic electroluminescence element according to claim 1, wherein the charge transport layer is disposed on an anode side and on a cathode side of the light-emitting layer.

5. The organic electroluminescence element according to claim 1, wherein a content of the compound represented by formula (1) in the charge transport layer is from 5% by weight to 50% by weight.

6. The organic electroluminescence element according to claim 1, wherein an energy difference (Eg) between the highest occupied molecular orbital and the lowest unoccupied molecular orbital of the compound represented by formula (1) is 4.0 eV or more.

7. The organic electroluminescence element according to claim 1, wherein the lowest excited triplet level (T1) of the compound represented by formula (1) is 2.7 eV or more.

8. The organic electroluminescence element according to claim 1, wherein an electron affinity (Ea) of the compound represented by formula (1) is 2.3 eV or less.

9. The organic electroluminescence element according to claim 1, wherein an ionization potential (Ip) of the compound represented by formula (1) is 6.1 eV or more.

10. The organic electroluminescence element according to claim 1, wherein at least one of R₁ through R₄ is a group having a double bond, and the group having the double bond is a phenyl group, a biphenylyl group or a terphenylyl group.

11. The organic electroluminescence element according to claim 10, wherein the group having the double bond is a phenyl group.

12. The organic electroluminescence element according to claim 1, wherein the charge transport layer contains plural compounds represented by formula (1) in a mixing state.

13. The organic electroluminescence element according to claim 12, wherein the plural compounds represented by formula (1) are compounds having a different number of phenyl groups from each other.

14. The organic electroluminescence element according to claim 1, wherein the light-emitting layer contains a metal complex.

15. The organic electroluminescence element according to claim 14, wherein the metal complex is a metal complex having a tri- or higher-dentate ligand.

16. The organic electroluminescence element according to claim 15, wherein the metal complex is a metal complex represented by the following formula (A): 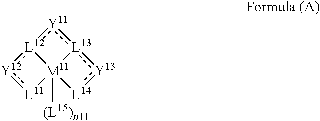
wherein in formula (A), M¹¹ represents a metal ion; L¹¹ through L¹⁵ each independently represent a ligand which coordinates to M¹¹; an atomic group may further exist between L¹¹ and L¹⁴ to form a cyclic ligand; L¹⁵ may bond to both of L¹¹ and L¹⁴ to form a cyclic ligand; Y¹¹, Y¹² and Y¹³ each independently represent a linking group, a single bond or a double bond; when Y¹¹, Y¹² or Y¹³ is a linking group, bonds between L¹¹ and Y¹², Y¹² and L¹², L¹² and Y¹¹, U¹¹ and L¹³, L¹³ and Y¹³, and Y¹³ and L¹⁴ each independently represent a single bond or a double bond; n11 is from 0 to 4; and bonds between M¹¹ and L¹¹ to L¹⁵ are each independently a coordination bond, an ionic bond or a covalent bond.

17. The organic electroluminescence element according to claim 16, wherein in formula (A), M¹¹ is a platinum ion.
